(19) United States
(12) Patent Application Publication
(10) Pub. No.: US 2007/0048457 A1
(43) Pub. Date: Mar. 1, 2007

(54) Producing method of film having coated layer, film having coated layer, optical film, polarizing plate and liquid crystal display

(75) Inventors: Takumi Ando, Minami-Ashigara-shi (JP); Tomonari Ogawa, Minami-Ashigara-shi (JP); Makoto Satoh, Minami-Ashigara-shi (JP); Takato Suzuki, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJI FILM Corporation, Tokyo (JP)

(21) Appl. No.: 11/509,688

(22) Filed: Aug. 25, 2006

(30) Foreign Application Priority Data
Aug. 25, 2005 (JP) P2005-244359

(51) Int. Cl. C09K 19/00; B05D 3/02

(52) U.S. Cl. 428/1.1; 428/1.3; 427/379

(57) ABSTRACT

A producing method of a coated film is provided and includes: coating a coating solution that contains a light-transmitting resin and a solvent on a support and, subsequently applying first and second drying steps for drying a coated coating solution. The first drying step is carried out in a drying zone where the maximum wind speed on a surface of a coated layer is 1 m/sec or more, and the second drying step is carried out in a drying zone having a temperature of 50° C. or more higher than a temperature in a zone where the first drying step is carried out.

### BACKGROUND OF THE INVENTION

1. Field of the Invention

The invention relates to a method for a producing a film having a coated layer. In particular, the invention relates to a technology that allows uniformly without irregularity forming a coated layer on a support. Furthermore, the invention relates to an optical film having an optical function layer.

2. Description of Background Art

In general, various kinds of films having a coated layer (hereinafter, sometimes referred to as coated films) are produced according to a method where a coating solution is coated on a substrate film followed by drying to form the coated layer. As a coating method of the coating solution, various systems such as a slot die, extrusion, roll coat, bar coat, reverse gravure coat and micro-gravure are adopted (JP-A-62-140672).

As a coated film, for instance, various kinds of optical films having an optical functional layer can be cited. As displays of office automation equipments such as TVs or personal computers, so far, CRTs have been a mainstream. However, liquid crystal displays, being largely advantageous in the thinness, lightweight and lower power consumption, are replacing the CRTs. Liquid crystal displays now in circulation have optical functional layers such as a liquid crystal layer for forming a retardation film, a hard coat layer for surface protection and surface-treated films such as an anti-glare layer and an anti-reflection film.

An optical functional layer, as the optical function is made higher, is formed into a thinner film. When there is irregularity in a film thickness and a surface shape, a display function of an image display such as a liquid crystal display therewith is deteriorated. Accordingly, the optical functional layer is demanded to be uniform in the film thickness. However, whatever coating methods are adopted, during a transfer from a coating step to a drying step, a resin flows, and, during a drying step, owing to irregular drying, a resin flows; as a result, surfaces different in surface shape are formed; accordingly, it is difficult to form a coated layer having a uniform film thickness and a uniform surface shape. In particular, it is difficult to form a coated layer having a uniform film thickness and a uniform surface shape on a large area substrate film.

For instance, when a hard coat layer or an anti-reflection layer is formed on a polymer film support, since there is difference in refractive index between resin layers stacked, interference irregularity due to an irregular thickness caused by the resin flow after coating is particularly significant. In this case, since there is discrepancy in the optical thickness in a plane, the reflectance as well is lowered than a theoretical value.

Furthermore, when an anti-glare layer is formed, generally minute irregularity is formed on a surface. Accordingly, when, owing to irregular drying, non-uniformity such as irregularity is formed, ambient light is irregularly scattered; accordingly, display quality in a bright room is deteriorated.

Furthermore, a liquid crystal molecule that forms a liquid crystal layer is known that it is generally readily affected by an influence of an interface to arrange (orient) with directionality owing to an interface restraining force such as rubbing. In the foregoing coating methods, since one surface of a coated solution that contains liquid crystal molecules is an open system, in normally known coating and drying methods, an air flow on an open system side resultantly generates orientation irregularity of the liquid crystal layer. A liquid crystal display having the thus obtained liquid crystal layer shows partially varying front contrast.

To these film thickness irregularities and surface shape irregularities, in JP-A-2003-126768, an wind speed on a surface of a coated film is set to such very slight wind as 0.2 to 1 m/sec, and, in JP-A-2004-290963, a vaporization velocity of a solvent is maintained at 0.1 g/m²/sec or less to dry; that is, in both thereof, it is tried to gradually dry to uniformize the irregularity. In the improvement owing to gradual drying, an improvement effect can be obtained to a certain extent; however, in the case of a film being formed on a long support, when a width is 1 m or more, a center portion in a width direction is very much delayed to dry, and, thereby, in some cases, on the contrary, the irregularity generated in the drying is made obvious. Furthermore, owing to the prolongation of the drying, it takes a longer time to dry and thereby the productivity is deteriorated.

Accordingly, a drying method and a producing technology that allow continuously forming, in particular on a wide and long support, an optical functional layer that is free from the drying irregularity and uniform in film thickness and surface shape are in demand.

### SUMMARY OF THE INVENTION

An object of an illustrative, non-limiting embodiment of the invention is to provide a method for producing a film having a coated layer, which, even when a support has a large area, can form a uniform coated layer free from drying irregularity owing to a coating solution.

Another object of an illustrative, non-limiting embodiment of the invention is to provide an optical film that has a coated layer obtained according to the producing method as an optical functional layer, and a polarizing plate and an image display with the optical film.

The foregoing objects can be attained by the following means.

1. A method for producing a film having a coated layer, comprising:

coating a coating solution on a support to provide a coating layer, the coating solution comprising a light-transmitting resin and a solvent;

first drying the coating layer in a first drying zone where a maximum wind speed on a surface of the coating layer is 1 m/sec or more; and

second drying the coating layer in a second drying zone having a temperature of 50° C. or more higher than that of the first drying zone to form a coated layer.

2. The method as described in the above 1, wherein a drying speed of the solvent in the first drying is 0.3 g/m²/sec or more.

3. The method as described in the above 1 or 2, wherein the solvent in the coating solution comprises at least two solvents having boiling temperatures different from one another by 30° C. or more.

4. The method as described in any one of the above 1 to 3, wherein the coating, the first drying and the second drying are carried out with the support conveying at 30 m/min or more.

5. The method as described in any one of the above 1 to 4, wherein the support is a long roll, and the support has a width of 1.4 to 4 m.

6. The method as described in any one of the above 1 to 5, wherein the coating solution comprises a surfactant.

7. A film comprising: a support; and a coated layer, the film being produced by a method as described in any one of the above 1 to 6.

8. An optical film comprising a film as described in the above 7, wherein the coated layer comprises an optical functional layer.

9. The optical film as described in the above 8, wherein the optical functional layer is an anti-glare layer.

10. The optical film as described in the above 8 or 9, wherein the optical functional layer comprises light-transmitting particles having a refractive index different from the light-transmitting resin.

11. The optical film as described in any one of the above 8 to 10, which comprises a lower refractive index layer having a refractive index lower than that of the optical functional layer, the optical functional layer being disposed between the support and the lower refractive index layer.

12. A polarizing plate comprising: a polarizer; and two protective films sandwiching the polarizer, wherein at least one of the two protective films is an optical film as described in any one of the above 8 to 11.

13. A liquid crystal display comprising: a liquid crystal cell; and an optical film as described in any one of the above 8 to 11 or a polarizing plate as described in the above 12, as an outermost layer of the liquid crystal display.

14. The liquid crystal display as described in the above 13, wherein the liquid crystal cell is of a VA mode or an IPS mode.

### BRIEF DESCRIPTION OF THE DRAWINGS

The features of the invention will appear more fully upon consideration of the exemplary embodiments of the invention, which are schematically set forth in the drawings, in which:

FIG. 1 is a diagram of a coating machine that is used in a producing method of a coated film according to one aspect of the invention;

FIG. 2 is a sectional view of a coater having a slot die, which is used in one aspect of the invention;

FIG. 3A is a diagram showing a sectional view of a slot die used in one aspect of the invention, and FIG. 3B is a diagram showing a sectional view of an existing slot die used in one aspect of the invention;

FIG. 4 is a perspective view showing a slot die and the proximity thereof in a coating step used in one aspect of the invention;

FIG. 5 is a sectional view showing relationship between a low pressure chamber and a web in the proximity of each other (a back plate forms one body with a chamber body); and

FIG. 6 is a sectional view showing relationship between a low pressure chamber and a web in the proximity of each other (a back plate is fastened to a chamber with a screw).

### DETAILED DESCRIPTION OF THE EXEMPLARY EMBODIMENTS

Although the invention will be described below with reference to the exemplary embodiments thereof, the following exemplary embodiments and modifications do not restrict the invention.

According to an exemplary embodiment, when a drying step of a coated film is controlled to inhibit the drying irregularity from occurring in a plane and thereby a uniform coated layer is formed, even when a support has a large area, a uniform coated layer free from the drying irregularity can be formed. Accordingly, a producing method of a coated film, which is high in the productivity, can be provided, and an optical functional layer having excellent characteristics, an optical film and a liquid crystal display can be provided. A producing method according to an exemplary embodiment of the invention is useful for forming, for instance, an optical functional layer. An optical film according to an exemplary embodiment of the invention can be suitably used in various kinds of image displays such as a liquid crystal display (LCD), an organic EL display, a PDP and a CRT.

In the specification, a description such as “(meth)acrylate” means at least any one of acrylate and methacrylate. The same is applied to a term of “(meth)acrylic acid” as well.

A producing method of a coated film (hereinafter, referred to as well as “coated film formation method”) according to an exemplary embodiment of the invention includes:

coating, on a support, a coating solution that contains a light-transmitting resin and a solvent, and subsequently applying a first drying and a second drying to dry a coated coating solution (i.e., a coating layer), wherein,

the first drying is carried out in a first drying zone where the maximum wind speed on a surface of the coating layer is 1 m/sec or more; and

the second drying is carried out in a second drying zone having a temperature of 50° C. or more higher than a temperature in the first drying zone.

A support and a coating solution that are used in a producing method of a coated film according to an exemplary embodiment of the invention can be appropriately determined depending on a kind of a coated layer formed and an application thereof.

As a coating solution that is used in the invention, as far as it can form a coated film, any one can be used. Depending on a function of a targeted coated film, a resin material (a resin material is preferably light-transmitting and the “light-transmitting property” means that, when a coated film is formed, the light transmittance of the visible light region is 50% or more) and a solvent of a coating solution are selected. Examples of a coated film that can be formed by means of a coated film forming method according to the invention include an optical functional layer, an antistatic layer, a surface protective layer, a conductive functional layer, a tacky layer, an adhesive layer and a transparent coat layer. When coated films are formed with coating solutions, coated films can be sequentially formed on a support. Accordingly, as a support, one on which a coated film is formed in advance can be used. In a coated film obtained by a producing method according to an exemplary embodiment of the invention, among coated films formed on the support, at least one layer is necessary to be formed according to the coated film forming method according to the invention.

The coated film forming method according to an exemplary embodiment of the invention can be preferably applied when an optical functional layer is formed, in particular, an optical functional layer having a thickness of 10 μm or less is formed (in the specification, a coated film having an optical functional layer is called as “an optical film”). As the optical functional layer, a hard coat layer, an anti-reflective layer, a retardation layer and an optical compensation film can be cited. In particular, the optical functional layer is preferably a hard coat layer and more preferably a hard coat layer having an anti-glare layer (anti-glare layer).

(Support)

As a support of the coated film according to the invention, a transparent resin film, a transparent resin plate, a transparent resin film and transparent glass can be used without restriction. As the transparent resin film, a cellulose acylate film (for instance, cellulose triacetate film (refractive index: 1.48), cellulose diacetate film, cellulose acetate butyrate film and cellulose acetate propionate film), a polyethylene terephthalate film, a polyether sulfone film, a polyacrylic resin film, a polyurethanic resin film, a polyester film, a polycarbonate film, a polysulfone film, a polyether film, a polymethyl pentane film, a polyether ketone film and a (meth)acrylnitrile film can be used.

Among these, a cellulose acylate film that is high in the transparency, less in the optical birefringence, easy to produce, and generally used as a protective film of a polarizing plate is preferable and a cellulose triacetate film is particularly preferable. Furthermore, a thickness of the transparent support is normally set substantially in the range of 25 to 1,000 μm.

The transparent support of the invention is preferably in a long roll shape, specifically, preferably substantially in the range of 100 to 5,000 m. Furthermore, a width of a long support, from a productivity point of view, is preferably 1 m or more and more preferably a long film of 1.4 to 4 m. When the width exceeds 4 m, the roll can be handled with difficulty and a conveyance speed cannot be made higher.

Still furthermore, the long film of the invention is particularly preferably knurled at edge portions in a width direction.

<Cellulose Acylate Film>

The cellulose acylate film that is used in the invention preferably has a degree of acetylation in the range of 59.0 to 61.5%.

The degree of acetylation means an amount of bonded acetic acid per unit mass of cellulose. The degree of acetylation is measured and calculated in accordance with ASTM: D-817-91 (test methods of cellulose acetate etc).

A viscosity average polymerization degree (DP) of the cellulose acylate is preferably 250 or more and more preferably 290 or more.

Furthermore, the cellulose acylate that is used in the invention preferably has a value of Mw/Mn (Mw: a mass average molecular weight (a weight average molecular weight) and Mn: a number average molecular weight) according to gel-permeation chromatography close to 1.0, in other words, narrow in a molecular weight distribution. A specific value of the Mw/Mn is preferably in the range of 1.0 to 1.7, more preferably in the range of 1.3 to 1.65 and most preferably in the range of 1.4 to 1.6.

In general, hydroxyl groups at 2, 3 and 6 sites of cellulose acylate are not necessarily equally distributed by one third of a total substitution degree; that is, the substitution degree of hydroxyl groups at the sixth site tends to be smaller. In the invention, the substitution degree of hydroxyl groups at the sixth site is preferably larger than that of the second and third sites.

To an entire substitution degree, hydroxyl groups at the sixth site are preferably substituted 32% or more with acyl groups, more preferably 33% or more and particularly preferably 34% or more. Furthermore, the substitution degree of acyl groups at the sixth site of cellulose acylate is preferably 0.88 or more. The hydroxyl groups at the sixth site may be substituted by, other than an acetyl group, an acyl group having 3 or more carbon atoms, for instance, a propyonyl group, a butyloyl group, a valeloyl group, a benzoyl group or an acryloyl group. A measurement of the substitution degree of the respective sites can be performed with NMR.

As the cellulose acylate that can be used in the invention, cellulose acetate obtained by methods described in JP-A-11-5851, paragraphs [0043] through [0044] [Example] [Synthesis Example 1], paragraphs [0048] through [0049] [Synthesis Example 2], and paragraphs [0051] through [0052] [Synthesis Example 3] can be used.

(Production of Cellulose Acylate Film)

A cellulose acylate film used in the invention can be produced by use of a solvent cast method. In the solvent cast method, a solution (dope) in which cellulose acylate is dissolved in an organic solvent is used to produce.

An organic solvent preferably contains a solvent selected from ethers having 3 to 12 carbon atoms, ketones having 3 to 12 carbon atoms, esters having 3 to 12 carbon atoms and halogenated hydrocarbons having 1 to 6 carbon atoms. Two kinds or more of the organic solvents may be blended and used.

The ether, ketone and ester may have a ring structure. A compound having at least two of any one of functional groups of ether, ketone and ester (that is, —O—, —CO— and —COO—) can be used as an organic solvent. An organic solvent may have other functional group such as an alcoholic hydroxyl group. In the case of an organic solvent that has at least two kinds of functional groups, a preferable number of carbon atoms may well be within the range of the above-specified preferable number of carbon atoms of a compound having any one of the functional groups.

Examples of ether having 3 to 12 carbon atoms include diisopropyl ether, dimethoxymethane, dimethoxyethane, 1,4-dioxane, 1,3-dioxolan, tetrahydrofuran, anisole and phenetole.

Examples of ketone having 3 to 12 carbon atoms include acetone, methyl ethyl ketone, diethyl ketone, diisobutyl ketone, cyclohexanone and methyl cyclohexanone.

Examples of ester having 3 to 12 carbon atoms include ethyl formate, propyl formate, pentyl formate, methyl acetate, ethyl acetate and pentyl acetate.

Examples of an organic solvent having at least two kinds of functional groups include 2-ethoxyethyl acetate, 2-methoxyethanol and 2-buthoxyethanol.

The number of carbon atoms of a halogenated hydrocarbon is preferably 1 or 2 and most preferably 1. A halogen of the halogenated hydrocarbon is preferable to be chlorine. A ratio of hydrogen atoms substituted by a halogen of a halogenated hydrocarbon is preferably in the range of 25 to 75 mole percent (weight percent), more preferably in the range of 30 to 70 mole percent, still more preferably in the range of 35 to 65 mole percent and most preferably in the range of 40 to 60 mole percent. Methylene chloride is a typical halogenated hydrocarbon.

A cellulose acylate solution (dope) can be prepared according to a standard method. A standard method means to process at a temperature equal to or more than 0° C. (normal temperature or higher temperature). A solution can be prepared according to a preparation method of a dope and with a unit in an ordinary solvent cast method. In the case of a standard method, as an organic solvent, halogenated hydrocarbon (in particular methylene chloride) can be preferably used. A non-halogenated solvent can be used as well and, as the non-halogenated solvent, ones described in ‘Hatsumei Kyokal Koukai Giho (Journal of Technical Disclosure)’ (Technical Disclosure No. 2001-1745, published Mar. 15, 2001, Japan Institute of Invention and Innovation) can be cited.

An amount of cellulose acylate is controlled so as to be contained in the range of 10 to 40 mass percent in a solution being obtained. An amount of cellulose acylate is more preferably in the range of 10 to 30 mass percent. In an organic solvent (main solution), optional additives described below may be added in advance.

A solution can be prepared by stirring cellulose acylate and an organic solvent at normal temperature (0 to 40° C.). A high concentration solution can be stirred under heat and pressure. Specifically, cellulose acylate and an organic solvent are poured into a pressure container, followed by hermetically sealing the container, further followed by stirring under pressure while heating to a temperature equal to or more than a boiling temperature at normal temperature of the solvent and in the range where the solvent does not boil. A heating temperature is normally 40° C. or more, preferably in the range of 60 to 200° C. and more preferably in the range of 80 to 110° C.

The respective ingredients may be poured into the container after roughly blending. Alternatively, the respective ingredients may be sequentially poured into a container. The container necessarily has a stirable configuration. An inert gas such as nitrogen gas may be injected to pressurize the container. Furthermore, the uprise of a vapor pressure of a solvent owing to heating can be utilized. Alternatively, after hermetically sealing the container, the respective ingredients may be added under pressure.

In the case of heating being applied, the heating is preferably applied from the outside of the container. For instance, a jacket type heater can be used. Furthermore, outside of the container, a plate heater and a piping can be disposed as well to circulate liquid to heat an entirety of the container.

A stirring blade is preferably disposed inside of the container to stir therewith. The stirring blade preferably has a length reaching the proximity of a wall of the container. At an end of the stirring blade, a ladling blade is preferably disposed to refresh a liquid film on a wall of the container.

The container may be provided with instruments such as a pressure gauge and a thermometer. The respective ingredients are dissolved in a solvent in the container. A prepared dope is withdrawn from the container after cooling, or, after taking out, is cooled with a heat exchanger.

A cooling dissolution method can be used as well to prepare a solution. In the cooling dissolution method, cellulose acylate can be dissolved even in an organic solvent in which the cellulose acylate cannot be dissolved according to an ordinary dissolution method. Even with a solvent with which cellulose acetate can be dissolved according to an ordinary dissolution method, by use of the cooling dissolution method, a uniform solution can be obtained faster.

In the cooling dissolution method, in the beginning, in an organic solvent, cellulose acylate is gradually added at room temperature under stirring.

An amount of cellulose acylate is preferably controlled so as to be contained in the range of 10 to 40 mass percent in the mixture. An amount of cellulose acylate is more preferably in the range of 10 to 30 mass percent. Furthermore, in the mixture, arbitrary additives described below may be added.

In the next place, the mixture is cooled to a temperature in the range of −100 to −10° C. (preferably in the range of −80 to −10° C., more preferably in the range of −50 to −20° C. and most preferably in the range of −50 to −30° C.). The mixture can be cooled in, for instance, a dry ice-methanol bath (−75° C.) or an ethylene glycol solution (−30 to −20° C.). When thus cooled, the mixture of cellulose acetate and an organic solvent is solidified.

A cooling rate is preferably 4° C./min or more, more preferably 8° C./min or more and most preferably 12° C./min or more. The larger the cooling rate is, the better. However, 10,000° C./sec is a theoretical upper limit, 1,000° C./sec is a technical upper limit and 100° C./min is a practical upper limit. The cooling rate is a value obtained by dividing a difference between a temperature when the cooling begins and a final cooling temperature with a time from the start of the cooling to an arrival to the final cooling temperature.

Furthermore, when the mixture is heated to a temperature in the range of 0 to 200° C. (preferably in the range of 0 to 150° C., more preferably in the range of 0 to 120° C. and most preferably in the range of 0 to 50° C.), the cellulose acetate is dissolved in the organic solvent. A temperature-rise can be achieved only by leaving in room temperature or by heating in a hot bath.

The heating rate is preferably 4° C./min or more, more preferably 8° C./min or more and most preferably 12° C./min or more. The larger the heating rate is, the better. However, 10,000° C./min is a theoretical upper limit, 1,000° C./min is a technical upper limit and 100° C./min is a practical upper limit. The heating rate is a value obtained by dividing a difference between a temperature when the heating is began and a final heating temperature with a time from the start of the heating to an arrival to the final heating temperature.

Thus, a uniform solution can be obtained. In the case of the dissolution being insufficient, operations of cooling and heating may be repeated. Visual observation of appearance of the solution is enough to judge whether the dissolution is sufficient or not.

In the cooling dissolution method, in order to avoid moisture from mingling owing to bedewing in the course of cooling, a hermetically sealed container is preferably used. Furthermore, in a cooling/heating operation, when pressure is applied at the time of cooling and pressure is reduced at the time of heating, a dissolution time can be shortened. In order to carry out pressurization and depressurization, a pressure resistant container is desirably used.

A 20 mass percent cellulose acetate (acetylation degree: 60.9% and viscosity average polymerization degree: 299) solution where cellulose acetate is dissolved in methyl acetate according to the cooling dissolution method, according to differential scanning calorimetry (DSC), has a pseudo phase transition point between a sol state and a gel state in the proximity of 33° C. and becomes a uniform gel state below the temperature. Accordingly, the solution is necessarily stored at a temperature equal to or higher than the pseudo phase transition temperature, and preferably at a temperature of substantially the gel phase transition temperature plus 10° C. However, the pseudo phase transition temperature varies depending on the acetylation degree of cellulose acetate, the viscosity average polymerization degree, the solution concentration and an organic solvent used.

From the prepared cellulose acylate solution (dope), a cellulose acylate film is produced by means of a solvent cast method.

The dope is flow-cast on a drum or a band, followed by vaporizing a solvent to form a film. In the dope before flow casting, a concentration is preferably controlled so that an amount of solid content may be in the range of 18 to 35%. A surface of the drum or band is preferably finished in a mirror surface. A flow-cast method and a drying method in the solvent cast method are described in U.S. Pat. Nos. 2,336,310, 2,367,603, 2,492,078, 2,492,977, 2,492,978, 2,607,704, 2,739,069 and 2,739,070, U. K. Patent Nos. 640731 and 736892 and JP-B-Nos. 45-4554, 49-5614 and 62-115035.

The dope is preferably flow-cast on a drum or a band of which surface temperature is set at a temperature of 10° C. or less. After flow casting, the dope is preferably dried by flowing air for 2 sec or more. An obtained film is peeled off the drum or band and the film may be further dried with hot air of which temperature is gradually varied from 100 to 160° C. to vaporize a residual solvent. The foregoing method is described in JP-B-5-17844. According to the method, a time period from the flow casting to peeling can be shortened. In order to carry out the method, it is necessary that the dope is gelated at a surface temperature of the drum or band at the time of flow-casting.

With a plurality of prepared cellulose acylate solutions (dope), two or more layers are flow cast according to the solvent cast method to prepare a film. In this case, the dope is flow-cast on a drum or a band, followed by vaporizing a solvent to prepare a film. The dope before the flow casting is preferably controlled in the concentration so that a solid content may be in the range of 10 to 40%. A surface of the drum or band is preferably finished to a mirror surface.

When a plurality of two or more layers of cellulose acylate solutions is flow-cast, from each of a plurality of flow-casting ports that can flow cast a plurality of cellulose acylate solutions and is disposed with a separation in a running direction of the support, a solution containing cellulose acylate may be flow cast and layered to prepare a film. Methods described in, for instance, JP-A Nos. 61-158414, 1-122419 and 11-198285 can be applied. Furthermore, two flow-casting ports may be used to flow cast a cellulose acylate solution to form a film. Methods described in, for instance, JP-B-60-27562, JP-A Nos. 61-94724, 61-104813, 61-158413 and 6-134933 can be used. Still furthermore, a cellulose acylate film flow-casting method described in JP-A-56-162617, in which a flow of a high viscosity cellulose acylate solution is covered with a flow of a low viscosity cellulose acylate film and high and low viscosity cellulose acylate solutions are simultaneously extruded can be used as well.

Alternatively, with two flow-casting ports, a film molded on a support with a first flow-casting port is peeled off, followed by applying a second flow casting on a side in contact with a support surface, and thereby a film may be prepared. This method is described in, for instance, JP-B-44-20235. The cellulose acylate solutions that are flow cast may be the same cellulose acylate solution or different cellulose acylate solutions without restricting to particular one. In order to impart a function to each of a plurality of cellulose acylate layers, a cellulose acylate solution corresponding to the function may be extruded from each of the flow-casting ports.

Furthermore, in the invention, a cellulose acylate solution can be simultaneously flow cast together with another functional layer (for instance, adhesive layer, dye layer, antistatic layer, anti-halation layer, UV-absorption layer and polarization layer) forming solution to simultaneously form a functional layer and a film.

In a monolayer solution, in order to obtain a necessary film thickness, a high concentration and high viscosity cellulose acylate solution is necessary to be extruded. In that case, in many cases, a cellulose acylate solution is poor in the stability to generate solid matters, resulting in generating black dots and planarity irregularity. As a method of overcoming the problem, a plurality of cellulose acylate solutions is flow cast from a flow casting port. Thereby, not only a high viscosity solution can be simultaneously extruded on a support to be able to form a film improved in the planarity and excellent in a surface shape, but also, by using a high concentration cellulose acylate solution, a drying burden can be reduced and a film production speed can be heightened.

In the cellulose acylate film, in order to improve the mechanical physicality or to improve the drying speed after the flow casting, a plasticizer may be added. As the plasticizer, phosphoric esters or carboxylic esters can be used. Examples of the phosphoric ester include triphenyl phosphate (TPP), diphenylbiphenyl phosphate and tricresyl phosphate (TCP). As carboxylic ester, phthalic ester and citric ester are typical. Examples of phthalic ester include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of citric ester include O-acetyltrimethyl citrate (OACTE) and O-acetyltributyl citrate (OACTB). Examples of other carboxylic ester include butyl oleate, methylacetyl ricinolate, butyl sebacate and various kinds of trimellitate esters. Phthalic ester base plasticizers (DMP, DEP, DBP, DOP, DPP and DEHP) are preferably used. Among these, DEP and DPP are particularly preferable.

An addition amount of a plasticizer is, to an amount of cellulose acylate, preferably in the range of 0.1 to 25 mass percent, more preferably in the range of 1 to 20% mass percent and most preferably in the range of 3 to 15 mass percent.

The cellulose acylate film may contain a degradation inhibitor (for instance, an antioxidant, a peroxide decomposition agent, a radical inhibitor, a metal deactivator, an acid scavenger, or an amine). The degradation inhibitor is described in JP-A Nos. 3-199201, 5-197073, 5-194789, 5-271471 and 6-107854. An addition amount of degradation inhibitor is, in view of effect of the degradation inhibitor and bleed-out (exudation) to a film surface, to a solution (dope) being prepared, preferably in the range of 0.01 to 1 mass percent and more preferably in the range of 0.01 to 0.2 mass percent. Examples of particularly preferable degradation inhibitors include butylated hydroxytoluene (BHT) and tribenzylamine (TBA).

In a cellulose acylate film, as needs arise, a retardation increasing agent can be used to control the retardation of a film. The retardation of a film is preferably in the range of 0 to 300 nm in a film thickness direction and in the range of 0 to 1000 nm in an in-plane direction.

As the retardation increasing agent, an aromatic compound having at least two aromatic rings is preferable and used in the range of 0.01 to 20 parts by mass (parts by weight) to 100 parts by mass of cellulose acylate. An aromatic compound is preferably used, to 100 parts by mass of cellulose acylate, in the range of 0.05 to 15 parts by mass and more preferably in the range of 0.1 to 10 parts by mass. Two or more kinds of aromatic compounds may be used together.

Details thereof are described in JP-A Nos. 2000-111914, 2000-275434 and 2002-236215 and WO 00/065384.

(Stretching of Cellulose Acylate Film)

When the prepared cellulose acylate film is further stretched, the film thickness irregularity and surface irregularity caused by non-uniform drying and drying contraction can be improved. Furthermore, the stretching can be used as well to control the retardation.

A method of stretching in a width direction is not restricted to particular one. As an example thereof, a stretching method by means of a tenter can be cited.

Furthermore, more preferably, longitudinal stretching in a longer direction of a roll is applied. In this case, when, between pass rolls that convey a roll film, a draw ratio (rotation ratio of pass rolls) of the respective pass rolls is controlled, thereby a longitudinal stretching can be applied.

(Surface Treatment of Cellulose Acylate Film)

The cellulose acylate film is preferably used after the surface treatment. The specific examples of the surface treatment include corona discharge, glow discharge, flame treatment, acid treatment, alkali treatment or UV-light irradiation. Furthermore, as described in JP-A-7-333433, an undercoat layer is preferably disposed and used.

From a viewpoint of maintaining the flatness of a film, in the treatment, a temperature of the cellulose acylate film is preferably set at Tg or less, specifically 150° C. or less.

Like a case where an optical film according to the invention is used as a protective film of a polarizing plate, when a cellulose acylate film is adhered to a polarizer, from a viewpoint of the adhesiveness with the polarizer, acid-treatment or alkali-treatment, that is, saponification treatment to the cellulose acylate can be particularly preferably applied.

From the viewpoint of the adhesiveness, a surface energy of a cellulose acylate film is preferably 55 mN/m or more and more preferably 60 mN/m or more and 75 mN/m or less and can be controlled by the foregoing surface treatment.

The surface energy of a solid can be determined according to a contact angle method, a heat of wetting method, and an adsorption method as described in Nure no kiso to oyo (Basics and Applications of Wetting) (published on 1989. 12. 10 by Realize Inc.). In the case of the cellulose acetate film, it is preferable to employ the contact angle method.

Specifically, two kinds of solutions whose surface energy is known are dropped on the cellulose acetate film, of angles formed between a tangent to a droplet and the film surface at an intersection of the surface of the droplet and the film surface, an angle including the droplet is defined as a contact angle, and the surface energy of the film can be calculated.

In what follows, the surface treatment will be specifically described with the alkali saponification treatment as an example.

The alkali treatment is preferably carried out in a cycle involving dipping the film surface in an alkaline solution, then neutralizing with an acidic solution, washing with water, and drying.

Examples of the alkaline solution include a potassium hydroxide solution and a sodium hydroxide solution. A concentration of the alkalis is preferably in the range of 0.1 to 3.0 mol/l and more preferably in the range of 0.5 to 2.0 mol/l. A temperature of the alkaline solution is preferably in the range of room temperature to 90° C. and more preferably in the range of 40 to 70° C.

From a viewpoint of the productivity, after an alkali solution is coated and saponified, a film surface is washed with water to remove alkali therefrom. From the viewpoint of the wettability, as a coating solvent, alcohols such as IPA, n-butanol, methanol and ethanol are preferable, and as an aide for alkali dissolution, water, propylene glycol and ethylene glycol are preferably added and used.

<Polyethylene Terephthalate Film>

In the invention, a polyethylene terephthalate film as well can be preferably used because of being excellent in the transparency, mechanical strength, flatness, chemical resistance and moisture resistance and being cheap in the cost.

In order to further improve the adhesion strength between a transparent plastic film and a coated layer (for instance hard coat layer) disposed thereon, a transparent plastic film is more preferable to be one that is subjected to easy adhesion treatment.

As a commercially available PET film with an optical easy adhesion layer, COSMO SHINE A4100 and A4300 (trade name, manufactured by Toyobo Co., Ltd.) can be cited.

(Coated Layer (Optical Functional Layer))

<Hard Coat Layer>

An optical functional layer of an optical film of the invention preferably has a hard coat layer (or anti-glare layer) for imparting the mechanical strength of a film and thereon a lower refractive index layer that is lower in the refractive index than the hard coat layer and imparts the reflection-inhibiting property. More preferably, a hard coat layer and a lower refractive index layer are provided with an intermediate refractive index layer and a higher refractive index layer therebetween. Furthermore, a hard coat layer may be constituted with two or more layers stacked.

The refractive index of the hard coat layer in the invention, from a viewpoint of optical designing for obtaining a reflection proof film, is preferably in the range of 1.48 to 2.00, more preferably in the range of 1.52 to 1.90 and still more preferably in the range of 1.55 to 1.80. In the invention, it is preferable that the hard coat layer has thereon at least one layer of lower refractive index layer. In the configuration, when the refractive index is smaller than the above range, the antireflective property is deteriorated; on the other hand, when the refractive index is larger than the range, a color tint of reflected light tends to be stronger.

A film thickness of the hard coat layer is, from a viewpoint of imparting sufficient durability and impact resistance to the film, normally substantially in the range of 0.5 to 50 μm, preferably in the range of 1 to 20 μm, more preferably in the range of 2 to 10 μm and most preferably in the range of 3 to 7 μm.

Furthermore, the strength of the hard coat layer is preferably H or more, more preferably 2H or more, and most preferably 3H or more by pencil hardness test according to JIS K5400.

Still furthermore, it is preferable that a wear volume of a specimen before and after the test in the Taber test according to JIS K5400 is as small as possible.

A hard coat layer is preferably formed through a crosslinking reaction of an ionizing radiation curable compound or a polymerization reaction. For instance, a coating composition containing an ionizing radiation curable polyfunctional monomer or polyfunctional oligomer is coated on a transparent support, followed by crosslinking or polymerizing the polyfunctional monomer or polyfunctional oligomer to form a hard coat layer.

Examples of the transparent resin in the invention, polyfunctional monomers and polyfunctional oligomers can be cited.

As a functional group of the ionizing radiation curable polyfunctional monomer or polyfunctional oligomer, photo, electron beam or radiation polymerizable ones are preferable, and, among these, a photo-polymerizable functional group is preferable.

As the photo-polymerizable functional group, unsaturated polymerizable functional groups such as a (meth)acryloyl group, a vinyl group, a styryl group and an allyl group can be cited, and, among these, a (meth)acryloyl group is preferable.

Specific examples of photo-polymerizable polyfunctional monomer having a photo-polymerizable functional group include (meth)acrylic acid diesters of alkylene glycol such as neopentyl glycol acrylate, 1,6-hexanediol(meth)acrylate and propylene glycol di(meth)acrylate; (meth)acrylic acid diesters of polyoxyalkylene glycol such as triethylene glycol di(meth)acrylate, dipropylene glycol di(meth)acrylate, polyethylene glycol di(meth)acrylate and polypropylene glycol di(meth)acrylate; (meth)acrylic acid diesters of polyvalent alcohol such as pentaerythritol di(meth)acrylate; and (meth)acrylic acid diesters of ethylene oxide or propylene oxide adduct such as 2,2-bis {4-(acryloxy-diethoxy)phenyl}propane and 2-2-bis {4-(acryloxy-polypropoxy)phenyl}propane.

Furthermore, epoxy(meth)acrylates, urethane(meth)acrylates and polyester(meth)acrylates are preferably used as a photopolymerizable polyfunctional monomer.

Among these, esters of polyvalent alcohol with (meth)acrylic acid are preferred. Furthermore, a polyfunctional monomer having three or more (meth)acryloyl groups per molecule is more preferable. Specific examples thereof include trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, (di)pentaerythritol triacrylate, (di)pentaerythritol pentaacrylate, (di)pentaerythritol tetra(meth)acrylate, (di)pentaerythritol hexa(meth)acrylate, tripentaerythritol triacrylate and tripentaerythritol hexatriacrylate. In the specification, “(meth)acrylate”, “(meth)acrylic acid” and “(meth)acryloyl”, respectively, express “acrylate or methacrylate”, “acrylic acid or methacrylic acid” and “acryloyl or methacryloyl”.

Two or more kinds of polyfunctional monomers may be used in combination.

The polymerization reaction of a monomer having an ethylenic unsaturated group is preferably effected, under irradiation of ionizing irradiation or application of heat, in the presence of a photoradical polymerization initiator or thermal radical polymerization initiator.

Examples of the photoradical polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimmers, onium salts, borate salts, active esters, active halogens, inorganic complexes and coumalins.

Examples of the acetophenones include 2,2-dimethoxyacetophenone, 2,2-diethoxyacetophenone, p-dimethylacetophenone, 1-hydroxy-dimethylphenylketone, 1-hydroxy-dimethyl-p-isopropylphenyl ketone, 1-hydroxycyclohexylpheyl ketone, 2-methyl-4-methylthio-2-morpholino propiophenone, 2-benzyl-2-dimethylamino-1-(4-morpholinophenyl)-butanone, 4-phenoxydichloroacetophenone and 4-t-butyl-dichloroacetophenone.

Examples of the benzoins include benzoin, benzoinmethylether, benzoinethylether, benzoinisopropylether, benzilmethyl ketal, benzoinbenzenesulfonic acid ester, benzointoluenesulfonic acid ester, benzoin methyl ether, benzoin ethyl ether and benzoin isopropyl ether.

Examples of the benzophenones include benzophenone, hydroxybenzophenone, 4-benzoyl-4′-methyldiphenyl sulfide, 2,4-dichlorobenzophenone, 4,4-dichlorobenzophenone and p-chlorobenzophenone, 4,4′-dimethylaminobenzophenone (Michler's ketone) and 3,3′,4,4′-tetra(t-butylperoxycarbonyl)benzophenone.

Examples of the phosphine oxides include 2,4,6-trimethylbenzoyl diphenyl phosphine oxide.

Examples of the active esters include 1,2-octanedione, 1-[4-(phenylthio)-2-(O-benzoyloxime)], sulfonic esters and cyclic active ester compounds.

Examples of the onium salts include aromatic diazonium salts, aromatic iodonium salts and aromatic sulfonium salts.

Examples of the borate salts include ion complexes with a cationic pigment.

Examples of the active halogens include s-triazine and oxathiazole compounds including 2-(p-methoxyphenyl)-4,6-bis(trichloromethyl)-s-triazine, 2-(p-styrylphenyl)-4,6-bis(trichloromethyl)-s-triazine, 2-(3-Br-4-di(ethyl acetate)amino)phenyl)-4,6-bis(trichloromethyl)-s-triazine and 2-trihalomethyl-5-(p-methoxyphenyl)-1,3,4-oxadiazole.

Examples of the inorganic complexes include bis-(η⁵-2,4-cyclopentadien-1-yl)-bis(2,6-difluoro-3-(1H-pyrrol-1-yl)-phenyl)titanium.

Examples of the coumalins include 3-ketocoumalin.

These initiators may be used singularly or in a combination thereof.

Various examples are also described in Saishin UV Koka Gijutsu (Latest UV Curing Technologies), page 159 (1991), Technical Information Institute Co., Ltd. and are useful in the invention.

Examples of commercially available photoradical polymerization initiators include KAYACURE Series (for example, DETX-S, BP-100, BDMK, CTX, BMS, 2-EAQ, ABQ, CPTX, EPD, ITX, QTX, BTC and MCA) (trade name, manufactured by Nippon Kayaku Co., Ltd.), IRGACURE Series (for example, 651, 184, 819, 500, 907, 369, 1173, 2959, 4265 and 4263) (trade name, manufactured by Ciba Specialty Chemicals), and ESACURE Series (for example, KIP100F, KB1, EB3, BP, X33, KT046, KT37, KIP150 and TZT) (trade name, manufactured by Sartomer Company Inc.).

An amount of the photopolymerization initiator being used is preferably in the range of 0.1 to 15 parts by mass and more preferably in the range of 1 to 10 parts by mass based on 100 parts by mass of the polyfunctional monomer.

In addition to the photopolymerization initiator, a photosensitizer may be used. Specific examples of the photosensitizer include n-butylamine, triethylamine, tri-n-butylphosphine, Michler's ketone and thioxanthone. Examples of commercially available photosensitizers include KAYACURE Series (for example, DMBI and EPA) (trade name, manufactured by Nippon Kayaku Co., Ltd.).

The photopolymerization reaction is preferably carried out under irradiation of ultraviolet rays after coating and drying of the hard coat layer.

As the thermal radical initiator, organic or inorganic peroxides and organic azo or diazo compounds can be used.

Specifically, examples of the organic peroxides include benzoyl peroxide, halogen benzoyl peroxides, lauroyl peroxide, acetyl peroxide, dibutyl peroxide, cumene hydroperoxide and butyl hydroperoxide; examples of the inorganic peroxides include hydrogen peroxide, ammonium persulfate and potassium persulfate; examples of the azo compounds include 2,2′-azobis(isobutyronitrile), 2,2′-azobis(propionitrile) and 1,1′-azobis(cyclohexanecarbonitrile); and examples of the diazo compounds include diazoaminobenzene and p-nitrobenzenediazonium.

As the polymer containing a polyether as a principal chain, a ring-opening polymer of a polyfunctional epoxy compound is preferable. The ring-opening polymerization of a polyfunctional epoxy compound can be carried out under irradiation of ionizing radiations or application of heat in the presence of a photo acid generator or a thermal acid generator.

Accordingly, the hard coat layer can be formed by preparing a coating solution containing a polyfunctional epoxy compound, a photo acid generator or a thermal acid generator, a light-transmitting fine particle and an inorganic fine particle and coating the coating solution on a transparent support, followed by curing owing to a polymerization reaction with ionizing radiations or heat.

A light-transmitting resin where in place of or in addition to the monomer containing two or more ethylenically unsaturated groups, a crosslinking functional group-containing monomer is used to introduce a crosslinking functional group in a polymer, and, owing to a reaction of the crosslinking functional group, a crosslinking structure is introduced into a polymer may be used.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. Vinylsulfonic acid, acid anhydrides, cyanoacrylate derivatives, melamine, etherified methylol, esters and urethanes and metal alkoxides such as tetramethoxysilane can be utilized as well as the monomer for introducing a crosslinking structure. A functional group that exhibits crosslinking properties as a result of decomposition reaction, such as a block isocyanate group, may be used as well. That is, in the invention, the crosslinking functional group may be one that does not exhibit reactivity immediately but exhibits reactivity as a result of decomposition.

The light-transmitting resins having a crosslinking functional group can form a crosslinking structure by heating after coating.

The crosslinked or polymerized light-transmitting resin of the hard coat layer has a structure in which the principal chain of a polymer is crosslinked or polymerized. Examples of the principal chain of a polymer include polyolefins (saturated hydrocarbons), polyethers, polyureas, polyurethanes, polyesters, polyamines, polyamides and melamine resins. Of these, a polyolefin principal chain, a polyether principal chain and a polyurea principal chain are preferable; a polyolefin principal chain and a polyether principal chain are more preferable; and a polyolefin principal chain is the most preferable.

The polyolefin principal chain is made of a saturated hydrocarbon. The polyolefin principal chain is obtained for instance by addition polymerization reaction of an unsaturated polymerizable group. In the polyether principal chain, repeating units are bonded via an ether bond (—O—). A polyether principal chain is obtained for instance through a ring opening polymerization reaction of an epoxy group. In a polyurea principal chain, repeating units are bonded via a urea bond (—NH—CO—NH—). The polyurea principal chain is obtained for instance by polycondensation reaction between an isocyanate group and an amino group. In the polyurethane principal chain, repeating units are bonded via a urethane bond (—NH—CO—O—). The polyurethane principal chain is obtained for instance by polycondensation reaction between an isocyanate group and a hydroxyl group (including an N-methylol group). In the polyester principal chain, repeating units are bonded via an ester bond (—CO—O—). The polyester principal chain is obtained for instance by a polycondensation reaction between a carboxyl group (including an acid halide group) and a hydroxyl group (including an N-methylol group). In the polyamine principal chain, repeating units are bonded via an imino bond (—NH—). The polyamine principal chain is obtained owing to for instance a ring opening polymerization reaction of an ethyleneimine group. In the polyamide principal chain, repeating units are bonded via an amide bond (—NH—CO—). The polyamide principal chain is obtained for instance by a reaction between an isocyanate group and a carboxyl group (including an acid halide group). The melamine resin principal chain is obtained owing to for instance a polycondensation reaction between a triazine group (for example, melamine) and an aldehyde (for example, formaldehyde). Incidentally, in the melamine resin, the principal chain itself has a crosslinking or polymerization structure.

In order to control the refractive index of the hard coat layer, a higher refractive index monomer or an inorganic fine particle or both can be added to the light-transmitting resin of the hard coat layer. The inorganic fine particle has not only an effect of controlling the refractive index but also an effect of suppressing the cure shrinkage owing to a crosslinking reaction. In the invention, a polymer formed by polymerization of the foregoing polyfunctional monomer and/or higher refractive index monomer after forming the hard coat layer and one including inorganic fine particle dispersed therein are called as well a light-transmitting resin.

Examples of the higher refractive index monomer include bis(4-methacryloylthiophenyl) sulfide, vinylnaphthalene, biphenyl sulfide and 4-methacryloxyplhenyl-4′-methoxyphenyl thioether.

Examples of the inorganic fine particle include an oxide of at least one metal selected from silicon, zirconium, titanium, aluminum, indium, zinc, tin and antimony, BaSO₄, CaCO₃, talc, and kaolin. A particle diameter thereof is 100 nm or less and preferably 50 nm or less. By finely pulverizing the inorganic fine particle to 100 nm or less, a hard coat layer can be formed without deteriorating the transparency.

In order to make the hard coat layer have higher refractive index, ultra-fine particles of an oxide of at least one metal selected from Al, Zr, Zn, Ti, In and Sn are preferable. Specific examples thereof include ZrO₂, TiO₂, Al₂O₃, In₂O₃, ZnO, SnO₂, Sb₂O₃ and ITO. Of these, ZrO₂ is particularly preferably used.

An addition amount of the higher refractive index monomer or inorganic fine particle is preferably in the range of 10 to 90 mass percent and more preferably in the range of 20 to 80 mass percent to a total mass of the light-transmitting resin. Two or more kinds of inorganic fine particles may be used within the hard coat layer.

It is also preferred in the invention that a dispersion stabilizer or a surface treatment agent is used in combination to inhibit the inorganic fine particles from aggregating or precipitating or to form a bond with the transparent resin to improve the mechanical strength. Examples of the dispersion stabilizer and surface treatment agent include polyvinyl alcohol, polyvinyl pyrrolidone, a cellulose derivative, polyamide, a phosphate ester, polyether, a surfactant, a silane-coupling agent and a titanium-coupling agent. In particular, a silane-coupling agent is preferably used owing to the large film strength after curing. An addition amount of the silane-coupling agent as the dispersion stabilizer is not particularly restricted, and for example, is preferably 1 part by weight or more per 100 parts by weight of the inorganic fine particles. A method of addition of the dispersion stabilizer or surface treatment agent is neither particularly restricted. These may be added as previously hydrolyzed one, or in such a manner that after a silane-coupling agent as the dispersion stabilizer and the inorganic fine particles are mixed, hydrolysis and condensation are applied.

The haze of the hard coat layer varies depending on a function imparted to an anti-reflection film.

In a case where the definition of an image is maintained, the surface reflectance is suppressed low and a light-scattering function inside of and on a surface of the hard coat layer is not imparted, the lower a haze value is, the better, specifically, the haze value is preferably 10% or less, more preferably 5% or less and most preferably 2% or less.

On the other hand, when, in addition to the function of suppressing the surface reflectance low, a glare proof function due to scattering of ambient light owing to fine irregularity on a surface of the hard coat layer is imparted, the surface haze is preferably in the range of 5 to 15% and more preferably in the range of 5 to 10%.

Furthermore, when, owing to the internal scattering of the hard coat layer, a pattern, color irregularity, brightness irregularity and glittering of a liquid crystal panel are improved or, owing to scattering, a function of expanding a view angle is imparted, an internal haze value (a value obtained by subtracting a surface haze value from a total haze value) is preferably in the range of 10 to 90%, more preferably in the range of 15 to 80% and most preferably in the range of 20 to 70%.

In the optical film according to the invention, depending on the object, the surface haze and internal haze can be freely designed.

The measurement of haze can be carried out with a haze meter MODEL 1001 DP (trade name, produced by NIPPON DENSHOKU Co., LTD.)

Furthermore, of the surface irregularity of the hard coat layer in the invention, in order to obtain a clear surface to maintain the sharpness of an image, among the characteristics that represent the surface roughness, for instance, the center line average roughness (Ra) is preferably set at 0.10 μm or less. The Ra is more preferably 0.09 μm or less and still more preferably 0.08 μm or less. In an optical film according to the invention, in particular, in an anti-reflection film having an anti-reflection layer on a hard coat layer, in the surface irregularity of a film, the surface irregularity of the hard coat layer is dominant. Accordingly, when the center line average roughness of the hard coat layer is controlled, the center line average roughness of the anti-reflection film can be controlled in the above range.

The center line average roughness (Ra) can be measured in accordance with JIS-B0601.

In order to maintain the sharpness of an image, in addition to controlling an irregular shape of a surface, the sharpness of a transmitted image is preferably controlled. A clear antireflection film of the invention preferably has the sharpness of a transmitted image of 60% or more. The sharpness of transmitted image is generally an index exhibiting the degree of blurring of an image imaged through a film. The larger the value is, the more excellent an image seen through the film is. The sharpness of transmitted image is more preferably 70% or more, and further preferably 80% or more.

Here, the sharpness of transmitted image can be measured with an optical comb having a slit width of 0.5 mm by use of an image clarity meter (trade name: ICM-2D Model, manufactured by Suga Test Instruments Co., Ltd.) in accordance with JIS K7105.

On the other hand, when the anti-glare function is imparted, the center line average roughness (Ra) is preferably in the range of 0.10 to 0.40 μm. When the roughness (Ra) exceeds 0.4 μm, the glittering and, when ambient light is reflected, whitening of a surface are caused. Furthermore, a value of the sharpness of transmitted image is preferably in the range of 5 to 60%.

In order to impart a viewing angle enlarging function, in addition to controlling the internal haze value, it is important to control an intensity distribution (scattered light profile) of scattered light measured by a goniophotometer of the hard coat layer. For instance, in the case of a liquid crystal display, as light that is exited from a backlight is scattered more and more by an anti-reflection film disposed on a surface of a polarizing plate on an observer side, the viewing angle characteristics can be more improved. However, when the scattering is too large, there are problems in that the back scattering becomes prominent to lower the front brightness, or, owing to large scattering, the sharpness of image is deteriorated. Accordingly, the intensity distribution of scattered light of the hard coat layer is necessarily controlled in a certain range. In order to achieve desired recognition characteristics, an intensity of scattered light at an exit angle of 30°, which is particularly related to a viewing angle improvement effect, to a light intensity at an exit angle of 0° of the scattered light profile is preferably in the range of 0.01 to 0.2%, more preferably in the range of 0.02 to 0.15% and most preferably in the range of 0.02 to 0.1%.

For measuring a scattered light profile of an anti-reflection film with a hard coat layer, an automatic varied-angle goniophotometer GP-5 (trade name, produced by MURAKAMI COLOR RESEARCH LABORATORY CO., Ltd.) can be used.

As a method of imparting surface haze and/or internal haze to a hard coat layer, light transmitting particle is preferably incorporated in a light transmitting resin (containing refractive index controllable inorganic particle) made of an ionizing radiation curable compound.

In the case of the surface haze being imparted, light transmitting particle is preferably incorporated in the hard coat layer to form an irregular shape on a surface.

On the other hand, in the case of the internal haze being imparted, light transmitting particle different in the refractive index from the light transmitting resin is preferably incorporated. A difference of refractive indices of a binder and the light transmitting particle is preferably in the range of 0.02 to 0.20. The difference of the refractive indices in the above range generates an appropriate light scattering effect and does not cause the whitening of an entire film owing to an excessive light scattering effect. The difference of the refractive indices is preferably in the range of 0.03 to 0.15 and more preferably in the range of 0.04 to 0.13.

A combination of the binder and the light transmitting particle can be appropriately selected to control the difference of the refractive indices.

A particle diameter of the light transmitting particle is preferably in the range of 0.5 to 6 μm. When the particle diameter is in the above range, since the light scattering effect is appropriate and the back scattering is small, the light utilization efficiency becomes sufficient, and furthermore, since the surface irregularity is small, the white blur and a glittering phenomenon hardly occur. The particle diameter of the light transmitting particle is preferably in the range of 0.7 to 5 μm and most preferably in the range of 1 to 4 μm.

In order to incorporate the light transmitting particle in the hard coat layer and to obtain a clear surface, a film thickness of the hard coat layer is necessarily controlled so that the particle does not generate surface irregularity. Normally, a film thickness is made larger so that a protrusion of the particle may not project from a surface of the hard coat layer, and, thereby, the surface roughness Ra (center line average roughness) can be made 0.10 μm or less.

The light transmitting particle may be an organic particle or an inorganic particle. The smaller the fluctuation in the particle diameter is, the less the fluctuation in the scattering characteristics is. Accordingly, a haze value can be readily designed. As the light transmitting particle, a plastic bead is preferable, in particular, one that has high transparency and the refractive index difference with a binder, which satisfies a numerical value as mentioned above, is preferable.

As the organic particle, crosslinked acryl particle (refractive index: 1.49), acryl-styrene copolymer particle (refractive index: 1.54), melamine particle (refractive index: 1.57), polycarbonate particle (refractive index: 1.57), styrene particle (refractive index: 1.60), crosslinked styrene particle (refractive index: 1.61), polyvinyl chloride particle (refractive index: 1.60) and benzoguanamine-melamine formaldehyde particle (refractive index: 1.68) can be used.

As the inorganic particle, silica particle (refractive index: 1.44), alumina particle (refractive index: 1.63) and titanium oxide particle can be used.

Among these, the crosslinked acryl particle, crosslinked styrene particle and silica particle are preferably used.

Here, the refractive index of the light transmitting resin can be quantitatively evaluated by directly measuring with Abbe's refractometer or by measuring a spectral reflection spectrum or spectral ellipsometry. The refractive index of the light transmitting particle can be obtained in such a manner that the light transmitting particle is equivalently dispersed in each of solvents of which refractive index is varied by varying a mixing ratio of two kinds of solvents different in the refractive index, the turbidity thereof is measured, and the refractive index of the solvent when the turbidity shows a minimum value is measured with Abbe's refractometer.

As to a particle diameter of the light transmitting particle, as described above, one in the range of 0.5 to 6 μm may well be appropriately selected and used, two kinds or more may be blended and used, and the particle may be blended in the range of 5 to 30 parts by mass to 100 parts by mass of a light transmitting resin and used.

In the case of the light transmitting particle as mentioned above, since the light transmitting particle tends to precipitate in the light transmitting resin, inorganic filler such as silica may be added to inhibit the light transmitting particle from precipitating. As an addition amount of the inorganic filler is increased, the light transmitting particle can be more effectively inhibited from precipitating; however, the transparency of a coated film is adversely affected. Accordingly, preferably, the inorganic filler having a particle diameter of 0.5 μm or less is added to the light transmitting resin to an extent that does not damage the transparency of the coated film, that is, substantially less than 0.1 mass percent.

<Surfactant for Coated Layer>

In the coated layer in the invention, in order to reduce, in particular, coating irregularity, drying unevenness and point-like defect to secure planar uniformity, any one of a fluorinated and silicone-base surfactant, or both thereof may be preferably added to a coated layer forming coating composition. In particular, the fluorinated surfactant, being effective in improving planar failures such as the coating irregularity, drying unevenness and point-like defect of the coated film of the invention at a smaller addition amount, can be preferably used.

It is intended to impart high speed coating aptitude while enhancing the planar uniformity to improve the productivity.

Furthermore, the surfactants can be preferably used in the hard coat layer and anti-glare layer.

Preferable examples of the fluorinated surfactant include a fluoroaliphatic group-containing copolymer (in some cases, abbreviated as “fluoropolymer”). As the fluoropolymer, a copolymer between an acrylic resin or a methacrylic resin, which include a repeating unit corresponding to a (i) monomer described below or a repeating unit corresponding to a (ii) monomer described below, and a vinyl monomer polymerizable therewith is useful.

(i) Fluoroaliphatic Group-containing Monomer expressed by Formula A below

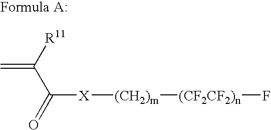

In the formula A, R¹¹ represents a hydrogen atom or a methyl group, X represents an oxygen atom, a sulfur atom or —N(R¹²)—, m represents an integer of 1 or more and 6 or less, and n represents an integer of 2 through 4. R¹² represents a hydrogen atom or an alkyl group having 1 through 4 carbon atoms, specifically, a methyl group, an ethyl group, a propyl group or a butyl group, and R¹² is preferably a hydrogen atom or a methyl group. X is preferably an oxygen atom.

(ii) Monomer polymerizable with the (i) and expressed by Formula B below

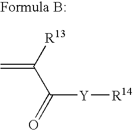

In the formula B, R¹³ represents a hydrogen atom or a methyl group, Y represents an oxygen atom, a sulfur atom or —N(R¹⁵)—, R¹⁵ represents a hydrogen atom or an alkyl group having 1 through 4 carbon atoms, specifically, a methyl group, an ethyl group, a propyl group or a butyl group, and R¹⁵ being preferably a hydrogen atom or a methyl group. Y is preferably an oxygen atom, —N(H)— and —N(CH₃)—

R¹⁴ represents a linear, branched or cyclic alkyl group that has 4 or more and 20 or less carbon atoms and may have a substitution group. As the substitution group of the alkyl group of R¹⁴, a hydroxyl group, an alkylcarbonyl group, an arylcarbonyl group, a carboxyl group, an alkylether group, an arylether group, a halogen atom such as a fluorine atom, a chlorine atom or a bromine atom, a nitro group, a cyano group or an amino group can be cited without restricting thereto. As the linear, branched or cyclic alkyl group that has 4 or more and 20 or less carbon atoms, a linear or branched butyl group, a linear or branched pentyl group, a linear or branched hexyl group, a linear or branched heptyl group, a linear or branched octyl group, a linear or branched nonyl group, a linear or branched decyl group, a linear or branched undecyl group, a linear or branched dodecyl group, a linear or branched tridecyl group, a linear or branched tetradecyl group, a linear or branched pentadecyl group, a linear or branched octadecyl group, a linear or branched eicosanyl group, a monocyclic cycloalkyl group such as a cyclohexyl group and a cycloheptyl group, and a polycyclic cycloalkyl group such as a bicycloheptyl group, a bicyclodecyl group, a tricycloundecyl group, a tetracyclododecyl group, an adamantyl group, a norbornyl group and a tetracyclodecyl can be preferably used.

An amount of the fluoroaiphatic group-containing monomer that is used in the fluoropolymer used in the invention and represented by the formula A is, based on the respective monomers of the fluoropolymer, 10 mol percent or more, preferably in the range of 15 to 70 mol percent and more preferably in the range of 20 to 60 mol percent.

A mass average molecular weight of the fluoropolymer used in the invention is preferably in the range of 3,000 to 100,000 and more preferably in the range of 5,000 to 80,000.

Furthermore, an addition amount of the fluoropolymer used in the invention is, to a coating solution, preferably in the range of 0.001 to 5 mass percent, more preferably in the range of 0.005 to 3 mass percent, and still more preferably in the range of 0.01 to 1 mass percent. When an addition amount of the fluoropolymer is less than 0.001 mass percent, an advantage can be insufficiently obtained. On the other hand, when it exceeds 5 mass percent, a coated film may be insufficiently dried, and thereby performance (for instance, reflectance and scratch resistance) as a coated film is adversely affected.

In what follows, examples of specific structure of the fluoropolymer containing a fluoroaliphatic group-containing monomer expressed by the formula A are shown below without restricting thereto. In the formula, a numeral in the formula shows a mol ratio of each of the monomers. Mw expresses a mass average molecular weight.

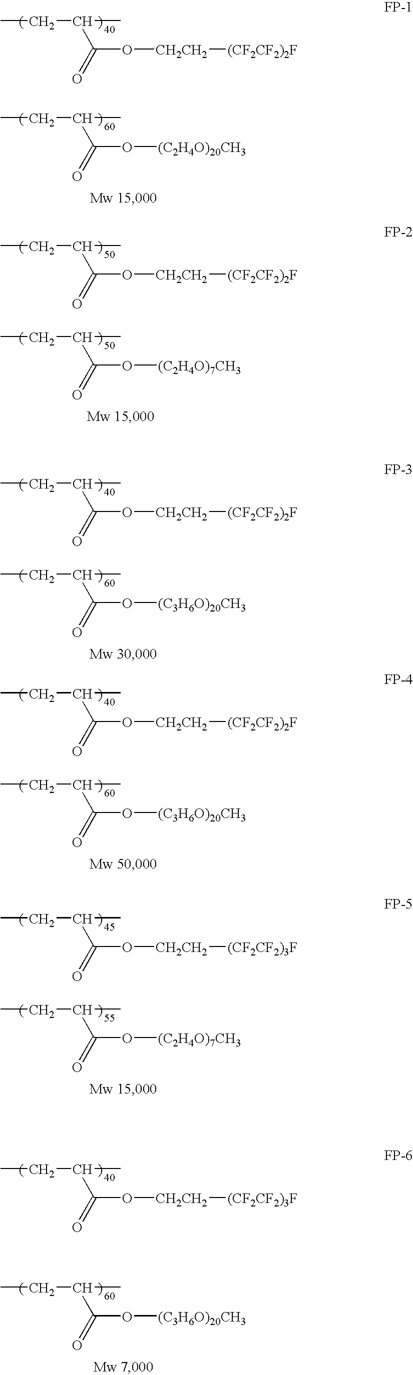

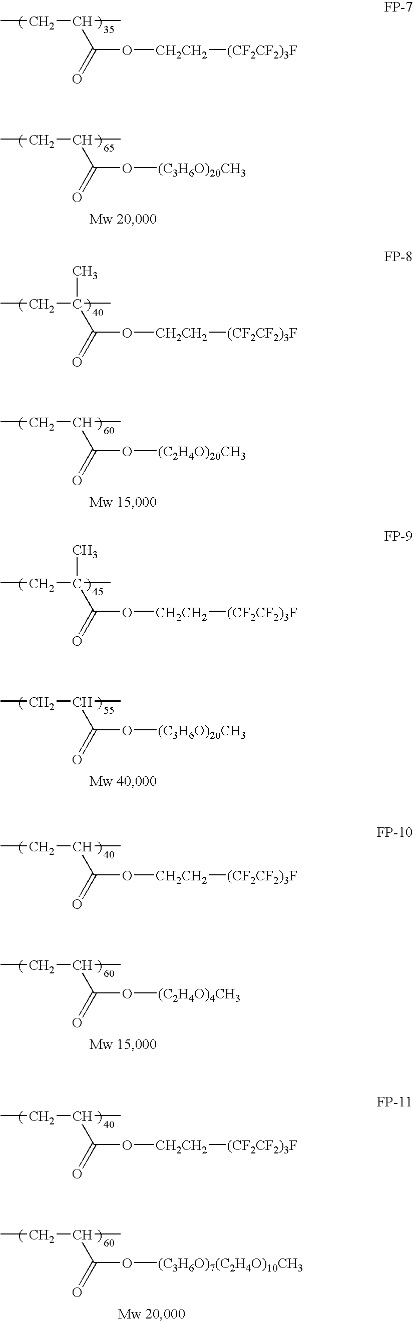

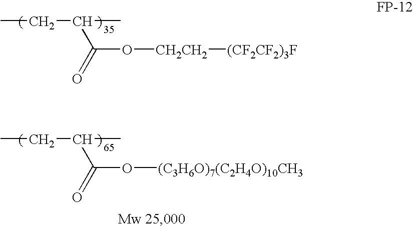

However, in particular, in the formation of a hard coat layer (or anti-glare layer), when the fluoropolymer such as described above is used, functional groups containing a F atom segregate on a surface of the hard coat layer to lower the surface energy of the anti-glare layer, and thereby, when a lower refractive index layer is overcoated on the hard coat layer, the anti-reflection performance is deteriorated. This is assumed that, since the wettability of a curable composition that is used to form a lower refractive index layer is deteriorated, minute visually unobservable irregularity is unfavorably formed on the lower refractive index layer. In order to overcome such a problem, it was found effective to control a structure of the fluoropolymer and an addition amount thereof to control the surface energy of the hard coat layer preferably in the range of 20 to 50 mN/m and more preferably in the range of 30 to 40 mN/m. In order to realize the surface energy such as described above, F/C that is a ratio of peaks derived from fluorine atoms and carbon atoms, which is measured by X-ray photoelectron spectrometry, is necessary in the range of 0.1 to 1.5.

Alternatively, when an upper layer is formed, a fluoropolymer that is extracted by a solvent that forms the upper layer is selected. Thereby, there is formed no segregation on a surface of a lower layer (=interface) and the adhesiveness between the upper and lower layers can be imparted. As a result, an optical film that can maintain the planar uniformity even in a high-speed coating and is strong in the scratch resistance can be provided. By inhibiting the surface energy from lowering to control a surface energy of the hard coat layer before coating a lower refractive index layer in the above range, the object can be achieved as well. Examples of such raw materials include copolymers between an acrylic resin or a methacrylic resin that contains a repeating unit corresponding to a fluoroaliphatic group-containing monomer expressed by a formula C below and a vinyl monomer polymerizable therewith.

(iii) Fluoroaliphatic group-containing Monomer expressed by Formula C below

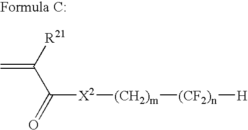

In the formula C, R²¹ represents a hydrogen atom or a halogen atom or a methyl group, a hydrogen atom and a methyl group being more preferable. A sign, X², represents an oxygen atom, a sulfur atom or —N(R²²)—, an oxygen atom or —N(R²²)— being preferable, an oxygen atom being more preferable. A sign, m, represents an integer of 1 or more and 6 or less (preferably in the range of 1 through 3, and more preferably 1) and a sign, n, represents an integer of 1 or more and 18 or less (preferably in the range of 4 through 12, and more preferably in the range of 6 through 8). A sign, R²², represents a hydrogen atom or an alkyl group that may have a substitution group and has 1 through 8 carbon atoms, preferably a hydrogen atom or an alkyl group having 1 through 4 carbon atoms, and more preferably a hydrogen atom or a methyl group. The X is desirably an oxygen atom.

Furthermore, a fluoropolymer may contain two or more kinds of fluoroaliphatic group-containing monomers expressed by the formula C as a constituent component.

(iv) Monomer expressed by Formula D below and polymerizable with the (iii)

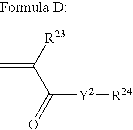

In the formula D, a sign, R²³, represents a hydrogen atom, a halogen atom or a methyl group, a hydrogen atom and a methyl group being more preferable. A sign, Y², represents an oxygen atom, a sulfur atom or —N(R²⁵)—, an oxygen atom or —N(R²⁵)— being more preferable, an oxygen atom being still more preferable. A sign, R²⁵, represents a hydrogen atom or an alkyl group having 1 through 8 carbon atoms, more preferably a hydrogen atom or an alkyl group having 1 through 4 carbon atoms, and still more preferably a hydrogen atom or a methyl group.

A sign, R²⁴, represents a linear, branched or cyclic alkyl group that may have a substitution group and has 1 through 20 carbon atoms, an alkyl group containing a poly(alkyleneoxy) group or an aromatic group that may have a substitution group (for instance, phenyl group or naphtyl group). The linear, branched or cyclic alkyl group having 1 through 12 carbon atoms or an aromatic group having 6 through 18 carbon atoms in total is more preferable and the linear, branched or cyclic alkyl group having 1 through 8 carbon atoms is still more preferable.

In what follows, examples of specific structure of the fluoropolymer containing a repeating unit corresponding to a fluoroaliphatic group-containing monomer expressed by the formula C are shown below without restricting thereto. In the formula, a numeral in the formula shows a mol ratio of each of the monomers. Mw expresses a mass average molecular weight.

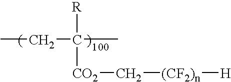

| | R | n | Mw |
|---|---|---|---|
| P-1 | H | 5 | 8000 |
| P-2 | H | 4 | 6000 |
| P-3 | H | 4 | 33000 |
| P-4 | CH₃ | 4 | 12000 |
| P-5 | CH₃ | 4 | 28000 |
| P-6 | H | 6 | 8000 |
| P-7 | H | 6 | 14000 |
| P-8 | H | 6 | 29000 |
| P-9 | CH₃ | 6 | 10000 |
| P-10 | CH₃ | 6 | 21000 |
| P-11 | H | 8 | 4000 |
| P-12 | H | 8 | 16000 |
| P-13 | H | 8 | 31000 |
| P-14 | CH₃ | 8 | 3000 |

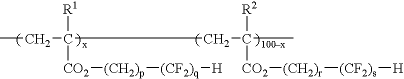

| | x | R¹ | p | q | R² | r | s | Mw |
|---|---|---|---|---|---|---|---|---|
| P-15 | 50 | H | 1 | 4 | CH₃ | 1 | 4 | 10000 |
| P-16 | 40 | H | 1 | 4 | H | 1 | 6 | 14000 |
| P-17 | 60 | H | 1 | 4 | CH₃ | 1 | 6 | 21000 |
| P-18 | 10 | H | 1 | 4 | H | 1 | 8 | 11000 |
| P-19 | 40 | H | 1 | 4 | H | 1 | 8 | 16000 |
| P-20 | 20 | H | 1 | 4 | CH₃ | 1 | 8 | 8000 |
| P-21 | 10 | CH₃ | 1 | 4 | CH₃ | 1 | 8 | 7000 |
| P-22 | 50 | H | 1 | 6 | CH₃ | 1 | 6 | 12000 |
| P-23 | 50 | H | 1 | 6 | CH₃ | 1 | 6 | 22000 |
| P-24 | 30 | H | 1 | 6 | CH₃ | 1 | 6 | 5000 |

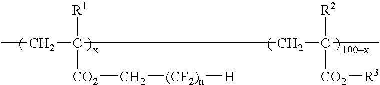

| | x | R¹ | n | R² | R³ | Mw |
|---|---|---|---|---|---|---|
| FP-148 | 80 | H | 4 | CH₃ | CH₃ | 11000 |
| FP-149 | 90 | H | 4 | H | C₄H₉(n) | 7000 |
| FP-150 | 95 | H | 4 | H | C₅H₁₃ (n) | 5000 |
| FP-151 | 90 | CH₂ | 4 | H | CH₂CH(C₃H₅)C₄H₉(n) | 15000 |
| FP-152 | 70 | H | 6 | CH₃ | C₂H₅ | 18000 |
| FP-153 | 90 | H | 6 | CH₃ | 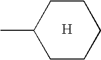 | 12000 |
| FP-154 | 80 | H | 6 | H | C₄H₉(sec) | 9000 |
| FP-155 | 90 | H | 6 | H | C₁₂H₂₅(n) | 21000 |
| FP-156 | 60 | CH₃ | 6 | H | CH₃ | 15000 |
| FP-157 | 60 | H | 8 | H | CH₃ | 10000 |
| FP-158 | 70 | H | 8 | H | C₂H₅ | 24000 |
| FP-159 | 70 | H | 8 | H | C₄H₉(n) | 5000 |
| FP-160 | 50 | H | 8 | H | C₄H₉(n) | 16000 |
| FP-161 | 80 | H | 8 | CH₃ | C₄H₉(iso) | 13000 |
| FP-162 | 80 | H | 8 | CH₃ | C₄H₉(t) | 9000 |
| FP-163 | 60 | H | 8 | H | 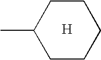 | 7000 |
| FP-164 | 80 | H | 8 | H | CH₂CH(C₂H₆)C₄H₉(n) | 8000 |
| FP-165 | 90 | H | 8 | H | C₁₂H₂₅(n) | 6000 |
| FP-166 | 80 | CH₃ | 8 | CH₃ | C₄H₉(sec) | 18000 |
| FP-167 | 70 | CH₃ | 8 | CH₃ | CH₃ | 22000 |
| FP-168 | 70 | H | 10 | CH₃ | H | 17000 |
| FP-169 | 90 | H | 10 | H | H | 9000 |

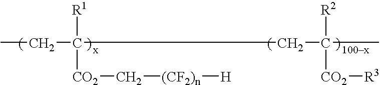

| | x | R¹ | n | R² | R³ | Mw |
|---|---|---|---|---|---|---|
| FP-170 | 95 | H | 4 | CH₃ | —(CH₂CH₂O)₂—H | 18000 |
| FP-171 | 80 | H | 4 | H | —(CH₂CH₂O)₂—CH₃ | 16000 |
| FP-172 | 80 | H | 4 | H | —(C₃H₆O)₇—H | 24000 |
| FP-173 | 70 | CH₃ | 4 | H | —(C₃H₆O)₁₃—H | 18000 |
| FP-174 | 90 | H | 6 | H | —(CH₂CH₂O)₂—H | 21000 |
| FP-175 | 90 | H | 6 | CH₃ | —(CH₂CH₂O)₃—H | 9000 |
| FP-176 | 80 | H | 6 | H | —(CH₂CH₂O)₂—C₄H₉(n) | 12000 |
| FP-177 | 80 | H | 6 | H | —(C₃H₆O)₇—H | 34000 |
| FP-178 | 75 | F | 6 | H | —(C₃H₆O)₁₃—H | 11000 |
| FP-179 | 85 | CH₃ | 6 | CH₃ | —(C₃H₆O)₂₀—H | 18000 |
| FP-180 | 95 | CH₃ | 6 | CH₃ | —CH₂CH₂OH | 27000 |
| FP-181 | 90 | H | 8 | CH₃ | —(CH₂CH₂O)₈—H | 12000 |
| FP-182 | 95 | H | 8 | H | —(CH₂CH₂O)₉—CH₃ | 20000 |
| FP-183 | 90 | H | 8 | H | —(C₃H₈O)₇—H | 8000 |
| FP-184 | 95 | H | 8 | H | —(C₃H₆O)₂₀—H | 15000 |
| FP-185 | 90 | F | 8 | H | —(C₃H₆O)₁₃—H | 12000 |
| FP-186 | 80 | H | 8 | CH₃ | —(CH₂CH₂O)₂—H | 20000 |
| FP-187 | 90 | CH₃ | 8 | H | —(CH₂CH₂O)₉—CH₃ | 17000 |
| FP-188 | 90 | CH₃ | 8 | H | —(C₃H₈O)₇—H | 34000 |
| FP-189 | 80 | H | 10 | H | —(CH₂CH₂O)₃—H | 19000 |
| FP-190 | 90 | H | 10 | H | —(C₃H₈O)₇—H | 8000 |
| FP-191 | 80 | H | 12 | H | —(CH₂CH₂O)₇—CH₃ | 7000 |
| FP-192 | 95 | CH₃ | 12 | H | —(C₃H₈O)₇—H | 10000 |

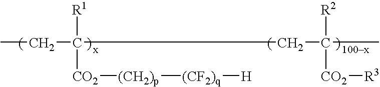

| | x | R¹ | p | q | R² | R³ | Mw |
|---|---|---|---|---|---|---|---|
| FP-193 | 80 | H | 2 | 4 | H | C₄H₉(n) | 18000 |
| FP-194 | 90 | H | 2 | 4 | H | —(CH₃CH₂O)₉—CH₃ | 16000 |
| FP-195 | 90 | CH₃ | 2 | 4 | F | C₆H₁₃(n) | 24000 |
| FP-196 | 80 | CH₃ | 1 | 6 | F | C₄H₉(n) | 18000 |
| FP-197 | 95 | H | 2 | 6 | H | —(C₃H₆O)₇—H | 21000 |
| FP-198 | 90 | CH₃ | 3 | 6 | H | —CH₂CH₂OH | 9000 |
| FP-199 | 75 | H | 1 | 8 | F | CH₃ | 12000 |
| FP-200 | 80 | H | 2 | 8 | H | CH₂CH(C₂H₆)C₄H₉(n) | 34000 |
| FP-201 | 90 | CH₃ | 2 | 8 | H | —(C₃H₈O)₇—H | 11000 |
| FP-202 | 80 | H | 3 | 8 | CH₃ | CH₃ | 18000 |
| FP-203 | 90 | H | 1 | 10 | F | C₄H₉(n) | 27000 |
| FP-204 | 95 | H | 2 | 10 | H | —(CH₂CH₂O)_{9—CH}₈ | 12000 |
| FP-205 | 85 | CH₃ | 2 | 10 | CH₃ | C₄H₉(n) | 20000 |
| FP-206 | 80 | H | 1 | 12 | H | C₆H₁₃(n) | 8000 |
| FP-207 | 90 | H | 1 | 12 | H | —(C₃H₆O)₁₃—H | 15000 |
| FP-208 | 60 | CH₃ | 3 | 12 | CH₃ | C₂H₅ | 12000 |
| FP-209 | 60 | H | 1 | 16 | H | CH₂CH(C₂H₆)C₄H₉(n) | 20000 |
| FP-210 | 80 | CH₃ | 1 | 16 | H | —(CH₂CH₂O)₂—C₄H₉ | 17000 |
| | | | | | | (n) | |
| FP-211 | 90 | H | 1 | 18 | H | —CH₂CH₂OH | 34000 |
| FP-212 | 60 | H | 3 | 18 | CH₃ | CH₃ | 19000 |

Furthermore, when, at the time of over-coating a lower refractive index layer on the hard coat layer, the surface energy is inhibited from lowering, the anti-reflection performance can be inhibited from being deteriorated. The object can be achieved as well by controlling the surface energy of the hard coat layer before coating a lower refractive index layer in the above range in such a manner that during the coating of the hard coat layer, a fluoropolymer is used to lower the surface tension of a coating solution to improve the planar uniformity and to maintain a high-speed productivity owing to a high-speed coating, and, after the coating of the hard coat layer, by use of a surface treatment method such as corona treatment, UV treatment, heat treatment, saponification treatment or solvent treatment, particularly preferably, a corona treatment, the surface free energy is inhibited from lowering.

Still furthermore, in the invention, in a coating composition for forming a hard coat layer, a thixotropy agent may be added. As the thixotropy agent, silica and mica of 0.1 μm or less can be cited. A content of the additive is normally preferably set substantially in the range of 1 to 10 parts by mass to 100 parts by mass of a UV-curable resin.

In the case of the hard coat layer and a transparent support coming into contact, a solvent of a coating solution for forming a hard coat layer, in order to balance the control (making the irregularity smaller or level) of the irregularity on a surface of the hard coat layer and the adhesiveness between the transparent support and the hard coat layer, is preferably constituted of at least one kind or more of solvents that dissolve the transparent support (for instance, triacetyl cellulose support) and at least one kind of solvents that do not dissolve the transparent support. More preferably, at least one kind of the solvents that do not dissolve the transparent support has a boiling temperature higher than that of at least one kind of the solvents that dissolve the transparent support.

Examples of solvents that dissolve a transparent support (preferably triacetyl cellulose) include:

ethers having 3 through 12 carbon atoms specifically such as dibutyl ether, dimethoxy methane, dimethoxy ethane, diethoxy ethane, propylene oxide, 1,4-dioxane, 1,3-dioxoran, 1,3,5-trioxane, tetrahydrofuran, anisole and phenetol;

ketones having 3 through 12 carbon atoms specifically such as acetone, methyl ethyl ketone, diethyl ketone, dipropyl ketone, diisobutyl ketone, cyclopentane, cyclohexanone and methyl cyclohexanone;

esters having 3 through 12 carbon atoms specifically such as ethyl formate, propyl formate, n-pentyl formate, methyl acetate, ethyl acetate, methyl propionate, n-pentyl acetate and γ-butylolactone; and

organic solvents having two or more kinds of functional groups specifically such as 2-methoxy acetic acid methyl, 2-ethoxy acetic acid ethyl, 2-ethoxy acetic acid ethyl, 2-ethoxy propionic acid ethyl, 2-methoxy ethanol, 2-propoxy ethanol, 2-buthoxy ethanol, 1,2-diacetoxy acetone, acetylacetone, diacetone alcohol, acetoacetic acid methyl and acetoacetic acid ethyl.

These can be used singularly or in a combination of two or more kinds. As the solvent that dissolves a transparent support, a ketone base solvent is preferable.

Examples of the solvent that does not dissolve the transparent support (preferably triacetyl cellulose) include methanol, ethanol, 1-propanol, 2-propanol, 1-buthanol, 2-buthanol, tert-buthanol, 1-pentanol, 2-methyl-2-buthanol, cyclohexanol, ethylene glycol, propylene glycol, isobutyl acetate, methyl isobutyl ketone, 2-octanone, 2-pentanone, 2-hexanone, 2-heptanone, 3-pentanone, 3-heptanone and 4-heptanone.

These can be used singularly or in a combination of two or more kinds.

A mass ratio (A/B) of a total amount (A) of a solvent that dissolves a transparent support to a total amount (B) of a solvent that does not dissolve the transparent support is preferably in the range of 5/95 to 50/50, more preferably in the range of 10/90 to 40/60 and still more preferably in the range of 15/85 to 30/70.

<Lower Refractive Index Layer>

An optical film according to the invention preferably has a lower refractive index layer as an outermost layer. The refractive index of the lower refractive index layer is preferably in the range of 1.20 to 1.46, more preferably in the range of 1.25 to 1.41 and most preferably in the range of 1.30 to 1.39. Furthermore, the lower refractive index layer preferably satisfies a expression (1) below from the viewpoint of realizing lower reflectance.
(m₁/4)λ×0.7<n₁d₁<(m₁/4)λ×1.3 Expression (1)

In the expression (1), m₁ expresses a positive odd integer, n₁ expresses the refractive index of a lower refractive index layer and d₁ expresses a film thickness (nm) of the lower refractive index layer. Furthermore, λ expresses a wavelength and a value in the range of 500 to 550 nm. That the expression (1) is satisfied means that in the above wavelength range there is m₁ (positive odd integer, normally 1) satisfying the expression (1).

In the lower refractive index layer, as a lower refractive index binder, a fluoropolymer or a fluorine-containing sol-gel material is contained. As the fluoropolymer or fluorine-containing sol-gel material, a material that forms a crosslink owing to heat or ionizing radiation and has dynamic friction coefficient of a surface of a formed lower refractive index layer in the range of 0.03 to 0.15 and a contact angle to water in the range of 90 to 120° is preferable. In the invention, an inorganic fine particle is used in the lower refractive index layer to improve the film strength thereof.

As the fluoropolymer that is used in the lower refractive index layer, other than a hydrolysate or dehydration condensate of a perfluoroalkyl group-containing silane compound (for instance, (heptadecafluoro-1,1,2,2-tetrahydrodecyl)triethoxy silane), a fluorine-containing copolymer that has a fluorine-containing monomer unit and a constituent unit for imparting the crosslinking reactivity as a constituent component can be cited.

Specific examples of the fluorine-containing monomer unit include fluoroolefins (for instance, fluoroethylene, vinylidene fluoride, tetrafluoroethylene, hexafluoropropylene and perfluoro-2,2-dimethyl-1,3-dioxol), partly or completely fluorinated alkyl ester derivatives of (meth)acrylic acid (for instance, Biscoat 6FM (trade name, produced by OSAKA ORGANIC CHEMICAL INDUSTRY LTD.) and M-2020 (trade name, produced by DAIKIN INDUSTRIES, ltd.), and partly or completely fluorinated vinyl ether derivatives of (meth)acrylic acid. Among these, perfluoroolefins are preferable. Particularly preferred one among these is hexafluoropropylene from the viewpoint of the refractive index, solubility, transparency and availability.

Examples of the constituent unit for providing crosslinking reactivity include a constituent unit obtained by polymerizing a monomer previously provided with a self-crosslinkable functional group in a molecule like glycidyl (meth)acrylate and glycidyl vinyl ether, a constituent unit obtained by polymerizing a monomer provided with a carboxyl group, a hydroxyl group, an amino group or a sulfo group (for instance, (meth)acrylic acid, methylol (meth)acrylate, hydroxyalkyl (meth)acrylate, allyl acrylate, hydroxy ethyl vinyl ether, hydroxy butyl vinyl ether, maleic acid and crotonic acid), and a constituent unit obtained by introducing a crosslinking reactive group such as a (meth)acryloyl group into these constituent units by polymer reaction (for instance, a method involving the action of acrylic acid chloride on hydroxyl group can be used).

Other than the aforementioned fluorine-containing monomer units and the constituent units for providing the crosslinking reactivity, a monomer free of a fluorine atom may be properly copolymerized from the viewpoint of the solubility in a solvent and the transparency of film. The monomer unit that can be used in combination therewith is not particularly restricted. Examples of the monomer unit employable herein include olefins (for instance, ethylene, propylene, isoprene, vinyl chloride and vinylidene chloride), acrylic acid esters (for instance, methyl acrylate, ethyl acrylate and 2-ethylhexyl acrylate), methacrylic acid esters (for instance, methyl methacrylate, ethyl methacrylate, butyl methacrylate and ethylene glycol dimethacrylate), a styrene derivative (for instance, styrene, divinylbenzene, vinyl toluene and α-methylstyrene), vinyl ethers (for instance, methyl vinyl ether, ethyl vinyl ether and cyclohexyl vinyl ether), vinyl esters (for instance, vinyl acetate, vinyl propionate and vinyl cinnamate), acrylamides (for instance, N-tert-butyl acrylamide and N-cyclohexylacylamide), methacrylamides, and acrylonitrile derivatives.

The aforementioned polymer may be used properly in combination with a curing agent as disclosed in JP-A-10-25388 and JP-A-10-147739.

A particularly useful fluorine-containing polymer in the invention is a random copolymer of perfluoroolefin and vinyl ethers or vinyl esters. The fluorine-containing polymer preferably contains a group which can undergo a crosslinking reaction per se (for instance, radical reactive group such as a (meth)acryloyl group, and a ring-opening polymerizable group such as an epoxy group and an oxetanyl group). The crosslinking reactive group-containing polymerizing unit accounts for preferably from 5 to 70 mol percent, particularly preferably from 30 to 60 mol percent of all the polymerizing units of the polymer.

Furthermore, it is preferable that a polysiloxane structure is introduced in the fluorine-containing polymer of the invention for the purpose of imparting stain resistance. A method of introducing a polysiloxane structure is not particularly restricted. However, as described in JP-A Nos. 11-189621, 11-228631 and 2000-313709, a method of introducing a polysiloxane block copolymer component with a silicone macroazo initiator and a method of introducing a polysiloxane graft copolymer component with a silicone macromer as described in JP-A Nos. 2-251555 and 2-308806 are preferable. A content of the polysiloxane component is preferably in the range of 0.5 to 10 mass percent and particularly preferably in the range of 1 to 5 mass percent in the polymer.

Other than the foregoing methods, a measure for adding a reactive group-containing polysiloxane (for instance, KF-100T, X-22-169AS, KF-102, X-22-37011E, X-22-164B, X-22-5002, X-22-173B, X-22-174D, X-22-167B and X-22-161AS (trade name, all of which are manufactured by Shin-Etsu Chemical Co., Ltd.); AK-5, AK-30 and AK-32 (trade name, all of which are manufactured by Toagosei Co., Ltd.); and SILAPLANE FM0275 and SILAPLANE FM0721 (trade name, all of which are manufactured by Chisso Corporation) is as well preferable for the purpose of imparting stain resistance. Such polysiloxane is preferably added in an amount ranging from 0.5 to 10 mass percent, and particularly preferably from 1 to 5 mass percent based on a whole solid content of the lower refractive index layer.

In the invention, in the lower refractive index layer, in order to establish a balance between the lower refractive index and the scratch resistance, a hollow silica fine particle is incorporated.

The refractive index of the hollow silica fine particle is preferably in the range of 1.17 to 1.40, more preferably in the range of 1.17 to 1.35 and most preferably in the range of 1.17 to 1.30. Here, the refractive index expresses the refractive index of a particle as a whole and does not express only that of silica of a crust that forms the hollow silica fine particle. At this time, when a expresses a radius of a void inside of the particle and b expresses a radius of a crust of a particle, the porosity X can be calculated with a expression (2) below.
x=((4πa³/3)/(4πb³/3))×100 Expression (2)

The porosity x is preferably in the range of 10 to 60%, more preferably in the range of 20 to 60% and most preferably in the range of 30 to 60%. When it is tried to make a hollow silica fine particle lower in the refractive index and higher in the porosity, a thickness of the crust becomes thinner to result in lowering the strength of the particle. Accordingly, from the viewpoint of the scratch resistance, a particle having such lower refractive index as less than 1.17 cannot be used.

The refractive index of the hollow silica fine particle was measured with Abbe's refractometer (produced by Atago Co., Ltd.).

A method of producing a hollow silica fine particle is described in, for instance, JP-A Nos. 2001-233611 and 2002-79616.

A coating amount of the hollow silica fine particle is preferably in the range of 1 to 100 mg/m², more preferably in the range of 5 to 80 mg/m², and further preferably in the range of 10 to 60 mg/m². When the coating amount falls within the foregoing range, not only an effect for realizing a lower refractive index and an effect for improving the scratch resistance are revealed, but also, since fine irregularities are not generated on a surface of the lower refractive index layer, there is no fear of deterioration of the appearance such as real black and integrated reflectance.

An average particle diameter of the hollow silica fine particle is 0.5 nm or more and 200 nm or less, preferably 20 nm or more and 150 nm or less, more preferably 30 nm or more and 80 nm or less and furthermore preferably 40 nm or more and 60 nm or less.

When the particle diameter of the hollow silica fine particle falls within the foregoing range, a ratio of voids is proper to lower the refractive index and the surface of the lower refractive index layer is free from deterioration of the appearance such as real black and integrated reflectance based on the fine irregularities.

The silica of the outer shell portion of the hollow silica fine particle may be crystalline or amorphous. Furthermore, though the particle size distribution of the hollow silica fine particles is preferable to be monodispersed one, it may be polydispersed one, or may be even coagulated one so far as a prescribed particle diameter is met. Although a shape is most preferably spherical, there is no problem even when it is an amorphous form.

Here, an average particle diameter of the hollow silica fine particle can be determined from an electron microscopic photograph.

In the invention, in order to improve the scratch resistance, together with the hollow silica fine particle, other inorganic fine particles can be contained.

The inorganic fine particle, being incorporated in the lower refractive index layer, is desirably low in the refractive index. For instance, magnesium fluoride and silica can be cited. In particular, from the point of views of the refractive index, dispersion stability and cost, void-less silica fine particle is preferable. A particle diameter of the void-less silica fine particle is preferably 30 nm or more and 150 nm or less, more preferably 35 nm or more and 80 nm or less and most preferably 40 nm or more and 60 nm or less.

Furthermore, at least one kind of silica fine particles (hereinafter, referred to as “small diameter silica fine particle”) having an average particle diameter less than 25% of a thickness of the lower refractive index layer is preferably used together with the silica fine particle having the above particle diameter (hereinafter, referred to as “large diameter silica fine particle”).

The small diameter silica fine particle, being able to exist in a gap between the large diameter silica fine particles, can contribute as a retaining agent of the large diameter silica fine particles.

An average particle diameter of the small diameter silica fine particle is preferably 1 nm or more and 20 nm or less, more preferably 5 nm or more and 15 nm or less and particularly preferably 10 nm or more and 15 nm or less. Such silica fine particle can be preferably used from the viewpoint of the raw material cost and the retaining agent effect.

The silica fine particle, in order to obtain, in a dispersion solution or a coating solution, the dispersion stability or to enhance the affinity and the bonding nature with a binder component, may be subjected to physical surface treatment such as plasma discharge or corona discharge or chemical surface treatment with a surfactant and a coupling agent. A coupling agent is particularly preferably used. As the coupling agent, an alkoxy metal compound (for instance, titanium-coupling agent and silane-coupling agent) can be preferably used. Among these, the silane-coupling agent is preferable, organosilane compounds expressed by formulas (1) and (2) described below are preferable and a silane-coupling agent having an acryloyl group or a methacryloyl group can be particularly effectively used.

The coupling agent may be used, as a surface treatment agent of the inorganic fine particle of a lower refractive index layer, to apply surface treatment prior to preparation of the lower refractive index layer coating solution. However, it is preferable to incorporate in the lower refractive index layer by adding as an additive at the time of preparation of the coating solution.

From the viewpoint of alleviating the burden of surface treatment, the silica particle is preferably dispersed in a medium prior to the surface treatment.

In the invention, from the viewpoint of the anti-scratch, at least any one of a hydrolysate of an organosilane compound and a partial condensate thereof, a so-called sol component (hereinafter, referred to like this), is preferably contained in at least one layer of a hard coat layer and a lower refractive index layer, and more preferably in both of the hard coat layer and the lower refractive index layer.

An appropriate content of the sol of organosilane is different depending on a layer being added. An addition amount to a lower refractive index layer is, based on a total solid content in the lower refractive index layer, preferably in the range of 0.1 to 50 mass percent, more preferably in the range of 0.5 to 20 mass percent and particularly preferably in the range of 1 to 10 mass percent.

In the lower refractive index layer, an amount of sol of organosilane used to a fluorine-containing polymer is, from the viewpoints of an effect of usage of the sol, the refractive index of the layer and shape and surface appearance of a layer formed, preferably in the range of 5 to 100 mass percent, more preferably in the range of 5 to 40 mass percent, still more preferably in the range of 8 to 35 mass percent and particularly preferably in the range of 10 to 30 mass percent.

An addition amount of the sol of organosilane to the hard coat layer is, based on a total solid content of a light diffusion layer, preferably in the range of 0.5 to 50 mass percent, more preferably in the range of 1 to 30 mass percent and particularly preferably in the range of 2 to 20 mass percent. An addition amount to a layer other than the above is, based on a total solid content of a containing layer (added layer), preferably in the range of 0.001 to 50 mass percent, more preferably in the range of 0.01 to 20 mass percent, still more preferably in the range of 0.05 to 10 mass percent, and particularly preferably in the range of 0.1 to 5 mass percent.

An organosilane compound being used can be expressed by a formula (1) below.
(R¹⁰)ₘ—Si(X)₄₋ₘ Formula (1)

In the formula (1), R¹⁰ represents a substituted or unsubstituted alkyl or aryl group.

A sign, X, represents a hydrolyzable group and preferred examples thereof include an alkoxy group (preferably an alkoxy group having 1 to 5 carbon atoms such as a methoxy group and an ethoxy group), a halogen atom (for instance, Cl, Br and I), or R²COO (in which R² is preferably a hydrogen atom or an alkyl group having 1 to 5 carbon atoms such as CH₃COO and C₂H₅COO). Preferred one among these is an alkoxy group, particularly a methoxy group or an ethoxy group.

A suffix m represents an integer of 1 to 3. When there is a plurality of R¹⁰'s or X's, the plurality of R¹⁰'s or X's may be the same or different from each other. The suffix m is preferably 1 or 2 and particularly preferably 1.

A substituent group on R¹⁰ is not restricted to particular one. Examples of these substituent groups include a halogen atom (for instance, fluorine, chlorine or bromine), a hydroxyl group, a mercapto group, a carboxyl group, an epoxy group, an alkyl group (for instance, methyl, ethyl, i-propyl, propyl or t-butyl), an aryl group (for instance, phenyl or naphthyl), an aromatic heterocyclic group (for instance, furyl, pyrazolyl or pyridyl), an alkoxy group (for instance, methoxy, ethoxy, i-propoxy or hexyloxy), an aryloxy group (for instance, phenoxy), an alkylthio group (for instance, methylthio or ethylthio), an arylthio group (for instance, phenylthio), an alkenyl group (for instance, vinyl or 1-propenyl), an acyloxy group (for instance, acetoxy, acryloyloxy or methacryloyloxy), an alkoxycarbonyl group (for instance, methoxycarbonyl or ethoxycarbonyl), an aryloxycarbonyl group (for instance, phenoxycarbonyl), a carbamoyl group (for instance, carbamoyl, N-methylcarbamoyl, N,N-dimethylcarbamoyl or N-methyl-N-octylcarbamoyl), and an acylamino group (for instance, acetylamino, benzoylamino, acrylamino or methacrylamino). These substituent groups may be further substituted.

When there is a plurality of R¹⁰'s, at least one of these is preferably a substituted alkyl group or a substituted aryl group.

Among organosilane compounds represented by the formula (1), an organosilane compound having a vinyl polymerizable substituent group represented by the following formula (2) is preferable.

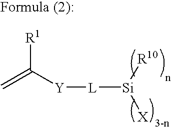

In the formula (2), R¹ represents a hydrogen atom, an alkyl group (methyl group or methoxy group), an alkoxy group (methoxy group or ethoxy group), an alkoxycarbonyl group (methoxycarbonyl group or ethoxycarbonyl group), a cyano group or a halogen atom (fluorine atom or chlorine atom). Among the above, the hydrogen atom, the methyl group, the methoxy group, the methoxycarbonyl group, the cyano group, the fluorine atom and the chlorine atom are preferred, the hydrogen atom, the methyl group, the methoxycarbonyl group, the fluorine atom and the chlorine atom being further preferred, and the hydrogen atom and the methyl group being particularly preferred.

A sign, Y, represents a single bond, an ester group, an amide group, an ether group or a urea group. Among these, the single bond, the ester group and the amide group are preferred, the single bond and the ester group are more preferred and the ester group is most preferred.

A sign, L, represents a divalent connecting group. Specific examples thereof include a substituted or unsubstituted alkylene group, a substituted or unsubstituted arylene group, a substituted or unsubstituted alkylene group having a connecting group (for instance, ether, ester or amide) therein, and a substituted or unsubstituted arylene group having a connecting group therein. Among these, the substituted or unsubstituted alkylene group, the substituted or unsubstituted arylene group, and the alkylene group having a connecting group therein are preferred, an unsubstituted alkylene group, an unsubstituted arylene group and an alkylene group having a connecting group made of ether or ester therein are further preferred, and the unsubstituted alkylene group and the alkylene group having a connecting group made of ether or ester therein are particularly preferred. The substituent group includes a halogen atom, a hydroxyl group, a mercapto group, a carboxyl group, an epoxy group, an alkyl group and an aryl group, and the substituent group may be further substituted.

A suffix, n, represents 0 or 1. When there exists a plurality of X's, the plurality of X's may be the same or different from each other. The suffix, n, is preferably 0.

A sign, R¹⁰, is the same as that in the formula (1), preferred to be a substituted or unsubstituted alkyl group or an unsubstituted aryl group and more preferred to be an unsubstituted alkyl group or an unsubstituted aryl group.

A sign, X, is the same as that in the formula (1), preferred to be a halogen atom, a hydroxyl group or an unsubstituted alkoxy group, more preferred to be a chlorine atom, a hydroxyl group or an unsubstituted alkoxy group having 1 to 6 carbon atoms, still more preferred to be a hydroxyl group or an alkoxy group having 1 to 3 carbon atoms, and particularly preferred to be a methoxy group.

As the organosilane compound, compounds represented by the formulas (1) and (2) may be used in a combination of two or more kinds. When these are combined to use, an organosilane compound having a vinyl polymerizable substitution group represented by the formula (2) and a compound that does not have a vinyl polymerizable substitution group are preferably used in combination. In what follows, specific examples of the compounds represented by the formulas (1) and (2) are shown without restricting thereto.

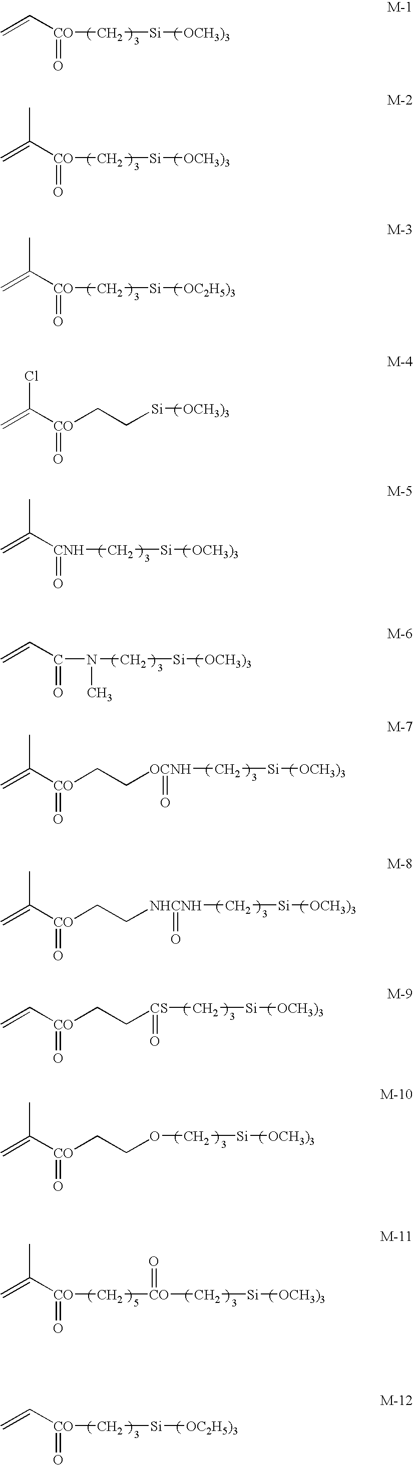

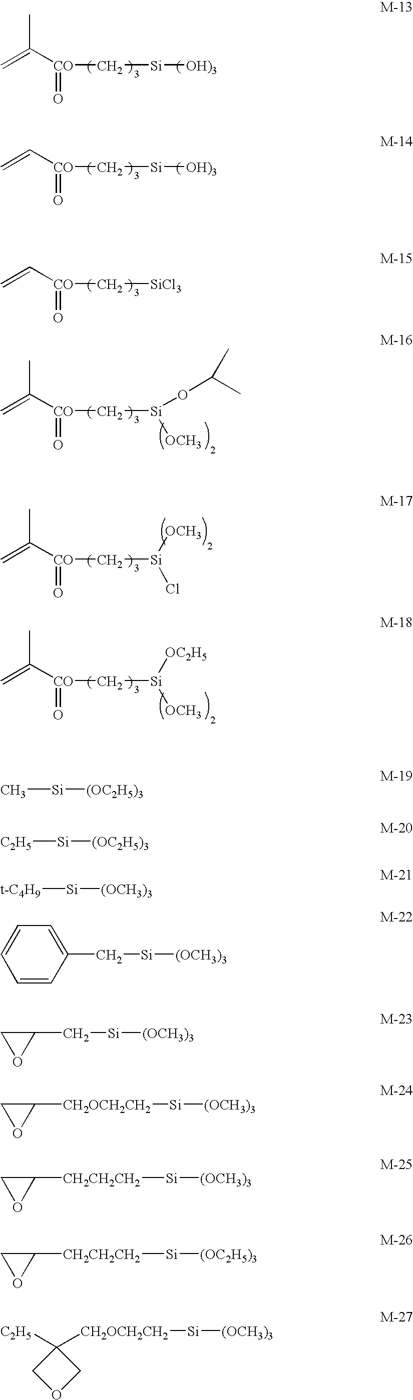

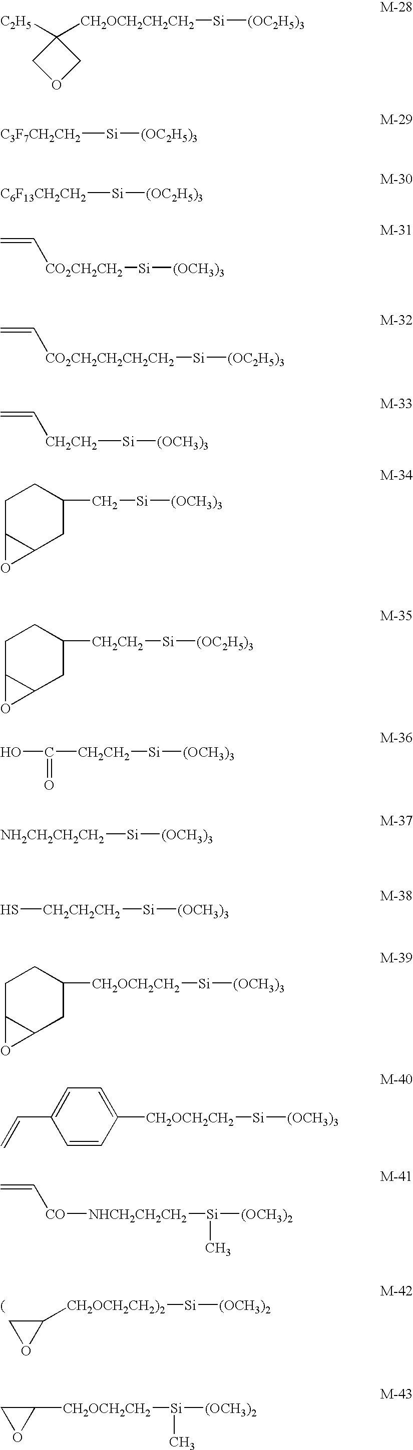

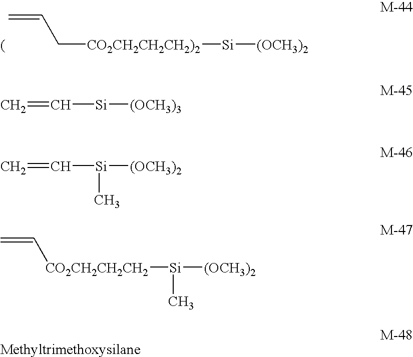

Among the foregoing compounds, M-1, M-2, M-5, M-19 through M-21 and M-48 are preferable. When these are used in combination, as an organosilane compound having a vinyl polymerizable substitution group, any one of M-1, M-2 and M-5, and, as a compound that does not have a vinyl polymerizable substitution group, any one of M-19 through M-21 and M-48 are preferably combined to use.

The hydrolysis/condensation reaction of organosilane may be performed with or without a solvent. However, in order to uniformly mix the components, an organic solvent is preferably used. Suitable examples thereof include alcohols, aromatic hydrocarbons, ethers, ketones and esters.

The solvent is preferably a solvent capable of dissolving organosilane and a catalyst. Furthermore, an organic solvent is preferably used as a coating solution or a part of a coating solution in view of process, and those that do not impair the solubility or dispersibility when it is mixed with other materials such as fluorine-containing polymer are preferred.

Among these organic solvents, examples of the alcohols include a monohydric alcohol or a dihydric alcohol. The monohydric alcohol is preferably a saturated aliphatic alcohol having 1 through 8 carbon atoms. Specific examples of the alcohols include methanol, ethanol, n-propyl alcohol, i-propyl alcohol, n-butyl alcohol, sec-butyl alcohol, tert-butyl alcohol, ethylene glycol, diethylene glycol, triethylene glycol, ethylene glycol monobutyl ether and ethylene glycol acetate monoethyl ether.

Furthermore, specific examples of the aromatic hydrocarbons include benzene, toluene and xylene. Specific examples of the ethers include tetrahydrofuran and dioxane. Specific examples of the ketones include acetone, methyl ethyl ketone, methyl isobutyl ketone and diisobutyl ketone. Specific examples of the esters include ethyl acetate, propyl acetate, butyl acetate and propylene carbonate.

The organic solvents can be used singularly or in a combination of at least two kinds.

A concentration of a solid content in the reaction is, without restricting to particular one, normally in the range of 1 to 90% and preferably in the range of 20 to 70%.

The hydrolysis/condensation reaction of organosilane is preferably performed in the presence of a catalyst. Examples of the catalyst include an inorganic acid such as hydrochloric acid, sulfuric acid or nitric acid; an organic acid such as oxalic acid, acetic acid, formic acid, methanesulfonic acid or toluenesulfonic acid; an inorganic base such as sodium hydroxide, potassium hydroxide or ammonia; an organic base such as triethylamine or pyridine; a metal alkoxide such as triisopropoxyaluminum or tetrabutoxyzirconium; and a metal chelate compound with a metal such as Zr, Ti or Al as a center metal. From production stability and storage stability of the sol solution, acid catalysts (inorganic acids and organic acids) and metal chelate compounds are preferred. As the acid catalysts, among the inorganic acids, a hydrochloric acid and a sulfuric acid are preferred, and among the organic acids, those having an acid dissociation constant (pKa value (25° C.)) of 4.5 or less in water are preferred. Hydrochloric acid, sulfuric acid and organic acid having an acid dissociation constant of 3.0 or less in water are more preferred, a hydrochloric acid, a sulfuric acid and an organic acid having an acid dissociation constant of 2.5 or less in water are still more preferred, an organic acid having an acid dissociation constant of 2.5 or less in water is yet still more preferred, methanesulfonic acid, oxalic acid, phthalic acid and malonic acid are furthermore preferred, and an oxalic acid is particularly preferred.

The hydrolysis/condensation reaction is normally performed with water in an amount of 0.3 to 2 mol, preferably 0.5 to 1 mol added to one mol of the hydrolyzable group of organosilane under stirring at a temperature from 25 to 100° C. in the presence or absence of the above-described solvent and preferably in the presence of a catalyst.

In the case where a hydrolyzable group is alkoxide and a catalyst is organic acid, since a carboxyl group or a sulfo group of the organic acid supplies a proton, an amount of water added can be reduced. An amount of water added to 1 mole of the alkoxide group of organosilane is in the range of 0 to 2 mol, preferably in the range of 0 to 1.5 mol, more preferably in the range of 0 to 1 mol and particularly preferably in the range of 0 to 0.5 mol. When alcohol is used as a solvent, a case where water is not substantially added is preferable as well.

An amount of the catalyst used is, when the catalyst is inorganic acid, to a hydrolyzable group, 0.01 to 10 mol percent and preferably 0.1 to 5 mol percent; and when the catalyst is organic acid, though an appropriate amount used is different depending on an amount of water added, an amount of the catalyst is, to a hydrolyzable group, when water is added, 0.01 to 10 mol percent and preferably 0.1 to 5 mol percent, and, when the water is not substantially added, 1 to 500 mol percent, preferably 10 to 200 mol percent, more preferably 20 to 200 mol percent, still more preferably 50 to 150 mol percent and particularly preferably 50 to 120%.

The reaction is carried out at a temperature in the range of 25 to 100° C. under stirring. However, the temperature is preferably appropriately controlled depending on the reactivity of organosilane.

As a metal chelate compound, one that has an alcohol represented by a formula R³OH (wherein R³ represents an alkyl group having 1 to 10 carbon atoms) and a compound represented by R⁴COCH₂COR⁵ (wherein R⁴ represents an alkyl group having 1 to 10 carbon atoms and R⁵ represents an alkyl group having 1 to 10 carbon atoms or an alkoxy group having 1 to 10 carbon atoms) as ligands and with a metal selected from Zr, Ti and Al as a center metal can be preferably used. Within this category, two or more kinds of metal chelate compounds may be used in combination. The metal chelate compound for use in the present invention is preferably a compound selected from a group of compounds represented by formulae: Zr(OR³)ₚ₁(R⁴COCHCOR⁵)ₚ₂, Ti(OR³)_{q1}(R⁴COCHCOR⁵)_{q2} and Al(OR³)ᵣ₁(R⁴COCHCOR⁵)ᵣ₂, and these compounds have an activity of accelerating the condensation reaction of a hydrolysate and/or partial condensate of the organosilane compound.

In the metal chelate compounds, R³ and R⁴ may be the same or different and each represents an alkyl group having 1 to 10 carbon atoms, specifically such as an ethyl group, a n-propyl group, an i-propyl group, a n-butyl group, a sec-butyl group, a tert-butyl group, a n-pentyl group or a phenyl group. Furthermore, R⁵ represents, other than an alkyl group having 1 to 10 carbon atoms same as above, an alkoxy group having 1 to 10 carbon atoms such as a methoxy group, an ethoxy group, a n-propoxy group, an i-propoxy group, a n-butoxy group, a sec-butoxy group or a tert-butoxy group. In the metal chelate compounds, p1, p2, q1, q2, r1 and r2 each represent an integer determined so as to satisfy the relationships of p1+p2=4, q1+q2=4 and r1+r2=3.

Specific examples of the metal chelate compound include a zirconium chelate compound such as zirconium tri-n-butoxyethylacetoacetate, zirconium di-n-butoxy-bis(ethylacetoacetate), zirconium n-butoxy-tris(ethylacetoacetate), zirconium tetrakis(n-propylacetoacetate), zirconium tetrakis(acetylacetoacetate) and zirconium tetrakis(ethylacetoacetate); a titanium chelate compound such as titanium diisopropoxybis(ethylacetoacetate), titanium diisopropoxybis(acetylacetate) and titanium diisopropoxybis(acetylacetone); and an aluminum chelate compound such as aluminum diisopropoxyethylacetoacetate, aluminum diisopropoxyacetylacetonate, aluminum isopropoxybis(ethylacetoacetate), aluminum isopropoxybis(acetylacetonate), aluminum tris(ethylacetoacetate), aluminum tris(acetylacetonate) and aluminum monoacetylacetonatobis(ethylacetoacetate).

Among these metal chelate compounds, zirconium tri-n-butoxyethylacetoacetate, titanium diisopropoxybis(acetylacetonate), aluminum diisopropoxyethylacetoacetate and aluminum tris(ethylacetoacetate) are preferred. The metal chelate compounds may be used singularly or in a combination of two or more kinds. Furthermore, a partial hydrolysate of the metal chelate compound may be used as well.

The metal chelate compound according to the invention is used, from viewpoints of the velocity of a condensation reaction and the film strength when a film is formed, to organosilane, at a ratio preferably in the range of 0.01 to 50 mass percent, more preferably in the range of 0.1 to 50 mass percent and still more preferably in the range of 0.5 to 10 mass percent.

A solvent composition of a coating solution that is used to form a lower refractive index layer according to the invention may be a single component or a mixture of solvents. When it is a mixture, a solvent having a boiling temperature of 100° C. or less is preferably in the range of 50 to 100%, more preferably in the range of 80 to 100%, still more preferably in the range of 90 to 100% and most preferably 100%. When a solvent of which boiling temperature is 100° C. or less is in the above range, the drying rate is fast, a coated surface is excellent and a coated film thickness is uniform; accordingly, the optical characteristics such as the reflectance are excellent.

Specific examples of a solvent having a boiling point of 100° C. or less include hydrocarbons such as hexane (boiling point: 68.7° C., hereinafter, “° C.” will be omitted), heptane (98.4), cyclohexane (80.7) and benzene (80.1); halogenated hydrocarbons such as dichloromethane (39.8), chloroform (61.2), carbon tetrachloride (76.8), 1,2-dichloroethane (83.5) and trichloroethylene (87.2); ethers such as diethyl ether (34.6), diisopropyl ether (68.5), dipropyl ether (90.5) and tetrahydrofuran (66); esters such as ethyl formate (54.2), methyl acetate (57.8), ethyl acetate (77.1) and isopropyl acetate (89); ketones such as acetone (56.1) and 2-buthanone (=methyl ethyl ketone, 79.6); alcohols such as methanol (64.5), ethanol (78.3), 2-propanol (82.4) and 1-propanol (97.2); cyano compounds such as acetonitrile (81.6) and propionitrile (97.4); and carbon disulfide (46.2). Among these, ketones and esters are preferred and ketones are particularly preferred. Among the ketones, 2-buthanone is particularly preferred.

Specific examples of the solvent having a boiling point of 100° C. or more include octane (125.7), toluene (110.6), xylene (138), tetrachloroethylene (121.2), chlorobenzene (131.7), dioxane (101.3), dibutyl ether (142.4), isobutyl acetate (118), cyclohexanone (155.7), 2-methyl-4-pentanone (=MIBK, 115.9), 1-butanol (117.7), N,N-dimethylformamide (153), N,N-dimethylacetamide (166) and dimethyl sulfoxide (189). Among these, cyclohexanone and 2-methyl-4-pentanone are preferred.

When a lower refractive index layer component is diluted with a solvent having the above composition, a lower refractive index layer coating solution is prepared. A concentration of the coating solution is, though preferably appropriately controlled considering the viscosity of the coating solution and specific gravities of layer materials, preferably in the range of 0.1 to 20 mass percent and more preferably in the range of 1 to 10 mass percent.

<Higher Refractive Index Layer>

In an optical film according to the invention, a higher refractive index layer and a medium refractive index layer can be disposed on a hard coat layer to improve the anti-reflectivity. In the invention, the refractive indices of the higher refractive index layer and the medium refractive index layer are preferably in the range of 1.55 to 2.40. In the specification below, in some cases, the higher refractive index layer and the medium refractive index layer are collectively called as a higher refractive index layer. In the invention, “high”, “medium” and “low” of the higher refractive index layer, the medium refractive index layer and the lower refractive index layer express relative magnitude relationship between individual layers. Furthermore, with respect to relationship with a support, the refractivity preferably satisfies relationships of transparent support>lower refractive index layer and higher refractive index layer>transparent support.

The higher refractive index layer in the present invention preferably contains an inorganic fine particle mainly made of titanium dioxide containing at least one element selected from cobalt, aluminum and zirconium. The main component means a component of which content (mass percent) is highest among components that constitute the particle.

The inorganic fine particle mainly made of titanium dioxide in the present invention preferably has the refractive index in the range of 1.90 to 2.80, more preferably in the range of 2.10 to 2.80, and most preferably in the range of 2.20 to 2.80.

The mass average primary particle diameter of the inorganic fine particle mainly made of titanium dioxide is preferably in the range of 1 to 200 nm, more preferably in the range of 1 to 150 nm, still more preferably in the range of 1 to 100 nm, and particularly preferably in the range of 1 to 80 nm.

The particle diameter of the inorganic fine particle can be measured by a light scattering method or an electron microphotograph. The specific surface area of the inorganic fine particle is preferably in the range of 10 to 400 m²/g, more preferably in the range of 20 to 200 m²/g, and most preferably in the range of 30 to 150 m²/g.

As to a crystal structure of the inorganic fine particle mainly made of titanium dioxide, the main component preferably has a rutile structure, a rutile/anatase mixed crystal, an anatase structure or an amorphous structure, and more preferably a rutile structure. The main component means a component of which content (mass percent) is highest among components that constitute the particle.

By incorporating at least one element selected from Co (cobalt), Al (aluminum) and Zr (zirconium) into the inorganic fine particle mainly made of titanium dioxide, the photocatalytic activity of the titanium dioxide can be suppressed and thereby the weather resistance of the higher refractive index layer can be improved.

In particular, a preferred element is Co (cobalt). Two or more kinds thereof can be combined to use.

A content of Co (cobalt), Al (aluminum) or Zr (zirconium) to Ti (titanium) is preferably in the range of 0.05 to 30 mass percent, more preferably in the range of 0.1 to 10 mass percent, still more preferably in the range of 0.2 to 7 mass percent, yet still more preferably in the range of 0.3 to 5 mass percent, and most preferably in the range of 0.5 to 3 mass percent.

Co (cobalt), Al (aluminum) or Zr (zirconium) can be present at least either inside or on a surface of the inorganic fine particle mainly made of titanium dioxide, but the element is preferably present in the inside of the inorganic fine particle mainly made of titanium dioxide, and most preferably in both the inside and the surface.

Co (cobalt), Al (aluminum) or Zr (zirconium) can be made to exist (for example, doped) inside of the inorganic fine particle mainly made of titanium dioxide by various methods. A method described in Yasushi Aoki, Ion Chunyuhou (Ion Implantation Method), Journal of the Surface Science Society of Japan, Vol. 18, No. 5, pp. 262-268 (1998), JP-A-11-263620, JP-T-11-512336, EP-A-0335773 and JP-A-5-330825 can be cited.

A method of introducing Co (cobalt), Al (aluminum) or Zr (zirconium) in the process of forming the inorganic fine particle mainly made of titanium dioxide (for example, JP-T-11-512336, EP-A-0335773 and JP-A-5-330825) is particularly preferred.

Co (cobalt), Al (aluminum) or Zr (zirconium) is also preferably present in the form of an oxide.

The inorganic fine particle mainly made of titanium dioxide may further contain other elements depending on the applications. Other elements may be contained as impurities. Examples of other elements include Sn, Sb, Cu, Fe, Mn, Pb, Cd, As, Cr, Hg, Zn, Mg, Si, P and S.

The inorganic fine particle mainly made of titanium dioxide for use in the present invention may be surface-treated. The surface treatment is applied with an inorganic compound or an organic compound. Examples of the inorganic compound for use in the surface treatment include a cobalt-containing inorganic compound (CoO₂, Co₂O₃, Co₃O₄), an aluminum-containing inorganic compound (Al₂O₃, Al(OH)₃), a zirconium-containing inorganic compound (ZrO₂, Zr(OH)₄), a silicon-containing inorganic compound (SiO₂) and an iron-containing inorganic compound (Fe₂O₃).

Among these, a cobalt-containing inorganic compound, an aluminum-containing inorganic compound and a zirconium-containing inorganic compound are particularly preferred, and a cobalt-containing inorganic compound, Al(OH)₃ and Zr(OH)₄ are most preferred.

Examples of the organic compound for use in the surface treatment include a silane coupling agent and a titanate coupling agent. Among these, a silane coupling agent is most preferred, for instance, a silane coupling agent represented by the formula (1) or (2) can be cited.

A content of the silane coupling agent is, to a total solid content of the higher refractive index layer, preferably in the range of 1 to 90 mass percent, more preferably in the range of 2 to 80 mass percent and most preferably in the range of 5 to 50 mass percent.

Examples of the titanate coupling agent include a metal alkoxide such as tetramethoxy titanium, tetraethoxy titanium and tetraisorpopoxy titanium, and Preneact (trade name: KR-TTS, KR-46B, KR-55 and KR-41B, produced by Ajinomoto Co., Inc.).

Preferred examples of other organic compound for use in the surface treatment include polyol, alkanolamine and other organic compounds having an anionic group. Among these, an organic compound having a carboxyl group, a sulfonic acid group or a phosphoric acid group is particularly preferred. Stearic acid, lauric acid, oleic acid, linoleic acid and linolenic acid are preferably used.

The organic compound for use in the surface treatment preferably further has a crosslinking or polymerizable functional group. Examples of the crosslinking or polymerizable functional group include an ethylenically unsaturated group (for instance, (meth)acryl group, allyl group, styryl group or vinyloxy group) capable of additionally reacting/polymerizing by the effect of a radical species; a cationic polymerizable group (epoxy group, oxatanyl group, vinyloxy group); and a polycondensation reactive group (hydrolyzable silyl group, N-methylol group). Among these, a functional group having an ethylenically unsaturated group is preferred.

Two or more kinds of these surface treatments may be used in combination as well. A combinatorial use of an aluminum-containing inorganic compound and a zirconium-containing inorganic compound is particularly preferred.

The inorganic fine particle mainly made of titanium dioxide may be rendered to have a core/shell structure by the surface treatment as described in JP-A-2001-166104.

A shape of the inorganic fine particle mainly made of titanium dioxide, which is contained in the higher refractive index layer, is preferably a pebble form, a spherical form, a cubic form, a spindle form or an amorphous form, more preferably an amorphous form or a spindle form.

<Dispersant>

For dispersing the inorganic fine particle mainly made of titanium dioxide, which is used in the higher refractive index layer, a dispersant can be used.

In the invention, for the dispersion of the inorganic fine particle mainly made of titanium dioxide, a dispersant having an anionic group can be preferably used.

As the anionic group, a group having an acidic proton such as a carboxyl group, a sulfonic acid group (and sulfo group), a phosphoric acid group (and phosphono group) and a sulfonamide group, or a salt thereof is effective. In particular, a carboxyl group, a sulfonic acid group, a phosphonic acid group, and a salt thereof are preferred, and a carboxyl group and a phosphoric acid group are more preferred. As for the number of anionic groups contained per one molecule of the dispersant, it is sufficient when 1 or more anionic group is contained.

In order to further improve the dispersibility of the inorganic fine particle, a plurality of anionic groups may be contained. Two or more groups on an average are preferable, 5 or more groups are more preferable and 10 or more groups are most preferable. Furthermore, a plurality of kinds of anionic groups may be contained in one molecule of the dispersant.

The dispersant preferably further contains a crosslinking or polymerizable functional group. Examples of the crosslinking or polymerizable functional group include an ethylenically unsaturated group (for instance, (meth)acryloyl, allyl, styryl and vinyloxy group) capable of reacting additionally/polymerizing by the effect of a radical species; a cationic polymerizable group (epoxy, oxatanyl and vinyloxy group); and a polycondensation reactive group (hydrolyzable silyl and N-methylol group). Among these, a functional group having an ethylenically unsaturated group is preferred.

The dispersant preferably used for dispersing the inorganic fine particle mainly made of titanium dioxide, which is used in the higher refractive index layer of the present invention, is a dispersant having an anionic group and a crosslinking or polymerizable functional group and at the same time, having the crosslinking or polymerizable functional group on a side chain.

A mass average molecular weight (Mw) of the dispersant having an anionic group and a crosslinking or polymerizable functional group and at the same time, having the crosslinking or polymerizable functional group on a side chain is, without restricting particularly, preferably 1,000 or more. The mass average molecular weight (Mw) of the dispersant is more preferably from 2,000 to 1,000,000, still more preferably from 5,000 to 200,000 and particularly preferably from 10,000 to 100,000.

As the anionic group, a group having an acidic proton such as a carboxyl group, a sulfonic acid group (sulfo group), a phosphoric acid group (phosphono group) or a sulfonamide group, or a salt thereof is effective. In particular, a carboxyl group, a sulfonic acid group, a phosphoric acid group, and a salt thereof are preferred, and a carboxyl group and a phosphoric acid group are particularly preferred. The number of anionic groups contained per one molecule of the dispersant is, on average, preferably 2 or more, more preferably 5 or more, and particularly preferably 10 or more. Also, a plurality of kinds of anionic groups may be contained in one molecule of the dispersant.

The dispersant having an anionic group and a crosslinking or polymerizable functional group and at the same time, having the crosslinking or polymerizable functional group on a side chain has the anionic group on a side chain or at a terminal. As a method of introducing an anionic group on a side chain, for instance, a polymer reaction such as a method where a monomer containing an anionic group (for instance, (meth)acrylic acid, maleic acid, partially esterized maleic acid, itaconic acid, crotonic acid, 2-carboxyethyl (meth)acrylate, 2-sulfoethyl (meth)acrylate, and phosphoric acid mono-2-(meth)acryloyloxyethylester) is polymerized and a method where a polymer having a hydroxyl group or an amino group is allowed reacting with an acid anhydride can be used to synthesize.

In the dispersant having an anionic group on a side chain, a proportion of anionic group-containing repeating units is in the range of 10⁻⁴ to 100 mol percent, preferably in the range of 1 to 50 mol percent and particularly preferably in the range of 5 to 20 mol percent, based on all repeating units.

On the other hand, as a method of introducing an anionic group at a terminal, a method where a polymerization reaction is carried out in the presence of an anionic group-containing chain transfer agent (for instance, thioglycol acid) and a method where a polymerization reaction is carried out with anionic group-containing polymerization initiator (for instance, V-501: trade name, manufactured by Wako Pure Chemical Industries, Ltd.) can be used to synthesize.

A particularly preferable dispersant is a dispersant having an anionic group on a side chain.

Examples of the crosslinking or polymerizable functional group include an ethylenically unsaturated group (for instance, (meth)acryl group, allyl group, styryl group or vinyloxy group) capable of reacting additionally/polymerizing by the effect of a radical species; a cationic polymerizable group (for instance, epoxy group, oxatanyl group or vinyloxy group); and a polycondensation reactive group (for instance, hydrolyzable silyl group or N-methylol group). Among these, a functional group having an ethylenically unsaturated group is preferred.

The number of the crosslinking or polymerizable functional groups contained per one molecule of the dispersant is, on average, preferably 2 or more, more preferably 5 or more, particularly preferably 10 or more. Furthermore, a plurality of kinds of crosslinking or polymerizable functional groups may be contained in one molecule of the dispersant.

In the preferable dispersants for use in the invention, as an example of the repeating unit having an ethylenically unsaturated group on a side chain, one that has a repeating unit made of a poly-1,2-butadiene and poly-1,2-isoprene structure or a (meth)acrylic acid ester or amide repeating unit, to which a specific residue is bonded (R group of—COOR or —CONHR) can be cited. Examples of the specific residue group (R group) include —(CH₂)ₙ—CR₁═CR₂R₃, —(CH₂O)ₙ—CH₂CR₁═CR₂R₃, —(CH₂CH₂O)ₙ—CH₂CR₁═CR₂R₃, —(CH₂)ₙ—NH—CO—O—CH₂CR₁═CR₂R₃, —(CH₂)ₙ—O—CO—CR₁═CR₂R₃ and —(CH₂CH₂O)₂—X (wherein R₁ through R₃ each is a hydrogen atom, a halogen atom, an alkyl group having 1 to 20 carbon atoms, an aryl group, an alkoxy group or an aryloxy group, R₁ may combine with R₂ or R₃ to form a ring, a suffix n is an integer of 1 to 10, and X is a dicyclopentadienyl residue group). Specific examples of the ester residue group include —CH₂CH═CH₂, —CH₂CH₂O—CH₂CH═CH₂, —CH₂CH₂OCOCH═CH₂, —CH₂CH₂OCOC(CH₃)═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂ and —CH₂CH₂O—X (wherein X is a dicyclopentadienyl residue group). Specific examples of the amide residue group include —CH₂CH═CH₂, —CH₂CH₂—Y (wherein Y is a 1-cyclohexenyl residue group), —CH₂CH₂—OCO—CH═CH₂ and —CH₂CH₂—OCO—C(CH₃)═CH₂.

In the dispersant having an ethylenically unsaturated group, a free radical (a polymerization initiation radical or a radical grown in the polymerization process of a polymerizable compound) is added to the unsaturated bond group to cause an addition polymerization between molecules directly or through a polymerization chain of a polymerizable compound, as a result, a crosslink is formed between molecules to cure. Alternatively, an atom in the molecule (for example, a hydrogen atom on a carbon atom adjacent to the unsaturated bond group) is withdrawn by a free radical to produce a polymer radical and the polymer radicals are bonded with each other to form a crosslink between molecules, thereby completing the curing.

As a method of introducing a crosslinking or polymerizable functional group on a side chain, as described in for instance JP-A-3-249653, a method where, after a crosslinking or polymerizable functional group-containing monomer (for instance, allyl (meth)acrylate, glycidyl (meth)acrylate or trialcoxysilylpropyl methacrylate) is copolymerized, butadiene or isoprene is copolymerized or a vinyl monomer having a 3-chloropropionic acid ester site is polymerized, dehydrochlorination is applied or a method where a crosslinking or a polymerizable functional group is introduced owing to a polymer reaction (for instance, a polymer reaction of an epoxy group-containing vinyl monomer to a carboxyl group-containing polymer) to synthesize can be cited.

The crosslinking or polymerizable functional group-containing unit may constitute all repeating units except for the anionic group-containing repeating unit. However, the crosslinking or polymerizable functional group-containing unit preferably occupies from 5 to 50 mol percent, more preferably from 5 to 30 mol percent, in all crosslinking or repeating units.

The preferred dispersant in the invention may be a copolymer with an appropriate monomer other than a monomer having a crosslinking or polymerizable functional group and an anionic group. The copolymerization component is not particularly restricted but is selected by taking various points such as dispersion stability, compatibility with other monomer component, and the strength of a coated film into consideration. Preferred examples thereof include methyl (meth)acrylate, n-butyl (meth)acrylate, tert-butyl (meth)acrylate, cyclohexyl (meth)acrylate and styrene.

The preferred dispersant of the present invention is not particularly restricted in its form. However, a block copolymer or a random copolymer is preferred and in view of cost and easy synthesis, a random copolymer is more preferred.

In what follows, specific examples of dispersant that is preferably used in the invention will be shown without restricting thereto. Unless referring clearly, an example shows a random copolymer.

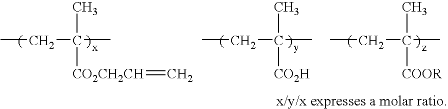

| | x | y | z | R | Mw |
|---|---|---|---|---|---|
| P-(1) | 80 | 20 | 0 | — | 40,000 |
| P-(2) | 80 | 20 | 0 | — | 110,000 |
| P-(3) | 80 | 20 | 0 | — | 10,000 |
| P-(4) | 90 | 10 | 0 | — | 40,000 |
| P-(5) | 50 | 50 | 0 | — | 40,000 |
| P-(6) | 30 | 20 | 50 | CH₂CH₂CH₃ | 30,000 |
| P-(7) | 20 | 30 | 50 | CH₂CH₂CH₂CH₃ | 50,000 |
| P-(8) | 70 | 20 | 10 | CH(CH₃)₃ | 60,000 |
| P-(9) | 70 | 20 | 10 | 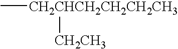 | 150,000 |
| P-(10) | 40 | 30 | 30 | 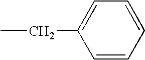 | 15,000 |

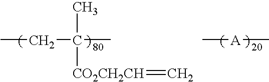

| | A | Mw |
|---|---|---|
| P-(11) | 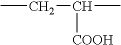 | 20,000 |
| P-(12) | 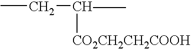 | 30,000 |
| P-(13) | 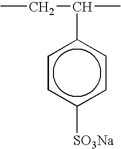 | 100,000 |
| P-(14) | 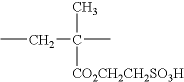 | 20,000 |
| P-(15) | 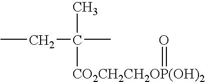 | 50,000 |
| P-(16) | 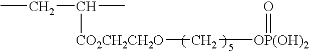 | 15,000 |

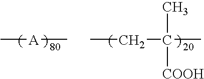

| | A | Mw |
|---|---|---|
| P-(17) | 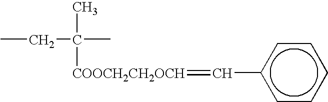 | 20,000 |
| P-(18) | 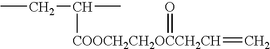 | 25,000 |
| P-(19) | 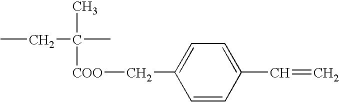 | 18,000 |
| P-(20) | 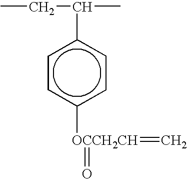 | 20,000 |
| P-(21) | 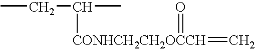 | 35,000 |

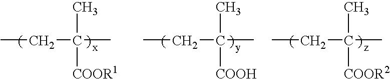

| | R¹ | R² | x | y | z | Mw |
|---|---|---|---|---|---|---|
| P-(22) | 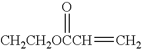 | C₄H₉(n) | 10 | 10 | 80 | 25,000 |
| P-(23) | 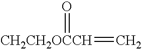 | C₄H₉(t) | 10 | 10 | 80 | 25,000 |
| P-(24) | 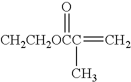 | C₄H₉(n) | 10 | 10 | 80 | 500,000 |
| P-(25) | 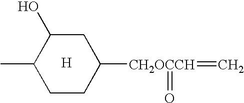 | C₄H₉(n) | 10 | 10 | 80 | 23,000 |
| P-(26) | 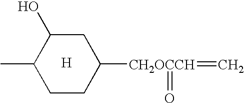 | C₄H₉(n) | 80 | 10 | 10 | 30,000 |
| P-(27) | 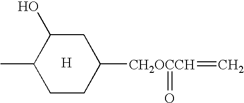 | C₄H₉(n) | 50 | 20 | 30 | 30,000 |
| P-(28) | 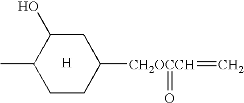 | C₄H₉(t) | 10 | 10 | 80 | 20,000 |
| P-(29) | 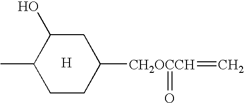 | CH₂CH₂OH | 50 | 10 | 40 | 20,000 |
| P-(30) | 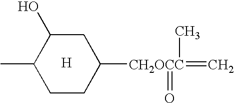 | C₄H₉(n) | 10 | 10 | 80 | 25,000 |

| | | |
|---|---|---|
| P-(31) | 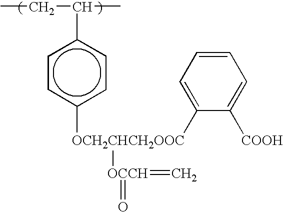 | Mw = 60,000 |
| P-(32) | 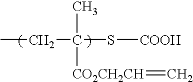 | Mw = 10,000 |
| P-(33) | 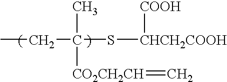 | Mw = 20,000 |
| P-(34) | 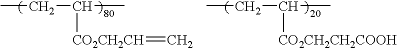 | Mw = 30,000 (Block copolymer) |
| P-(35) | 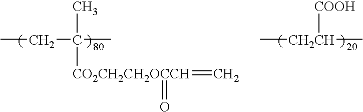 | Mw = 15,000 (Block copolymer) |
| P-(36) | 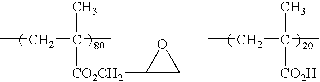 | Mw = 8,000 |
| P-(37) | 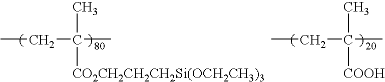 | Mw = 5,000 |
| P-(38) | 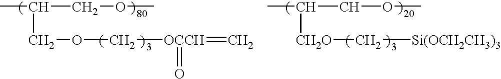 | Mw = 10,000 |

An amount of the dispersant used is, based on the inorganic fine particle mainly made of titanium dioxide, preferably in the range of 1 to 50 mass percent, more preferably in the range of 5 to 30 mass percent, and most preferably in the range of 5 to 20 mass percent. Furthermore, two or more kinds of dispersants may be used in combination.

{Method of Forming Higher Refractive Index Layer}

The inorganic fine particle mainly made of titanium dioxide, which is used in the higher refractive index layer, is used in a dispersion state for the formation of higher refractive index layer. The inorganic fine particles are dispersed in a dispersion medium in the presence of a dispersant described above.

The dispersion medium is preferably a liquid having a boiling point in the range of 60 to 170° C. Examples of the dispersion medium include water, alcohol (for instance, methanol, ethanol, isopropanol, butanol and benzyl alcohol), ketone (for instance, acetone, methyl ethyl ketone, methyl isobutyl ketone and cyclohexanone), ester (for instance, methyl acetate, ethyl acetate, propyl acetate, butyl acetate, methyl formate, ethyl formate, propyl formate and butyl formate), aliphatic hydrocarbon (for instance, hexane and cyclohexane), halogenated hydrocarbon (for instance, methylene chloride, chloroform and carbon tetrachloride), aromatic hydrocarbon (for instance, benzene, toluene and xylene), amide (for instance, dimethylformamide, dimethylacetamide and n-methylpyrrolidone), ether (for instance, diethyl ether, dioxane and tetrahydrofuran) and ether alcohol (for instance, 1-methoxy-2-propanol). Among these, toluene, xylene, methyl ethyl ketone, methyl isobutyl ketone, cyclohexanone and butanol are preferred.

The particularly preferable dispersion medium is methyl ethyl ketone, methyl isobutyl ketone or cyclohexanone.

The inorganic fine particles are dispersed with a disperser. Examples of the disperser include a sand grinder mill (for instance, bead mill with pin), a high-speed impeller mill, a pebble mill, a roller mill, an attritor and a colloid mill. Among these, a sand grinder mill and a high-speed impeller are preferred. Furthermore, a preliminary dispersion treatment may be applied. Examples of the disperser for use in the preliminary dispersion treatment include a ball mill, a three-roll mill, a kneader and an extruder.

The inorganic fine particles are preferably dispersed in the dispersion medium as small as possible. A mass average particle diameter is in the range of 1 to 200 nm, preferably in the range of 5 to 150 nm, more preferably in the range of 10 to 100 nm, and particularly preferably in the range of 10 to 80 nm.

When the inorganic fine particles are dispersed so as to have a small particle diameter of 200 nm or less, a higher refractive index layer that does not impair the transparency can be formed.

The higher refractive index layer for use in the invention is preferably formed as follows. That is, to the liquid dispersion where the inorganic fine particles are dispersed in a dispersion medium as described above, a transparent resin (for instance, ionizing radiation curable polyfunctional monomer or polyfunctional oligomer exemplified in the description of the hard coat layer), a photopolymerization initiator, a sensitizer and a coating solvent are added to form a coating composition for the formation of the higher refractive index layer, and the coating composition for the formation of the higher refractive index layer is coated on a hard coat layer and cured through a crosslinking or polymerization reaction of the ionizing radiation-curable compound (for instance, polyfunctional monomer or oligomer), and thereby a higher refractive index layer can be preferably formed. As specific examples of the light transmitting resin, photopolymerization initiator, sensitizer and coating solvent, compounds exemplified in the hard coat layer can be used.

Simultaneously with or after the coating of the light transmitting resin of the higher refractive index layer, the light transmitting resin is preferably crosslinked or polymerized with the dispersant.

The light transmitting resin of the thus-produced higher refractive index layer takes a form where the above-described preferred dispersant and the ionizing radiation-curable polyfunctional monomer or oligomer are crosslinked or polymerized to take the anionic group of the dispersant into the light transmitting resin. Furthermore, in the light transmitting resin of the higher refractive index layer, an anionic group has a function of maintaining a dispersed state of the inorganic fine particles and the crosslinking and polymerization structure imparts a film formation function to the light transmitting resin. As a result, the physical strength, chemical resistance and weather resistance of the higher refractive index layer containing the inorganic fine particles can be improved.

The inorganic fine particle has an effect of controlling the refractive index of the higher refractive index layer and at the same time a function of suppressing cure shrinkage.

The inorganic fine particle is preferably dispersed in the higher refractive index layer as small as possible. The mass average particle diameter thereof is in the range of 1 to 200 nm, preferably in the range of 5 to 150 nm, more preferably in the range of 10 to 100 nm, and most preferably in the range of 10 to 80 nm.

By making the inorganic fine particles fine so as to have a particle diameter of 200 nm or less, a higher refractive index layer that does not impair the transparency can be formed.

A content of the inorganic fine particle in the higher refractive index layer is preferably in the range of 10 to 90 mass percent, more preferably in the range of 15 to 80 mass percent, still more preferably in the range of 15 to 75 mass percent, based on the mass of the higher refractive index layer. In the higher refractive index layer, two or more kinds of inorganic fine particles may be used in combination.

Since a lower refractive index layer is formed on the higher refractive index layer, the refractive index of the higher refractive index layer is preferably higher than the refractive index of the transparent support.

In the higher refractive index layer, a light transmitting resin obtained by a crosslinking or polymerization reaction of an ionizing radiation-curable compound containing an aromatic ring, an ionizing radiation-curable compound containing a halogen element (for instance, Br, I or Cl) except for fluorine, or an ionizing radiation-curable compound containing an atom such as S, N and P, can be preferably used as well.

The refractive index of the higher refractive index layer is preferably in the range of 1.55 to 2.40, more preferably in the range of 1.60 to 2.20, still more preferably in the range of 1.65 to 2.10, and most preferably in the range of 1.80 to 2.00.

For instance, when on the hard coat layer, three layers of an intermediate refractive index layer, a higher refractive index layer and a lower refractive index layer are disposed in this order, the refractive index of the intermediate refractive index layer is preferably in the range of 1.55 to 1.80, the refractive index of the higher refractive index layer is preferably in the range of 1.80 to 2.40 and the refractive index of the lower refractive index layer is preferably in the range of 1.20 to 1.46.

The higher refractive index layer may contain, in addition to the above-described components (for instance, inorganic fine particle, polymerization initiator and photosensitizer), a resin, a surfactant, an antistatic agent, a coupling agent, a thickening agent, a coloration inhibitor, a colorant (for instance, pigment and dye), a defoaming agent, a leveling agent, a flame retardant, an ultraviolet absorbent, an infrared absorbent, a tackifier, a polymerization inhibitor, an antioxidant, a surface modifier, and an electrically conductive metal fine particle.

A film thickness of the higher refractive index layer can be appropriately designed according to applications. When the higher refractive index layer is used as an optical interference layer that is described later, the film thickness is preferably in the range of 30 to 200 nm, more preferably in the range of 50 to 170 nm, and particularly preferably in the range of 60 to 150 nm.

(Other Optical Function Layer)

In order to prepare an optical film having a more excellent anti-reflection function, it is preferable to dispose an intermediate refractive index layer having the refractive index between the refractive index of the higher refractive index layer and that of the transparent support.

The intermediate refractive index layer is preferably prepared similarly to what is described in the higher refractive index layer, and, by controlling a content of the inorganic fine particle in the coated film, the refractive index thereof can be controlled.

In an optical film, a layer other than the above may be disposed. For instance, an adhesive layer, a shield layer, an anti-stain layer, a slide layer and an antistatic layer may be disposed. The shield layer is disposed to shield an electromagnetic wave or infrared ray.

(Method of Producing Coated Film)

In the next place, a method of producing a coated film of the invention will be detailed.

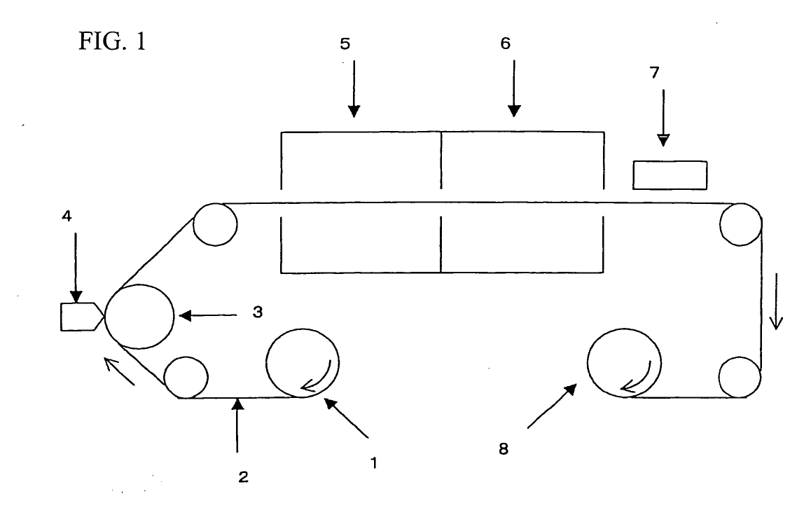

A method of producing a coated film of the invention includes coating a coating solution on a support and subsequently drying a coating solution coated on the support. FIG. 1 shows an example of a conceptual diagram of a coating machine used in the production of the coated film.

In FIG. 1, on a support 2 conveyed from a conveyer roll 1, at a coating roll 3 and die coater 4, a coating solution is coated, followed by forwarding to a drying step. In the coating machine of FIG. 1, a drying step is carried out in a first drying zone 5 and a second drying zone 6. A drying temperature and a drying time period in each of the first and second drying zones are controlled depending on a kind of the coating solution. After the drying step, as needs arise, through a curing unit 7 (for instance, thermosetting device or UV-curing unit) of the coated film, a coated film obtained by forming a coated layer on the support is wound by a winding roll 8.

Since a continuous support is employed, in the respective steps from a sending to a winding step, the support is conveyed at a substantially same speed.

{Preparation of Coating Solution}

First of all, a coating solution containing components for forming each layer is prepared. During the preparation, by controlling an amount of volatilization of the solvent at the minimum level, the coating solution can be inhibited form going up in the water content. The water content in the coating solution is preferably 5% or less, and more preferably 2% or less. The control of the amount of volatilization of the solvent can be achieved by enhancing sealing properties at the time of stirring after throwing the respective raw materials into a tank and by minimizing the contact area with air of the coating solution at the time of liquid transfer works. Furthermore, a measure for reducing the water content in the coating solution during coating or before or after coating may be provided.

It is preferable that the coating solution contains at least two kinds of solvents and boiling temperatures of the two kinds of solvents are different from one another by 30° C. or more. The difference between the boiling temperatures is more preferably 40° C. or more and 150° C. or less and still more preferably 50° C. or more and 120° C. or less. When the boiling temperatures are set in the range, the drying irregularity can be homogenized. It is assumed effective for a high boiling temperature solvent to remain a certain extent in the coated layer even after the first drying step.

Furthermore, it is preferable that the coating solution for forming the hard coat layer is subjected to filtration through which foreign matters corresponding to a dry thickness (substantially 50 nm to 120 nm) of a layer formed directly thereon, for instance, the lower refractive index layer can be substantially removed (this means an extent of 90% or more). Since the light-transmitting fine particle for imparting the light diffusibility is equal to or more than a film thickness of the lower refractive index layer, it is preferable that the foregoing filtration is applied to an intermediate solution in which all of raw materials other than the light-transmitting fine particle are added. Furthermore, in the case where a filter capable of removing the foregoing foreign substances small in particle size is not available, it is preferred to apply filtration such that foreign substances corresponding to the wet thickness (substantially 1 to 10 μm) of a layer formed at least directly thereon can be substantially entirely removed. By such a measure, it is possible to reduce point failure of the layer formed directly thereon.

The respective layers of the coated film of the invention can be formed by the following coating methods without restricting thereto. That is, known methods such as a dip coating method, an air knife coating method, a curtain coating method, a roller coating method, a wire bar coating method, a gravure coating method, an extrusion coating method (die coating method) (see U.S. Pat. No. 2,681,294), and a micro gravure coating method are employable. Of these, a micro gravure coating method or a die coating method is preferable.

The micro gravure coating method that is used in the invention is a coating method where a gravure roll that has a diameter of substantially 10 to 100 mm, and preferably of substantially 20 to 50 mm and is marked with a gravure pattern over an entire periphery thereof is disposed beneath a support and rotated adversely to a conveyance direction of the support, an excess of a coating solution is scraped off a surface of the gravure roll with a doctor blade, and thereby a constant amount of the coating solution is coated by transferring it onto a lower surface of the support in the position where the upper surface of the support is in a free state. By continuously unwinding a rolled support, it is possible to coat at least one layer of the hard coat layer and the lower refractive index layer containing a fluorine-containing polymer on one side of the unwound support by the micro gravure coating method.

With respect to the coating condition by the micro gravure coating method, a line number of the gravure pattern marked on the gravure roll is preferably from 50 to 800 lines per inch and more preferably from 100 to 300 lines per inch; a depth of the gravure pattern is preferably from 1 to 600 μm and more preferably from 5 to 200 μm; a rotation number of the gravure roll is preferably from 3 to 800 rpm and more preferably from 5 to 200 rpm; and the conveyance speed of the support is preferably from 0.5 to 100 m/min and more preferably from 1 to 50 m/min.

In order to supply the coated film of the invention at high productivity, an extrusion method (die coat method) is preferably used. In particular, a die coater that can be preferably used in a region (20 cc/m² or less) where a wet coating amount is small like the hard coat layer and the anti-reflection layer will be described below.

{Constitution of Die Coater}

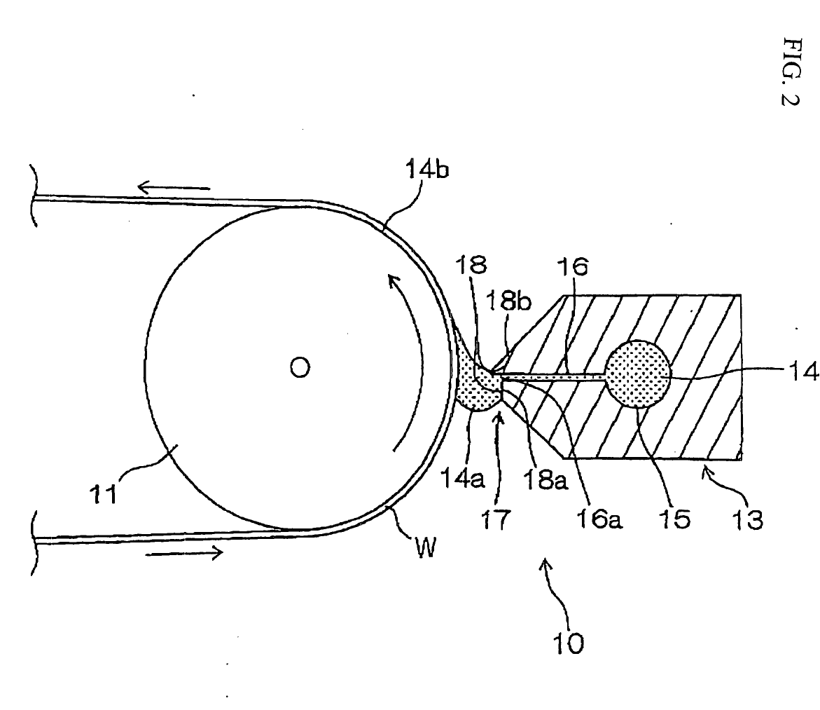

FIG. 2 is a sectional view of a coater with a slot die. A coater 10 coats a coating solution 14 from a slot die 13 in bead 14a on a web W that continuously runs supported by a backup roll 11 to form a coated film 14b on the web W.

A pocket 15 and a slot 16 are formed inside of the slot die 13. A section of the pocket 15 has a linear line and a curved line, and, for example, as shown in FIG. 2, may be nearly circular or half circular. The pocket 15 is a solution reserve space of the coating solution, which is extended in a widthwise direction of the slot die 13 with a sectional shape thereof. A length of an effective extension length is usually the same as or slightly longer than a coating width. The coating solution 14 is supplied into the pocket 15 from a side surface of the slot die 13 or from a center of a surface opposite to an aperture 16a of the slot 16. Furthermore, the pocket 15 is provided with a pocket stopper to inhibit the coating solution 14 from flowing out of the pocket 15.

The slot 16 is a flow path through which the coating solution 14 flows from the pocket 15 to the web W, and has a sectional form thereof in the widthwise direction of the slot die 13 similarly to the pocket 15. The aperture 16a located on a web side is, generally with one such as a not shown width limiting plate, controlled so as to be a width having a length substantially same as the coating width. At a slot tip end of the slot 16, an angle that forms with a tangent in a conveying direction of the web of the backup roll 11 is preferably 30° or more and 90° or less.

A tip lip 17 of the slot die 13, in which the aperture 16a of the slot 16 is positioned, is tapered, and the tip thereof is a flat portion 18 referred to as a land. An upstream side of the land 18 in a proceeding direction of the web W with respect to the slot 16 is referred to as an upstream lip land 18a, and a downstream side thereof is referred to as a downstream lip land 18b.

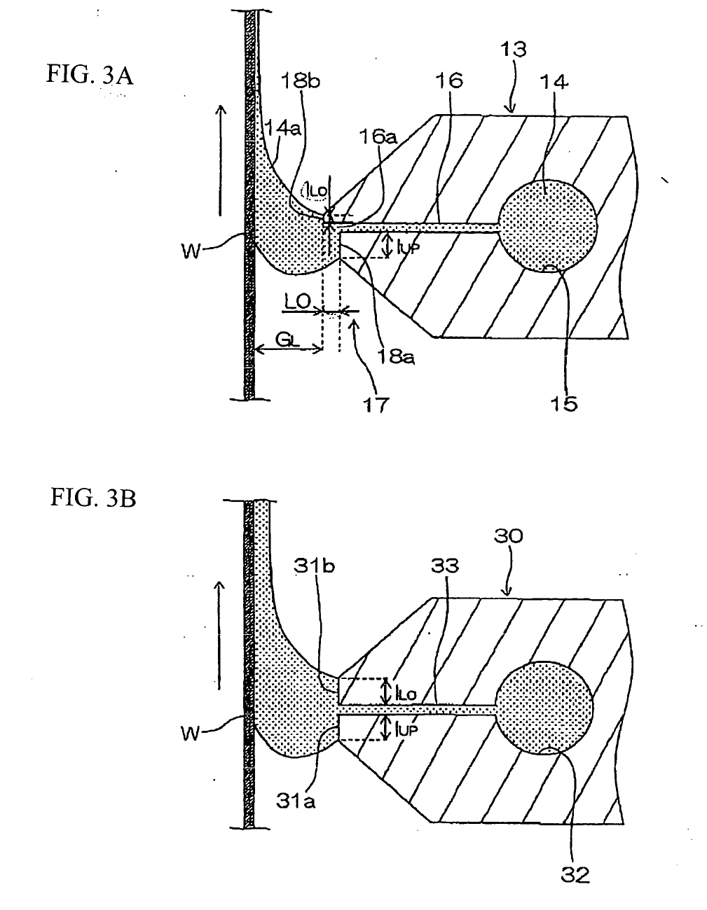

FIGS. 3A and 3B show an example of a sectional form of the slot die 13 in comparison with that of an existing one, FIG. 3A showing a slot die 13 according to the invention, and FIG. 3B showing an existing slot die 30. In the existing slot die 30, distances from the upstream lip land 31a and the downstream lip land 31b to the web are same. Incidentally, reference numerals 32 and 33, respectively, show a pocket and a slot. On the other hand, in the slot die 13 of the invention, a length I_{LO} of the downstream side lip land is set shorter, and thereby, when a wet film thickness is 20 μm or less, a coating operation can be carried out with precision.

A land length I_{UP} of the upstream side lip land 18a, though not restricted to particularly, is preferably in the range of 500 μm to 1 mm. A land length I_{LO} of the downstream lip land 18b is 30 μm or more and 100 μm or less, preferably 30 μm or more and 80 μm or less and more preferably 30 μm or more and 60 μm or less. When the land length I_{LO} of the downstream lip is shorter than 30 μm, an edge or the land of the tip lip is apt to be chipped to cause stripes on a coated film, resulting in consequently making coating impossible. Furthermore, there is a problem in that a wet line position on the downstream side becomes difficult to set, and the coating solution is apt to spread on the downstream side. It has been known that a leak spread of the coating liquid on the downstream side means a inhomogeneous wet line, causing poor shapes such as stripes on a coating surface. On the other hand, when the land length I_{LO} of the downstream lip is longer than 100 μm, the bead per se cannot be formed; accordingly, thin layer coating is impossible.

Furthermore, the downstream lip land 18b is formed into an overbite shape closer to the web W than the upstream lip land 18a. Accordingly, a degree of depressurization can be reduced and thereby a bead formation suitable for thin film coating can be realized. A difference of the distances between the downstream lip land 18b and upstream lip land 18a and the web W (hereinafter, referred to as overbite length LO) is preferably 30 μm or more and 120 μm or less, more preferably 30 μm or more and 100 μm or less and still more preferably 30 μm or more and 80 μm or less. When the slot die 13 has an overbite shape, a gap G_{L} between the tip lip 17 and the web W indicates a gap between the downstream lip land 18b and the web W.

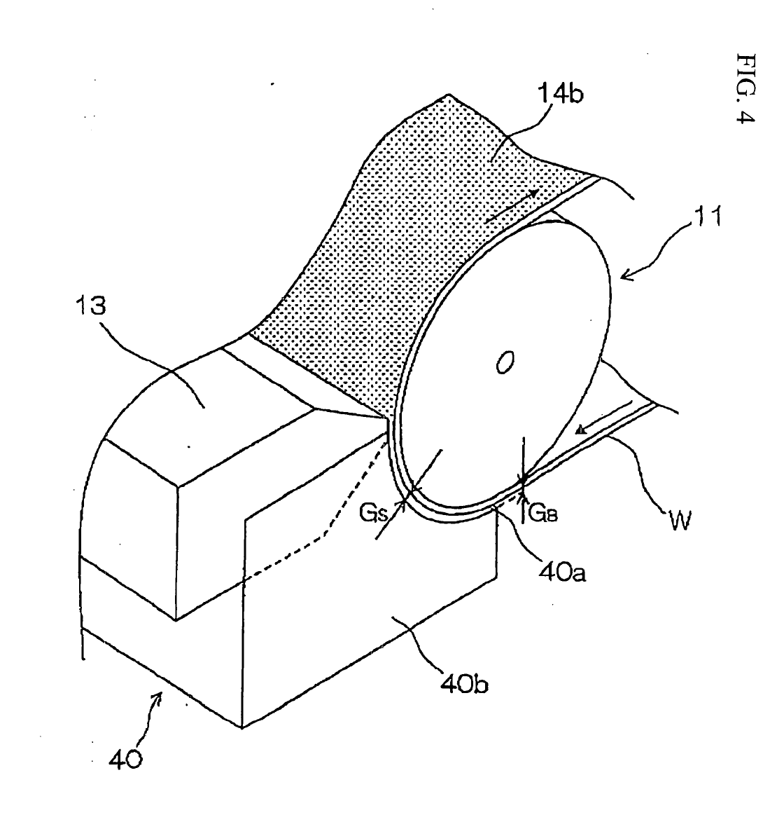

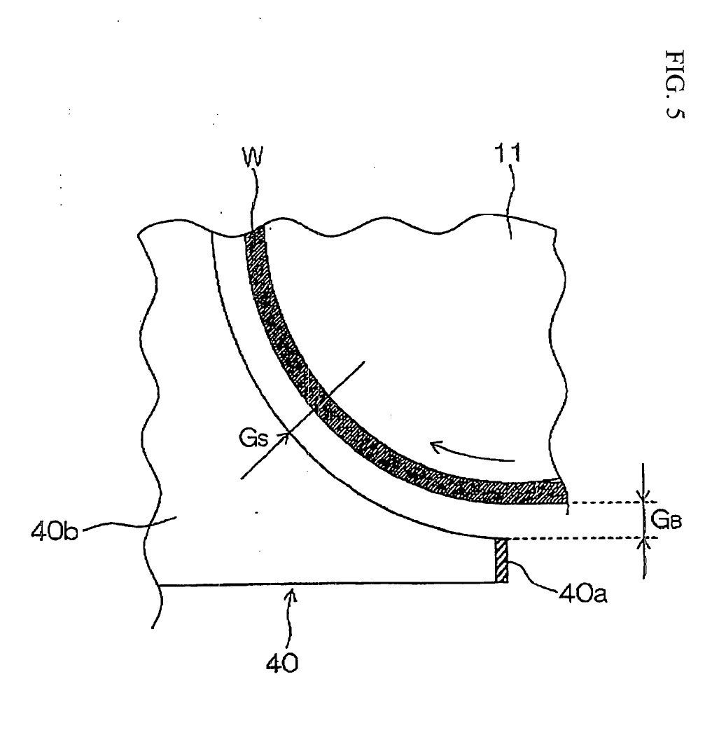

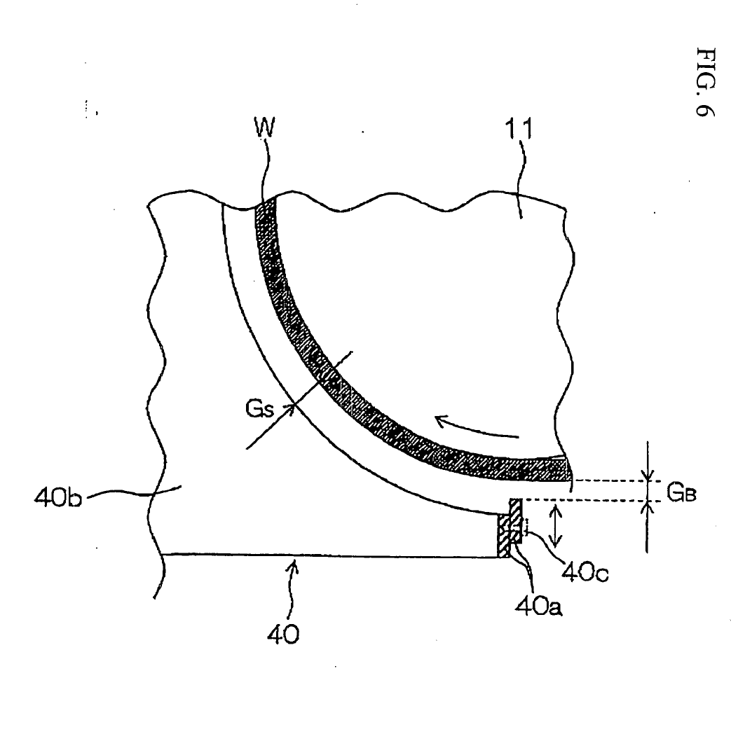

FIG. 4 is a perspective view showing a slot die in a coating step and the vicinity thereof. A low-pressure chamber 40 is provided on a side opposite to a proceeding direction of the web W at a position that does not come into contact therewith so as to allow applying sufficient pressure reducing control to the bead 14a. The low-pressure chamber 40 is provided with a back plate 40a and a side plate 40b for maintaining operation efficiency thereof, and gaps G_{B} and G_{S} are provided between the back plate 40a and the web W and between the side plate 40b and the web W, respectively. FIGS. 5 and 6 are sectional views showing the low-pressure chamber 40 and the web W that are in the vicinity of each other. The side plate and the back plate may be integrated with a chamber body as shown in FIG. 5 or may have a configuration where as shown in FIG. 6 the side plate and the back plate are screwed to the chamber with a screw 40c so as to be able to appropriately vary a gap. In whatever configurations, portions actually opened between the back plate 40a and the web W and between the side plate 40b and the web W, respectively, are defined as gaps G_{B} and Gs. The gap G_{B} between the back plate 40a of the low-pressure chamber 40 and the web W means a gap from the uppermost end of the back plate 40a to the web W when the low-pressure chamber 40 is disposed as shown in FIG. 4 beneath the web W and the slot die 13.

The gap G_{B} between the back plate 40a and the web W is preferably disposed larger than a gap G_{L} between the tip lip 17 of the slot die 13 and the web W, and thereby a degree of depressurization in the vicinity of the bead can be inhibited from varying owing to decentering of the backup roll 11. For instance, when a gap G_{L} between the tip lip 17 of the slot die 13 and the web W is 30 μm or more and 100 μm or less, the gap G_{B} between the back plate 40a and the web W is preferably 100 μm or more and 500 μm or less.

{Material, Precision}

The longer a length in a web running direction of the tip lip on a proceeding direction side of the web is, the more disadvantageously the bead is formed, and, when the length fluctuates between an arbitrary positions in a width direction of the slot die, even only a slight external disturbance causes the instability of the bead. Accordingly, the length is preferably set at 20 μm or less in a range of fluctuation in a width direction of the slot die.

When a material such as stainless steel is used as a material of the tip lip of the slot die, the material wears in the step of die machining, and even when a length in a web running direction of the tip lip of the slot die is set in the range of 30 to 100 μm as mentioned above, the accuracy of the tip lip cannot be satisfied. Accordingly, in order to maintain high machining accuracy, it is important to use a tip portion made of carbide material as disclosed in Japanese Patent No. 2817053. Specifically, at least the tip lip of the slot die is preferably made of cemented carbide obtained by bonding carbide crystals having an average particle diameter of 5 μm or less. The cemented carbide includes crystal particles of carbide such as tungsten carbide (hereinafter abbreviated as WC) bonded by a binding metal such as cobalt. As the binding metal, other than the above, titanium, tantalum, niobium, and a combination thereof may be used. An average particle diameter of the WC crystal is more preferably 3 μm or less.

In order to realize high accuracy coating, the length of the land on a web proceeding direction side of the tip lip and a fluctuation in a slot die width direction of a gap with the web are important as well. The straightness in the range that can suppress the combination of the two factors, namely the range of fluctuation of the gap to a certain extent is desirably achieved. Preferably, the straightness of the tip lip and the backup roll are arranged so that the range of fluctuation in a slot die widthwise direction of the gap may be 5 μm or less.

{Coating Speed}

When such accuracies as mentioned above of the backup roll and the tip lip are achieved, in a coating method preferably used in the invention, at the time of high-speed coating, a film thickness is high in the stability. Furthermore, since the coating method is a pre-measure system, even at the time of the high-speed coating, a stable film thickness can be readily secured. To a coating solution for low coating amount like an optical film, in particular, an anti-reflection film in the invention, the coating method can coat at high-speed excellently in the film thickness stability. Other coating methods can be used to coat. However, in a dip coat method, a coating solution in a liquid reservoir tank is inevitably vibrated; accordingly, step-wise irregularity is likely to occur. In a reverse roll coating method, owing to decentering or deflection of a roll related to coating, stepwise irregularity is likely to occur. Furthermore, since the coating methods are post-measuring systems, a film thickness cannot be stably secured. It is preferable to use the above coating method at a coating speed of 30 m/min or more from the productivity point of view.

{Wet Coating Amount}

When a hard coat layer (or anti-glare layer) is formed, the coating solution is preferably coated directly or through another layer on a substrate film in the range of 6 to 30 μm as a wet coating film thickness, and more preferably in the range of 3 to 20 μm from the viewpoint of inhibition of the drying irregularity. Furthermore, when a lower refractive index layer is formed, the coating composition is preferably coated directly or through another layer on the hard coat layer in the range of 1 to 10 μm as a wet coating film thickness and more preferably in the range of 2 to 5 μm.

<Drying>

A drying step in a producing method of the invention includes at least two drying steps. In a first drying step carried out in the first drying zone, where a coating solution is dried with drying air after coating, the maximum wind speed of the drying air on a surface of the coated film is 1 m/sec or more, preferably 2 m/sec or more and 30 m/sec or less and still more preferably 3 m/sec or more and 20 m/sec or less. When the wind speed is less than 1 m/sec, the difference of the drying rate in a width direction of a support becomes conspicuous, thereby the drying irregularity is caused and the drying time becomes longer, resulting in deteriorating the productivity. When the wind speed is too large, in some cases, the wind pressure flows the coated solution. A direction of the drying air is not particularly restricted. The wind speed here shows a value measured with an anemometer of a wind component at 10 mm from a surface of the coated film in a direction in parallel with a proceeding direction of the coated film and the support.

The minimum value of the wind speed is preferably 0.1 m/sec or more.

A temperature of the drying air is normally in the range of room temperature to substantially 200° C., preferably in the range of room temperature to 150° C. and more preferably in the range of room temperature to 100° C.

Furthermore, it is as well important to control the drying rate of the solvent, and the drying rate thereof is preferably 0.3 g/m²/sec or more, more preferably 0.4 g/m²/sec or more and still more preferably 0.5 g/m²/sec or more.

A drying rate of the solvent is obtained in such a manner that a film thickness of a coating solution on a support that is conveyed is measured, from a change of the film thickness, a vaporization amount of the solvent in the coating solution is calculated (specifically, formula: {change of film thickness [μm]×specific gravity [−]}/time necessary for the change of film thickness (s), a thickness of 1 μm when the specific gravity is 1000 kg/m³ corresponds to 1 g/m²), and an amount of vaporization [g/m²/s] of the solvent per unit area/unit time is defined as the drying rate.

As a drying air unit, in the first drying zone, an air supply hole and an air exhaust hole for supplying and exhausting drying air are preferably disposed. The air supply hole is preferably disposed mainly above a surface of the coated film and in an upper portion of the drying zone and the exhaust hole may be disposed in any of an upper portion of the drying zone, a lower portion thereof and a side portion thereof.

As a form of an air supplier, one having a plurality of air supply holes in a metal plate, one that blows drying air through a metal mesh or one provided with a plurality of air supply nozzles at a certain separation can be cited.

Furthermore, a method where by making use of solvent vapor vaporizing from a coated surface a gas concentration is raised or a method where air having a previously controlled constant gas concentration is circulated can be used to dry.

Furthermore, an electric heater, an infrared heater or a heating roll may be used together.

In the second drying step carried out in the second drying zone, a drying step is carried out at a zone temperature higher by 50° C. or more than a zone temperature of the first drying step. The temperature difference is preferably 60° C. or more and more preferably 70° C. or more.

A drying unit is not restricted to particular one. Drying air, an electric heater, an infrared heater and a heating roll can be cited and among these the drying air is preferable.

A temperature is preferably equal to or less than a temperature at which a component other than the solvent contained in the coating composition starts vaporizing. For instance, among commercially available photoradical initiators that can be used together with a UV-curable resin, there are ones several tens percent of which vaporize in several minutes in hot air of 120° C. or ones mono-functional or bifunctional acrylate monomer of which vaporize in a hot air of 100° C. In such a case, as mentioned above, a temperature is preferably a temperature at which a component other than the solvent contained in the coating composition of each layer starts vaporizing or less.

<Curing>

After the drying zone of the solvent, the web makes each coated film pass through a zone for curing by ionizing radiations and/or heat to cure the coating film. The ionizing radiations can be used without restrictions so far as the compound can be crosslinked and cured by activation with ultraviolet rays, electron beams and γ-rays. Of these, ultraviolet rays and electron beams are preferable, ultraviolet rays being particularly preferable from the standpoints that handling is simple and that high energy is readily obtained. As a light source of ultraviolet rays for photopolymerizing an ultraviolet ray-reactive compound, any light source capable of emitting ultraviolet rays can be used. Examples thereof include a low pressure mercury vapor lamp, a medium pressure mercury vapor lamp, a high pressure mercury vapor lamp, an ultra-high pressure mercury vapor lamp, a carbon arc lamp, a metal halide lamp and a xenon lamp. Furthermore, ArF excimer laser, KrF excimer laser, an excimer lamp or synchrotron radiations can be used. The irradiation condition varies depending upon the respective lamps. The irradiation dose is preferably 10 mJ/cm² or more, more preferably in the range of 50 to 10,000 mJ/cm², and particularly preferably in the range of 50 to 2,000 mJ/cm². At this time, with respect to a dose distribution in the widthwise direction of the web, an irradiation dose distribution in the range of 50 to 100% including the both ends relative to the maximum dose at the center is preferable, and the distribution in the range of 80 to 100% is more preferable.

The ultraviolet rays may be irradiated every time when one layer of a plurality of layers (the intermediate refractive index layer, the higher refractive index layer, and the lower refractive index layer) constituting the coated layer is provided or after laminating these layers. Alternatively, the ultraviolet rays may be irradiated in a combination thereof. It is preferable in view of productivity that the ultraviolet rays are irradiated after laminating multiple layers.

Furthermore, in the case of the optical film having the hard coat layer and the lower refractive index layer thereon, when the curing rate of the hard coat layer (100-a content of residual functional group) becomes a certain value that is less than 100% and furthermore when the lower refractive index layer is provided thereon and cured with ionizing radiations and/or heat, when the curing rate of the hard coat layer as a lower layer becomes higher than that before providing the lower refractive index layer, the adhesiveness between the hard coat layer and the lower refractive index layer is preferably improved.

Still furthermore, electron beams can be similarly used. Examples of the electron beams include electron beams having energy in the range of 50 to 1,000 keV and preferably in the range of 100 to 300 keV, which are released from a variety of electron beam accelerators such as a Cockroft-Walton's type, a van de Graaff type, a resonance transformation type, an insulating core transformer type, a linear type, a dynamitron type, and a high frequency type.

In the case where each layer is formed by crosslinking reaction or polymerization reaction with the foregoing ionizing radiations, it is preferable that the crosslinking reaction or polymerization reaction is carried out in an atmosphere having an oxygen concentration of 10% by volume or less. When the layer formation is carried out in an atmosphere having an oxygen concentration of 10% by volume or less, a layer having excellent physical strength and chemical resistance can be obtained.

The layer formation is carried out by crosslinking reaction or polymerization reaction of an ionizing radiation-curable compound preferably in an atmosphere having an oxygen concentration of 6% by volume or less, more preferably an oxygen concentration of 4% by volume or less, particularly preferably an oxygen concentration of 2% by volume or less, and most preferably an oxygen concentration of 1% by volume or less.

As a measure for controlling the oxygen concentration to 10% by volume or less, an atmosphere (nitrogen concentration: substantially 79% by volume, oxygen concentration: substantially 21% by volume) is preferably displaced with a separate gas, and particularly preferably displaced with nitrogen (purging with nitrogen).

(Polarizing Plate)

A polarizing plate of the invention includes a polarizer and two protective films, the two protective films sandwiching the polarizer threrebetween. As one of the protective films, an optical film of the invention can be used. As the other protective film, a usual cellulose acetate film may be used. However, it is preferred to use a cellulose acetate film that is produced by the foregoing solution film-forming method and stretched in the widthwise direction in a rolled film state at a stretching degree of from 10 to 100%.

Furthermore, in the polarizing plate of the invention, it is preferable that to the optical film the other protective film is an optical compensating film having an optically anisotropic layer made of a liquid crystalline compound.

Examples of the polarizer include an iodine based polarizer, a dye based polarizer that uses a dichroic dye, and a polyene based polarizer. The iodine based polarizer and dye based polarizer are generally produced with a polyvinyl alcohol based film.

A slow axis of the transparent support or cellulose acetate film of the optical film and a transmission axis of the polarizer are aligned substantially parallel to each other.

For the productivity of the polarizing plate, the moisture permeability of the protective film is important. The polarizer and the protective film are stuck to each other with an aqueous adhesive. A solvent of the adhesive is diffused in the protective film and dried. As the moisture permeability of the protective film is increased, the drying becomes faster, and the productivity is further increased. However, when the moisture permeability of the protective film is excessively increased, the moisture enters the polarizer to lower the polarizing ability depending upon the usage circumference (under high temperatures) of the liquid crystal display.

The moisture permeability of the protective film is determined by a thickness of the transparent support or polymer film (and the polymerizable liquid crystal compound), a free volume and the hydrophilicity/hydrophobicity.

In the case where the optical film of the invention is used as a protective film of the polarizing plate, the moisture permeability is preferably in the range of 100 to 1,000 g/m²/24 hrs, and more preferably in the range of 300 to 700 g/m²/24 hrs.

In the case of the film formation, the thickness of the transparent support can be adjusted by the lip flow rate and line speed, or by stretching and compression. Since the moisture permeability varies depending upon the principal raw materials, it is possible to make the moisture permeability fall within a more preferred range by controlling the thickness.

In the case of the film formation, the free volume of the transparent support can be controlled by the drying temperature and time. In this case as well, since the moisture permeability varies depending upon the principal raw materials, it is possible to make the moisture permeability fall within a more preferred range by controlling the free volume.

The hydrophilicity/hydrophobicity of the transparent support can be controlled with an additive. By adding a hydrophilic additive into the foregoing free volume, the moisture permeability can be increased, and conversely, by adding a hydrophobic additive, it is possible to lower the moisture permeability.

By individually controlling the foregoing moisture permeability, it becomes possible to inexpensively produce a polarizing plate having an optically compensatory ability with high productivity.

(Optical Compensating Film)

In a polarizing plate according to the invention, among the protective films that sandwich both surfaces of the polarizer, one protective film preferably has the optical film of the invention and the other protective film is preferable to be an optical compensating film having an optically anisotropic layer.

A liquid crystal compound that is used in the optically anisotropic layer of the optical compensating film may be any one of a rod-like liquid crystal and a discotic liquid crystal and includes high molecular liquid crystals or low molecular liquid crystals and furthermore ones in which a low molecular liquid crystal is crosslinked, whereby no liquid crystallinity is revealed. Of these liquid crystalline compounds, discotic liquid crystals are the most preferable.

Preferred examples of the rod-like liquid crystal include those described in JP-A-2000-304932.

Examples of the discotic liquid crystal include benzene derivatives described in C. Destrade, et al., Mol. Cryst., Vol. 71, page 111 (1981); truxene derivatives described in C. Destrade, et al., Mol. Cryst., Vol. 122, page 141 (1985) and Physics Lett. A, Vol. 78, page 82 (1990); cyclohexane derivatives described in B. Kohne, et al., Angew. Chem., Vol. 96, page 70 (1984); and azacrown based or phenlylacetylene based macrocyclic compounds described in M. Lehn, et al., J. Chem. Commun., page 1794 (1985) and J. Zhang, et al., J. Am. Chem. Soc., Vol. 116, page 2655 (1994).

The foregoing discotic liquid crystal generally has a structure in which, with the above-listed one as a mother nucleus at a center of a molecule, a linear alkyl group or alkoxy group, or a substituted benzoyloxy group is radially substituted and exhibits liquid crystallinity. However, the discotic liquid crystal is not restricted to the foregoing materials so far as a molecule itself has a negative uniaxial property and can impart a constant orientation.

Furthermore, in the invention, as the compound having a discotic structure unit in the optically anisotropic layer, a compound finally formed in the optically anisotropic layer is not necessarily a discotic compound. For example, those in which the foregoing low molecular weight discotic liquid crystal has a group reactive with heat or light, consequently, causes polymerization or crosslinking by reaction with heat or light and becomes to have a high molecular weight, thereby loosing liquid crystallinity, are also included. Preferred examples of the foregoing discotic liquid crystal are described in JP-A-8-50206.

It is preferable that the optically anisotropic layer of the optical compensating film is a layer made of a compound having a discotic structure unit; that the disc plane of the discotic structure unit is slanted to the transparent support plane (that is, the protective film plane); and that an angle between the disc plane of the discotic structure unit and the transparent support plane (that is, the protective film plane) varies in a depth direction of the optically anisotropic layer.

An angle (an angle of inclination) of a plane of the discotic structure unit is generally increased or decreased with an increase of a distance from a bottom surface of the optically anisotropic layer in the depth direction of the optically anisotropic layer. It is preferable that the foregoing angle of inclination increases with an increase in the distance. Furthermore, examples of a change of the angle of inclination include a continuous increase, a continuous decrease, an intermittent increase, an intermittent decrease, a change including a continuous increase and a continuous decrease and an intermittent change including an increase and a decrease. The intermittent change includes a region where the angle of inclination does not change on the way in the depth direction. It is preferable that the angle of inclination increases or decreases as a whole even when a region where the angle of inclination does not change is included. Furthermore, it is preferable that the angle of inclination increases as a whole, and it is particularly preferable that the angle of inclination continuously changes.

An optically anisotropic layer is generally obtained by coating a solution of a discotic compound and other compounds dissolved in a solvent on an orientation film, drying, followed by heating to a discotic nematic phase-forming temperature, further followed by cooling while keeping the oriented state (discotic nematic phase). Alternatively, an optically anisotropic layer is obtained by coating a solution of a discotic compound and other compounds (additionally, for example, a polymerizable monomer and a photopolymerization initiator) dissolved in a solvent on an orientation film, followed by drying, further followed by heating to a discotic nematic phase-forming temperature to polymerize (upon irradiation with UV rays), and still further followed by cooling. The discotic nematic liquid crystal phase-solid phase transition temperature of the discotic liquid crystalline compound used in the invention is preferably in the range of 70 to 300° C. and particularly preferably in the range of 70 to 170° C.

In general, when the discotic compound or the material of the orientation film is selected or the rubbing treatment method is selected, the angle of inclination of the discotic unit on the support side can be adjusted. Furthermore, the angle of inclination of the discotic unit on the surface side (air side) can be generally adjusted by selecting the discotic compound or other compounds (for example, a plasticizer, a surfactant, a polymerizable monomer and polymer) used together with the discotic compound. Still furthermore, the degree of change of the angle of inclination can be adjusted as well by the foregoing selection.

As the foregoing plasticizer, surfactant and polymerizable monomer, any compounds can be used so far as they have the compatibility with the discotic compound and can give a change of the angle of inclination of the liquid crystalline discotic compound, or they do not hinder the orientation thereof. Of these, a polymerizable monomer (for example, a compound having a vinyl group, a vinyloxy group, an acryloyl group, or a methacryloyl group) is preferable. The foregoing compound is generally used in an amount in the range of 1 to 50 mass percent (preferably from 5 to 30 mass percent) based on the discotic compound. Furthermore, as a preferred example of the polymerizable monomer, polyfunctional acrylate can be cited. With respect to the number of functional group, trifunctional or more polyfunctional monomers are preferable, and tetrafunctional or more polyfunctional monomers are more preferable. Of these, hexafunctional monomers are the most preferable. Examples of the hexafunctional monomer include dipentaerythritol hexaacrylate. Furthermore, polyfunctional monomers having the number of functional group different from each other can be mixed and used.

As the foregoing polymer, any polymers can be used so far as they have the compatibility with the discotic compound and can give a change of the angle of inclination to the liquid crystalline discotic compound. Examples of the polymer include cellulose esters. Preferred examples of the cellulose esters include cellulose acetate, cellulose acetate propionate, hydroxypropyl cellulose and cellulose acetate butyrate. The foregoing polymer is generally used in an amount in the range of 0.1 to 10 mass percent (preferably in the range of 0.1 to 8 mass percent and particularly preferably in the range of 0.1 to 5 mass percent) based on the discotic compound so that the orientation of the liquid crystalline discotic compound may not be disturbed.

In the invention, it is preferable that the optically anisotropic layer is made of a discotic liquid crystal formed on an orientation film provided on a protective film (for example, a cellulose acetate film), and that the orientation film is a rubbed film made of a crosslinked polymer.

(Orientation Film)

In the invention, an orientation film provided for the purpose of adjusting the orientation of the liquid crystalline compound of the optically anisotropic layer is preferably a layer made of two kinds of crosslinked polymers. It is preferable that at least in one kind of the two kinds thereof, any one of a polymer that is crosslinkable per se or a polymer that is crosslinked with a crosslinking agent is used. The foregoing orientation film can be formed by allowing functional group-containing polymers or polymers into which a functional group has been introduced to react with each other by the action of light, heat, and a pH change, or by introducing a bonding group derived from a crosslinking agent between polymers by use of a crosslinking agent that is a highly reactive compound, and thereby crosslinking the polymers each other.

Such crosslinking is usually carried out when a coating solution containing the foregoing polymers or a mixture of polymers and a crosslinking agent is coated on a transparent support, followed by heating. However, since the durability has only to be secured at a final product stage, the crosslinking may be carried out at any stage after the orientation film is coated on the support until a final polarizing plate is obtained. In the case where the optically anisotropic layer formed on the orientation film is formed with a discotic compound, when the orientation property of the discotic compound is taken into consideration, it is preferable that the crosslinking is thoroughly carried out after the discotic compound is oriented. That is, in the case where a coating solution containing a polymer and a crosslinking agent capable of crosslinking the polymer is coated on a support, after heating and drying (though crosslinking is generally carried out, in the case where the heating temperature is low, when heated to the discotic nematic phase-forming temperature, the crosslinking further proceeds), a rubbing treatment is applied to form an orientation film, a coating solution containing a compound having a disc-like structural unit is coated on the orientation film, followed by heating to a temperature of the discotic nematic phase-forming temperature or higher, further followed by cooling to form an optically anisotropic layer.

In the invention, as the polymer that is used in the orientation film, all of polymers that are crosslinkable per se and polymers that are crosslinked with a crosslinking agent can be used. As a matter of course, polymers having both properties can be used. Examples of the foregoing polymer include polymers such as polymethyl methacrylate, an acrylic acid/methacrylic acid copolymer, a styrene/malein imide copolymer, polyvinyl alcohol and a modified polyvinyl alcohol, poly(N-methylolacrylamide), a styrene/vinyltoluene copolymer, chloro-sulfonated polyethylene, nitrocellulose, polyvinyl chloride, chlorinated polyolefin, polyester, polyimide, a vinyl acetate/vinyl chloride copolymer, an ethylene/vinyl acetate copolymer, carboxymethyl cellulose, polyethylene, polypropylene, polycarbonates and gelatin, and a compound such as a silane coupling agent. Of these polymers, water-soluble polymers such as poly(N-methylolacrylamide), carboxymethyl cellulose, gelatin, polyvinyl alcohol, and a modified polyvinyl alcohol are preferable; gelatin, polyvinyl alcohol, and a modified polyvinyl alcohol are more preferable; and polyvinyl alcohol and a modified polyvinyl alcohol are particularly preferable.

Of the foregoing polymers, polyvinyl alcohol or modified polyvinyl alcohol is preferable, and a combination of two kinds of polyvinyl alcohols or modified polyvinyl alcohols different in the polymerization degree is the most preferable.

The polyvinyl alcohol is, for example, one having a degree of saponification in the range of 70 to 100%, generally one having a degree of saponification in the range of 80 to 100%, and more preferably one having a degree of saponification in the range of 85 to 95%. The degree of polymerization is preferably in the range of 100 to 3000. Examples of the modified polyvinyl alcohols include modified products of polyvinyl alcohol such as ones modified by copolymerization (as a modifying group, for example, COONa, Si(OX)₄, N(CH₃)₃Cl, C₉H₁₉COO, SO₃, Na or C₁₂H₂₅ is introduced); ones modified by chain transfer (as a modifying group, for example, COONa, SH, or C₁₂H₂₅ is introduced); and ones modified by block polymerization (as a modifying group, for example, COOH, CONH₂, COOR(R: an alkyl group having 1 to 20 carbon atoms), or C₆H₅ is introduced). Of these, unmodified or modified polyvinyl alcohols having a degree of saponification in the range of 80 to 100% are preferable; and unmodified or alkylthio-modified polyvinyl alcohols having a degree of saponification in the range of 85 to 95% are more preferable.

The synthesis method, a measurement of visible absorption spectrum, a method of determining a degree of introduction of these modified polymers are described in detail in JP-A-8-338913.

Specific examples of the crosslinking agent that is used together with the foregoing polymer such as polyvinyl alcohol include ones enumerated below, and these are preferably used together with the foregoing water-soluble polymer, particularly polyvinyl alcohol and a modified polyvinyl alcohol (including the modified products as specified above). That is, specific examples of the crosslinking agent include aldehydes (for instance, formaldehyde, glyoxal and glutaledhyde); N-methylol compounds (for instance, dimethylolurea and methyloldimethyl hydantoin); dioxane derivatives (for instance, 2,3-dihydroxydioxane), compounds that act upon activation of a carboxyl group (for instance, carbeniun, 2-naphthalene sulfonate, 1,1-bispyrrolidino-1-chloropyridinium, and 1-morpholinocarbonyl-3-(sulfonatoaminomethyl); active vinyl compounds (for instance, 1,3,5-triacryloyl-hexahydro-s-triazine, bis(vinylsulfone)methane, and N,N′-methylenebis-[β-(vinylsulfonyl)propionamide]); active halogen compounds (for instance, 2,4-dichloro-6-hydroxy-s-triazine); isoxazoles; and dialdehyde starches. These crosslinking agents can be used singularly or in a combination thereof. In the case where the productivity is taken into consideration, aldehydes having high reaction activity, particularly glutaldehyde is preferably used.

There are no particular restrictions on the crosslinking agent. With respect to an addition amount of the crosslinking agent, the moisture resistance tends to be improved as the addition amount is increased. However, in the case where the crosslinking agent is added in an amount of 50 mass percent or more based on the polymer, orientation ability as the orientation film is deteriorated. Accordingly, the addition amount of the crosslinking agent is preferably in the range of 0.1 to 20 mass percent and particularly preferably in the range of 0.5 to 15 mass percent. In this case, in some cases, the orientation film may possibly contain the unreacted crosslinking agent to some extent even after completion of the crosslinking reaction. The amount of the crosslinking agent is preferably 1.0 mass percent or less and particularly preferably 0.5 mass percent or less in the orientation film. When the crosslinking agent is contained in an amount exceeding 1.0 mass percent in the orientation film, sufficient durability is not obtained. That is, in the case of using in a liquid crystal display, when the liquid crystal display is used over a long period of time or allowed to stand in a high-temperature and high-humidity atmosphere for a long time, in some cases, reticulation may be generated.

The orientation film of the invention can be formed by coating a coating solution containing the foregoing polymer as an orientation film-forming material and crosslinking agent on a transparent support, heating to dry (crosslinking), and then rubbing. The crosslinking reaction may be carried out at an arbitrary timing after coating on the transparent support as described above. In the case where the foregoing water-soluble polymer such as the polyvinyl alcohol is used as the orientation film-forming material, the coating solution is preferably a solution where an organic solvent such as methanol having a defoaming action and water are mixed. A ratio thereof is generally in the range of 0/100 to 99/1, and preferably in the range of 0/100 to 91/9 by mass ratio. In this way, the generation of foams is suppressed, and defects of the orientation film and additionally the layer surface of the optically anisotropic layer are remarkably reduced. Examples of the coating method include a spin coating method, a dip coating method, a curtain coating method, an extrusion coating method, a bar coating method, and an E-type coating method. Of these, an E-type coating method is particularly preferable. Furthermore, a film thickness is preferably in the range of 0.1 to 10 μm.

The heating and drying can be carried out at from 20 to 110° C. In order to form sufficient crosslinking, the heating and drying temperature is preferably in the range of 60 to 100° C., and particularly preferably in the range of 80 to 100° C. The drying can be carried out for a period of time in the range of one minute to 36 hours, and preferably in the range of 5 to 30 minutes. The pH as well is preferably set at a value optimum for the crosslinking agent used. In the case where glutaldehyde is used as the crosslinking agent, the pH is preferably in the range of 4.5 to 5.5 and particularly preferably 5.

The orientation film is provided on a transparent support or via an undercoat layer capable of making the transparent support adhere closely to the orientation film. The undercoat layer is not particularly limited so far as in a combination of the transparent support and the orientation film, the adhesion therebetween can be enhanced.

The orientation film can be obtained by crosslinking the polymer layer as described above, followed by rubbing the surface. The orientation film functions so as to define an orientation direction of the liquid crystalline discotic compound provided thereon.

In the rubbing, a method that is widely employed as a treatment step of orienting a liquid crystal of LCD can be utilized. That is, a method of obtaining orientation by rubbing the surface of the orientation film in a fixed direction with paper, gauze, felt, rubber, nylon or polyester fibers can be used. In general, the rubbing is carried out several times with, for example, a cloth averagely transplanted with fibers having uniform length and thickness.

(Transparent Support on which Optically Anisotropic Layer is Provided)

A transparent support on which an optically anisotropic layer is provided is preferably a cellulose acetate film and may be optically uniaxial or biaxial.

Since the transparent support on which the optically anisotropic layer is provided plays itself an optically important role, the transparent support is preferably adjusted so as to have a retardation value Re (λ) in the range of 0 to 200 nm and a retardation value Rth (λ) in the range of 70 to 400 nm.

In the case where two sheets of optically anisotropic cellulose acetate film are used in a liquid crystal display, the retardation values Rth (λ) of the films are preferably in the range of 70 to 250 nm.

In the case where one sheet of optically anisotropic cellulose acetate film is used in a liquid crystal display, the retardation value Rth (λ) of the film is preferably in the range of 150 to 400 nm.

In the present specification, Re(λ) and Rth(λ) represent an in-plane retardation and a retardation in the thickness direction at a wavelength of λ, respectively. The Re(λ) is determined, in KOBRA 21ADH (trade name, manufactured by Oji Science Instruments), by making light having an wavelength of λ nm input in a normal direction of film and measuring. The Rth(λ) is computed by use of KOBRA 21 ADH on the basis of retardation values measured in three directions in total, that is, the Re (λ), a retardation value measured by inputting light having an wavelength λ nm from a direction inclined by +40° against the normal line direction of the film with the in-plane slow axis (judged by KOBRA 21ADH) as a tilt axis (rotational axis), and a retardation value measured by inputting light having a wavelength λ nm from a direction inclined by −40° against the normal line direction of the film with the in-plane slow axis as a tilt axis (rotational axis). Here, as hypothetical values of average refractive index, values described in Polymer Handbook (John Wiley & Sons, Inc.) and various catalogues of optical films can be employed. When an average value of refractive index is not known, it can be measured by use of an Abbe's refractometer. Average values of refractive index of major optical films are exemplified below: cellulose acylate (1.48), cycloolefin polymer (1.52), polycarbonate (1.59), polymethyl methacrylate (1.49) and polystyrene (1.59). By inputting a hypothetical average value of the refractive index and a film thickness, KOBRA 21ADH computes nx, ny and nz.

Incidentally, unless clearly stated in the specification, (λ) shows a value measured at a wavelength of 590 nm.

(Liquid Crystal Display)

The optical film and polarizing plate of the invention can be advantageously used in an image display such as a liquid crystal display and is preferably used in the outermost layer of the display.

The liquid crystal display has a liquid crystal cell and two polarizing plates, the liquid crystal cell being disposed between the two polarizing plates. The liquid crystal cell carries a liquid crystal between two electrode substrates. Furthermore, an optically anisotropic layer is disposed between the liquid crystal cell and one of the two polarizing plates, or each of two optically anisotropic layers may be disposed between the liquid crystal cell and each of the two polarizing plates.

The liquid crystal cell is preferably a TN mode, a VA mode, an OCB mode, an IPS mode, or an ECB mode. Among these, the VA mode or IPS mode is more preferable.

In the liquid crystal cell of a TN mode, rod-like liquid crystalline molecules are substantially horizontally oriented at the time when no voltage is applied and furthermore twisted and oriented at an angle in the range of 60 to 120°.

The liquid crystal cell of a TN mode is most frequently utilized in a color TFT liquid crystal display and described in many documents.

In the liquid crystal cell of a VA mode, rod-like liquid crystalline molecules are substantially vertically oriented at the time when no voltage is applied.

The liquid crystal cell of a VA mode includes, in addition to (1) a liquid crystal cell of a VA mode in a narrow sense in which rod-like liquid crystalline molecules are substantially vertically oriented at the time when no voltage is applied and substantially horizontally oriented at the time when a voltage is applied (JP-A-2-176625), (2) a liquid crystal cell (of an MVA mode) in which a VA mode is modified to be a multi-domain type so as to enlarge the viewing angle (described in SID97, Digest of Tech. Papers, 28 (1997), 845), (3) a liquid crystal cell (of an n-ASM mode) in which rod-like liquid crystalline molecules are substantially vertically oriented when no voltage is applied and oriented in a twisted multi-domain type when a voltage is applied (described in Nippon Ekisho Toronkai [Liquid Crystal Forum of Japan], Digest of Tech. Papers, 58-59 (1998)) and (4) a liquid crystal cell of a SURVAIVAL mode (reported in LCD International 98).

The liquid crystal cell of an OCB mode is a liquid crystal cell of a bend orientation mode in which rod-like liquid crystalline molecules are oriented substantially oppositely (symmetrically) in upper and lower portions of a liquid crystal cell and is described in U.S. Pat. Nos. 4,583,825 and 5,410,422. Since the rod-like liquid crystalline molecules are symmetrically oriented in the upper and lower portions of the liquid crystal cell, the liquid crystal cell of a bend orientation mode has a self-optically compensatory ability. Accordingly, the liquid crystal mode is called an OCB (Optically Compensatory Bend) liquid crystal mode. A liquid crystal display of a bend orientation mode has such an advantage that the response speed is fast.

The liquid crystal cell of an IPS mode is of a mode in which a transverse electric field is applied to a nematic liquid crystal to switch and is described in detail in Proc. IDRC (Asia Display '95), pp. 577-580 and ibid., pp. 707-710.

In the liquid crystal cell of an ECB mode, rod-like liquid crystalline molecules are substantially horizontally oriented when no voltage is applied. The ECB mode is one of liquid crystal display modes having the simplest structure and is described in, for example, JP-A-5-203946.

### EXAMPLES

In what follows, the invention will be specifically detailed with examples below. However, the invention is not restricted thereto.

Incidentally, in the specification, “parts” means “parts by mass”.

(Preparation of Hard Coat Layer Coating Solution A)

A following composition is thrown into a mixing tank, followed by agitating to prepare an anti-glare layer coating solution A.

(Composition of Hard Coat Layer Coating Solution A)

| | | |
|---|---|---|
| KAYARAD DPHA (UV-curable resin: manufactured | 28.4 | parts |
| by Nippon Kayaku Co., Ltd.) | | |
| Irgacure 184 (photopolymerization initiator, | 1.3 | parts |
| manufactured by Ciba Specialty Chemicals) | | |
| KBM-5103 (silane coupling agent, manufactured | 5.2 | parts |
| by Shin-Etsu Chemical Co., Ltd.) | | |
| CAB-531-1 (cellulose acetate butyrate of molecular weight | 0.50 | parts |
| of 40,000, manufactured by Eastman | | |
| Chemical Company) | | |
| Crosslinked poly(acryl-styrene) particle having an average | 9 | parts |
| particle diameter of 3.5 μm | | |
| (copolymerization composition ratio = 50/50, | | |
| refractive index: 1.536, manufactured by Soken | | |
| Chemical & Engineering Co., Ltd.) | | |
| Methyl isobutyl ketone | 61 | parts |

(Preparation of Hard Coat Layer Coating Solution B)

To the hard coat layer coating solution A, 0.05 parts of a fluorinated surfactant (FP-149) described in the specification is further added and stirred, and thereby an anti-glare hard coat layer coating solution B is prepared.

(Preparation of Hard Coat Layer Coating Solution C)

Now, among 61 parts of methyl isobutyl ketone of the hard coat layer coating solution A, 6 parts are replaced by propylene glycol, and thereby an anti-glare hard coat layer coating solution C is prepared.

(Preparation of Hard Coat Layer Coating Solution D)

A following composition is thrown into a mixing tank, followed by agitating to prepare an anti-glare layer coating solution D.

(Composition of Hard Coat Layer Coating Solution D)

| | | |
|---|---|---|
| KAYARAD PET-30 (UV-curable resin: manufactured | 50 | parts |
| by Nippon Kayaku Co., Ltd.) | | |
| Irgacure 184 (photopolymerization initiator, manufactured | 2.5 | parts |
| by Ciba Specialty Chemicals) | | |
| KBM-5103 (silane coupling agent, manufactured by | 6.2 | parts |
| Shin-Etsu Chemical Co., Ltd.) | | |
| Crosslinked poly(acryl-styrene) particle having an average | 2 | parts |
| particle diameter of 3.5 μm (refractive | | |
| index: 1.55, manufactured by Soken Chemical | | |
| & Engineering Co., Ltd.) | | |
| Crosslinked polystyrene particle having an average particle | 3 | parts |
| diameter of 3.5 μm (refractive index: | | |
| 1.60, manufactured by Soken Chemical & | | |
| Engineering Co., Ltd.) | | |
| Fluorinated surfactant (FP-149) described | 0.05 | parts |
| in the specification | | |
| Toluene | 50.0 | parts |
| Cyclohexane | 6.6 | parts |

(Preparation of Hard Coat Layer Coating Solution E)

A following composition is thrown into a mixing tank, followed by agitating to prepare an anti-glare layer coating solution E.

(Composition of Hard Coat Layer Coating Solution E)

| | | |
|---|---|---|
| Desolite Z7404 (hardcoat composition solution containing | 100 | parts |
| zirconia fine particle: solid content | | |
| concentration: 60 mass percent, ZrO₂ fine particle | | |
| content in solid content: 70 mass percent, average | | |
| particle diameter: substantially 20 nm, solvent composition | | |
| MIBK:MEK = 9:1, produced by JSR | | |
| Corp.) | | |
| KAYARAD DPHA (UV-curable resin: manufactured | 31 | parts |
| by Nippon Kayaku Co., Ltd.) | | |
| KBM-5103 (silane coupling agent, manufactured by | 10 | parts |
| Shin-Etsu Chemical Co., Ltd.) | | |
| KE-P150 (1.5 μm silica particle, manufactured by | 8.9 | parts |
| Nippon Shokubai Co., Ltd.) | | |
| MXS-300 (3.0 μm crosslinked PMMA particle, | 3.4 | parts |
| manufactured by Soken Chemical & Engineering Co., Ltd.) | | |
| Methyl ethyl ketone (MEK) | 29 | parts |
| Methyl isobutyl ketone (MIBK) | 13 | parts |

In the above, the 1.5 μm silica particle means silica particle having an average particle diameter of 1.5 μm, and 3.0 μm crosslinked PMMA particle means crosslinked polymethylmethacrylate particle having an average particle diameter of 3.0 μm. These are light transmitting particles.

(Preparation of Hard Coat Layer Coating Solution F)

A following composition is thrown into a mixing tank, followed by agitating to prepare a hard coat layer coating solution F.

(Composition of Hard Coat Layer Coating Solution F)

| | | |
|---|---|---|
| KAYARAD DPCA-20 (UV-curable resin: manufactured | 27.5 | parts |
| by Nippon Kayaku Co., Ltd.) | | |
| MEK-ST (dispersion of silica fine particle, manufactured | 50 | parts |
| by Nissan Chemical Industries, Ltd.) | | |
| KBM-5103 (silane coupling agent, manufactured by | 5.0 | parts |
| Shin-Etsu Chemical Co., Ltd.) | | |
| Irgacure 184 (photopolymerization initiator, manufactured | 2.5 | parts |
| by Ciba Specialty Chemicals) | | |
| SX-130H (1.3 μm crosslinked polystyrene particle, | 2.0 | parts |
| manufactured by Soken Chemical & | | |
| Engineering Co., Ltd.) | | |
| Methyl ethyl ketone (MEK) | 10.0 | parts |
| Cyclohexanone | 5.0 | parts |

(Preparation of Intermediate Refractive Index Layer Coating Solution)

A following composition is thrown into a mixing tank, followed by agitating to prepare an intermediate refractive index layer coating solution.

(Composition of Intermediate Refractive Index Layer Coating Solution)

| | | |
|---|---|---|
| Titanium dioxide fine particle dispersion liquid | 100 | parts |
| KAYARAD DPHA (UV-curable resin: manufactured by | 66 | parts |
| Nippon Kayaku Co., Ltd.) | | |
| Irgacure 907 (photopolymerization initiator, manufactured | 3.5 | parts |
| by Ciba Specialty Chemicals) | | |
| Kayacure DETX-S (photosensitizer, produced by Nippon | 1.2 | parts |
| Kayaku Co., Ltd.) | | |
| Methyl ethyl ketone (MEK) | 543 | parts |
| Cyclohexanone | 2103 | parts |

(Preparation of Higher Refractive Index Layer Coating Solution)

A following composition is thrown into a mixing tank, followed by agitating, further followed by filtering with a polypropylene filter with a pore diameter of 0.4 μm, and thereby a higher refractive index layer coating solution is prepared.

(Composition of Higher refractive index Layer Coating Solution)

| | | |
|---|---|---|
| Titanium dioxide fine particle dispersion liquid | 100 | parts |
| KAYARAD DPHA (UV-curable resin: manufactured by | 8.2 | parts |
| Nippon Kayaku Co., Ltd.) | | |
| Irgacure 907 (photopolymerization initiator, manufactured | 0.68 | parts |
| by Ciba Specialty Chemicals) | | |
| Kayacure DETX-S (photosensitizer, produced by Nippon | 0.22 | parts |
| Kayaku Co., Ltd.) | | |
| Methyl ethyl ketone (MEK) | 78 | parts |
| Cyclohexanone | 243 | parts |

(Preparation of Sol a)

Into a reaction vessel equipped with an agitator and a reflux condenser, 120 parts by mass of methyl ethyl ketone, 100 parts by mass of acryloyl oxypropyl trimethoxysilane (trade name: KBM-5103, produced by Shin-Etsu Chemical Co., Ltd.) and 3 parts by mass of diisopropoxy aluminum ethyl acetoacetate were added and blended, followed by adding 30 parts by mass of ion-exchange water, further followed by allowing reacting at 60° C. for 4 hr, still further followed by cooling to room temperature, and thereby a sol solution a was obtained. The compound thus obtained had a mass-average molecular weight of 1,800. A proportion of components having a molecular weight in the range of 1,000 to 20,000 in the components more than oligomer components was 100%. The gas chromatography analysis of the reaction product showed that none of the acryloyloxy propyl trimethoxysilane as the raw material remained.

(Synthesis of Perfluoroolefin Copolymer (1))

Into a 100 ml stainless steel autoclave with an agitator, 40 ml of ethyl acetate, 14.7 g of hydroxyethyl vinyl ether and 0.55 g of dilauroyl peroxide were charged, followed by deaerating the system and purging with nitrogen gas. Furthermore, 25 g of hexafluoropropylene (HFP) was introduced into the autoclave, followed by elevating a temperature to 65° C. When the temperature in the autoclave reached 65° C., the pressure in the autoclave was 0.53 MPa (5.4 kg/cm²). The reaction lasted for 8 hr with the temperature kept at the same value. When the pressure reached 3.1 MPa (3.2 kg/cm²), heating was stopped to allow cooling the mixture. When the inner temperature reached room temperature, the unreacted monomers were driven out of the system. The autoclave was then opened to withdraw a reaction solution. The reaction solution thus obtained was poured into a large excess of hexane. The solvent was removed by decantation to take out the polymer thus precipitated. The polymer was then dissolved in a small amount of ethyl acetate, and then twice reprecipitated from hexane to fully remove the residual monomers. After drying, 28 g of a polymer was obtained. Subsequently, 20 g of the polymer was dissolved in 100 ml of N,N-dimethylacetamide. To the solution, 11.4 g of acrylic acid chloride was added dropwise under ice cooling. The mixture was then stirred at room temperature for 10 hours. To the reaction solution, ethyl acetate was added and washed with water, followed by extracting an organic layer, further followed by concentrating. The resulting polymer was reprecipitated from hexane and 19 g of a perfluoroolefin copolymer (1) was obtained. The polymer thus obtained exhibited the refractive index of 1.421.

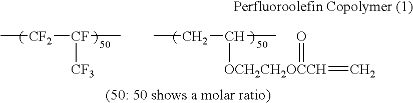

(Preparation of Hollow Silica Fine Particle Dispersion Liquid)

To 500 parts of hollow silica fine particle sol (isopropyl alcohol silica sol, CS60-IPA, manufactured by Catalysts & Chemicals Ind. Co., Ltd., average particle diameter: 60 nm, shell thickness: 10 nm, silica concentration: 20%, refractive index of silica particle: 1.31), 30 parts of acryloyloxypropyl trimethoxysilane (trade name: KBM-5103, manufactured by Shin-Etsu Chemical Co., Ltd.) and 1.5 parts of diisopropoxyaluninum ethyl acetate were added and mixed, followed by adding 9 parts of ion-exchange water. The mixture was allowed to react at 60° C. for 8 hours, followed by cooling the reaction mixture to room temperature, further followed by adding 1.8 parts of acetylacetone thereto, and thereby a hollow silica dispersion liquid was obtained. The resulting hollow silica fine particle dispersion liquid had a solid content concentration of 18 mass percent and the refractive index after drying the solvent of 1.31.

(Preparation of Lower Refractive Index Layer Coating Solution)

A following composition was thrown into a mixing tank and stirred, and then filtered with a polypropylene filter having a pore size of 1 μm to prepare a lower refractive index layer coating solution.

(Composition of Lower Refractive Index Layer Coating Solution)

| | | |
|---|---|---|
| KAYARAD DPHA (UV-curable resin, manufactured | 1.4 | parts |
| by Nippon Kayaku Co., Ltd.) | | |
| Perfluoroolefin copolymer (1) | 5.6 | parts |
| Hollow silica fine particle dispersion liquid | 20.0 | parts |
| RMS-033 (Reactive silicone, manufactured by Gelest, Inc.) | 0.7 | parts |
| Photopolymerization initiator a | 0.2 | parts |
| Sol solution a | 6.2 | parts |
| Methyl ethyl ketone (MEK) | 306.9 | parts |
| Cyclohexanone | 9.0 | parts |

Photopolymerization Initiator a

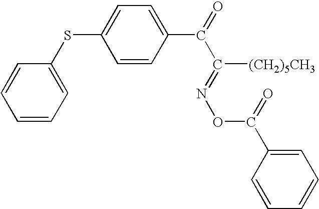

### Examples 1 Through 5 and Comparative Examples 1 Through 4

As a support, a triacetate cellulose film having a thickness of 80 μm (trade name: TAC-TD80U, manufactured by Fuji Photo Film Co., Ltd., support width: 1340 mm) was rolled out in roll and, on the support, by use of a die coat method shown in device conditions and coating conditions shown below, a hard coat layer coating solution A was coated. Then, under conditions shown in Table 1, a first drying step and subsequently a second drying step were applied, and, under nitrogen purge, with an air-cooled metal halide lamp of 160 W/cm (manufactured by Eye Graphics Co., Ltd.), UV-ray was irradiated to cure at an irradiation dose of 50 mJ/cm² to cure the coated layer, and thereby a hard coat layer having a thickness of 6 μm was formed and wound.

Fundamental conditions of coating: A slot die 13 of which an upstream side lip land length I_{UP} is 0.5 mm, a downstream side lip land length I_{LO} is 50 μm, a length in an web running direction of an aperture of a slot 16 is 150 μm and a length of the slot 16 is 50 mm was used. A gap between the upstream side lip land 18a and a web W was set longer by 50 μm than a gap between the downstream side lip land 18b and the web W (hereinafter, referred to as an overbite length of 50 μm), and a gap G_{L} between the downstream side lip land 18b and the web W was set at 50 μm. Furthermore, both a gap G_{S} between a side plate 40b of a low-pressure chamber 40 and the web W and a gap G_{B} between the back plate 40a and the web W were set at 200 μm.

In conformity to liquid physicality of the respective coating solutions, for the hard coat layer coating solutions A, B, C and D, a coating speed of 30 m/min and a wet coating amount of 17.5 ml/m² were set to coat; for the hard coat layer coating solution E, a coating speed of 20 m/min and a wet coating amount of 9 ml/m² were set to coat; for the hard coat layer coating solution F, a coating speed of 40 m/min and a wet coating amount of 21 ml/m² were set to coat; for the intermediate refractive index layer, a coating speed of 25 m/min and a wet coating amount of 3.5 ml/m² were set to coat; for the higher refractive index layer, a coating speed of 25 m/min and a wet coating amount of 3.5 ml/m² were set to coat; and for the lower refractive index layer, a coating speed of 40 m/min and a wet coating amount of 5.0 ml/m² were set to coat. A coating width was set at 1,300 mm and an effective width was set at 1,280 mm.

### Examples 6 Through 8

Similarly to example 1, the hard coat layer coating solution B was coated, followed by, under the conditions described in Table 1, undergoing the first drying step, subsequently the second drying step, further followed by irradiating UV-ray to cure a coated layer, and thereby a hard coat layer having a thickness of 6 μm was formed and wound.

### Example 9

Similarly to example 1, the hard coat layer coating solution C was coated, followed by, under the conditions described in Table 1, undergoing the first drying step, subsequently the second drying step, further followed by irradiating UV-ray to cure a coated layer, and thereby a hard coat layer having a thickness of 6 μm was formed and wound.

### Example 10 and Comparative Example 5

Similarly to example 1, the hard coat layer coating solution D was coated, followed by, under the conditions described in Table 1, undergoing the first drying step, subsequently the second drying step, further followed by irradiating UV-ray to cure a coated layer, and thereby a hard coat layer having a thickness of 6 μm was formed and wound.

### Example 11 and Comparative Example 6

Similarly to example 1, the hard coat layer coating solution E was coated, followed by, under the conditions described in Table 1, undergoing the first drying step, subsequently the second drying step, further followed by irradiating UV-ray to cure a coated layer, and thereby a hard coat layer having a thickness of 3.7 μm was formed and wound.

### Example 12 and Comparative Example 7

Similarly to example 1, the hard coat layer coating solution F was coated, followed by, under the conditions described in Table 1, undergoing the first drying step, subsequently the second drying step, further followed by irradiating UV-ray to cure a coated layer, and thereby a hard coat layer having a thickness of 6 μm was formed and wound.

### Example 13

A support on which a hard coat layer prepared in example 6 was coated was rolled out again, followed by coating the lower refractive index layer coating solution under the above fundamental conditions, further followed by drying at 90° C. for 60 sec, still further followed by irradiating UV-rays of an irradiation dose of 500 mJ/cm² with a 240 W/cm air-cooled metal halide lamp (manufactured by Eye Graphics Co., Ltd.) under an atmosphere of an oxygen concentration of 0.1% by nitrogen purge, and thereby a lower refractive index layer having a thickness of 100 nm was formed and wound. Thus, an anti-refection film was prepared.

### Example 14

The support on which a hard coat layer prepared in example 11 was coated was rolled out again, and, similarly to example 13, an anti-reflection film was prepared.

### Example 15

The support on which a hard coat layer prepared in example 12 was coated was rolled out again, followed by coating the intermediate refractive index layer coating solution under the above fundamental conditions, further followed by drying at 90° C. for 60 sec, still further followed by irradiating UV-rays of an irradiation dose of 500 mJ/cm² with a 240 W/cm air-cooled metal halide lamp (manufactured by Eye Graphics Co., Ltd.) under an atmosphere of an oxygen concentration of 0.1% by nitrogen purge, and thereby an intermediate refractive index layer having a thickness of 67 nm was formed and wound.

The refractive index of the intermediate refractive index layer was 1.65.

On the intermediate refractive index layer, the higher refractive index layer coating solution was coated under the above fundamental conditions, followed by drying at 90° C. for 60 sec, further followed by irradiating UV-rays of an irradiation dose of 500 mJ/cm² with a 240 W/cm air-cooled metal halide lamp (manufactured by Eye Graphics Co., Ltd.) under an atmosphere of an oxygen concentration of 0.1% by nitrogen purge, and thereby a higher refractive index layer having a thickness of 107 nm was formed and wound.

The refractive index of the higher refractive index layer was 1.93.

On the higher refractive index layer, the lower refractive index layer coating solution was coated under the above fundamental conditions, followed by drying at 90° C. for 60 sec, further followed by irradiating UV-rays of an irradiation dose of 500 mJ/cm² with a 240 W/cm air-cooled metal halide lamp (manufactured by Eye Graphics Co., Ltd.) under an atmosphere of an oxygen concentration of 0.1% by nitrogen purge, and thereby a lower refractive index layer having a thickness of 100 nm was formed and wound. Thus, on the hard coat layer, a three layer anti-reflection layer was formed.

### Example 16

Except that, as a support, a 80 μm thick triacetyl cellulose film of which width was changed to 1500 mm was used, similarly to example 13, an anti-reflection film was prepared.

### Example 17

With a cellulose triacetate film that was prepared by changing Tinuvin 327 (trade name, UV absorbent, manufactured by Ciba Specialties Chemicals) contained in TAC-TD80U that is a support to Tinuvin 326 (trade name, UV absorbent, manufactured by Ciba Specialties Chemicals), similarly to example 13, an anti-reflection film was prepared.

### Example 18

In the same manner as in example 1 except that cohesive silica particles having an secondary particle diameter of 1.0 μm (manufactured by Nihon Silica) were used in place of the crosslinked poly(acryl-styrene) particles having an average particle diameter of 3.5 μm in the hard coat layer coating solutions A, a coated layer was cured by undergoing the first drying step and subsequently the second drying step and irradiating UV-ray, and thereby a hard coat layer having a thickness of 2.4 μm was formed and wound.

(Saponification of Anti-Reflection Film)

An aqueous solution of 1.5 mol/l sodium hydroxide was prepared and kept at 55° C. An aqueous solution of 0.005 mol/l dilute sulfuric acid was prepared and kept at 35° C. The prepared anti-reflection film was immersed for 2 min in the sodium hydroxide aqueous solution, followed by immersing in water to thoroughly wash out sodium hydroxide aqueous solution. Subsequently, after immersing in the dilute sulfuric acid aqueous solution for 1 min, followed by immersing in water to thoroughly wash out the dilute sulfuric acid aqueous solution. Finally, a sample was thoroughly dried at 120° C.

Thus, a saponified anti-reflection film was prepared.

(Preparation of Polarizing Plate with Anti-Reflection Film)

A stretched polyvinyl alcohol film was allowed to absorb iodine, and thereby a polarizer was prepared. The saponified anti-reflection film, with a polyvinyl alcohol adhesive, was adhered to one side of the polarizer so that a support side (triacetyl cellulose) of the anti-reflection film may be a polarizer side. Furthermore, a wide-view film having an optically compensating layer (trade name: Wide-view Film Super Ace, manufactured by Fuji Photo Film Co., Ltd.) was saponified and, with a polyvinyl alcohol adhesive, adhered to the other side of the polarizer. Thus, a polarizing plate was prepared.

(Measurement/Evaluation Method)

Of obtained coated films, anti-reflection films and a polarizing plate, evaluations of following items were carried out. Results are shown in Table 1.

(1) Wind Speed Measurement

This is a value obtained by measuring a wind component in a direction in parallel with a proceeding direction of the coated film and the support at 10 mm above a coated film surface with an wind speed meter (trade name: Anemomaster MODEL 6112, manufactured by KANOMAX JAPAN INC.). On a coated surface in the first drying step, since a wind speed fluctuates depending on places, the maximum value was taken as a measurement value.

(2) Measurement of Drying Rate

With an IR Thickness Meter (trade name: IRM-V, manufactured by CHINO Corporation), a film thickness of a coating solution on a conveyed support was measured. From a thickness variation of the film, an amount of volatilizing solvent during coating is calculated (specifically, formula: {change of film thickness [μm]×specific gravity [−]}/time necessary for the change of film thickness (s), a thickness of 1 μm when the specific gravity is 1000 kg/m³ corresponds to 1 g/m²), and an amount of vaporization [g/m²/s] of the solvent per unit area/unit time is defined as the drying rate. At the measurement, as the solvent vaporizes, the drying rate changes and as the drying temperature varies the drying rate varies as well. Accordingly, every 10 sec, a film thickness of the coating solution was measured and the drying rate was calculated. Based on the results, a center value in each step is shown.

(3) Evaluation of Appearance

A polarizing plate disposed on an observer side of each of a liquid crystal display that uses a VA mode liquid crystal cell (trade name: LC-22GD3, manufactured by Sharp Corporation) and a liquid crystal display that uses a IPS mode liquid crystal cell (trade name: KLV-23HR1, manufactured by Sony Corporation) was peeled, in place thereof, a plane polarizing plate (trade name: HLCS-5618, manufactured by Sanritsutsu KK) was adhered so that a transmission axis of the polarizing plate may conform to that of the polarizing plate adhered to a product, and furthermore, through an adhesive, each of films according to examples 1 through 17 and comparative examples 1 through 7 was adhered so that a hard coat layer or an anti-reflection layer may be disposed on an observer side.

Prepared liquid crystal displays were visually evaluated of an appearance surface state from various viewing angles based on criteria below in a bright room of 1000 lux under a three-wavelength fluorescent lamp and with a liquid crystal display kept in black display. No drying irregularity was practically observed for displays having any of A to C criteria, and thus, such displays are acceptable.

A: no drying irregularity

B: only slight drying irregularity

C: weak drying irregularity

D: medium level drying irregularity

E: strong drying irregularity

TABLE 1

| | | | | | | Second | | |
|---|---|---|---|---|---|---|---|---|
| | | | First | | | Drying | | Drying |
| | Coating | Coating | Drying Step | | | Step | | Irreg- |
| | solution | speed | 1) | 2) | 3) | 1) | 2) | ularity |
| Example 1 | A | 30 | 25 | 1.5 | 0.8 | 110 | 5 | C |
| Example 2 | A | 30 | 25 | 3 | 1.5 | 110 | 5 | B |
| Example 3 | A | 30 | 25 | 10 | 4.8 | 110 | 5 | B |
| Example 4 | A | 30 | 25 | 3 | 1.5 | 80 | 5 | B |
| Example 5 | A | 30 | 25 | 3 | 1.5 | 135 | 5 | A |
| Comparative | A | 30 | 25 | 0.5 | 0.2 | 40 | 5 | E |
| example 1 | | | | | | | | |
| Comparative | A | 30 | 25 | 0.5 | 0.2 | 110 | 5 | D |
| example 2 | | | | | | | | |
| Comparative | A | 30 | 25 | 3 | 1.5 | 40 | 5 | E |
| example 3 | | | | | | | | |
| Comparative | A | 30 | 25 | 3 | 1.5 | 60 | 5 | D |
| example 4 | | | | | | | | |
| Example 6 | B | 30 | 25 | 3 | 1.4 | 110 | 5 | A |
| Example 7 | B | 30 | 50 | 3 | 3.2 | 110 | 5 | A |
| Example 8 | B | 30 | 70 | 3 | 4.7 | 135 | 5 | A |
| Example 9 | C | 30 | 25 | 3 | 1.2 | 110 | 5 | A |
| Example 10 | D | 30 | 25 | 3 | 0.7 | 110 | 5 | A |
| Comparative | D | 30 | 25 | 0.5 | 0.2 | 60 | 5 | E |
| example 5 | | | | | | | | |
| Example 11 | E | 20 | 25 | 3 | 1.9 | 110 | 5 | B |
| Comparative | E | 20 | 25 | 0.5 | 0.25 | 60 | 5 | E |
| example 6 | | | | | | | | |
| Example 12 | F | 40 | 25 | 3 | 2.3 | 110 | 5 | A |
| Comparative | F | 40 | 25 | 0.2 | 0.25 | 60 | 5 | D |
| example 7 | | | | | | | | |

1) Temperature (° C.)
2) Wind speed (m/s)
3) Vaporization speed (g/m²/s)

From results shown in Table 1, the followings are obvious. When in the first drying step the maximum value of the drying wind speed is 1 m/s or more and in the second drying step a temperature is set higher by 50° C. than that in a zone of the first drying step, a uniform surface shape less in the air irregularity was obtained. Furthermore, when two kinds of solvents of which boiling temperatures are different 30° C. or more were used or a fluorinated surfactant was used, a coated film in which the air irregularity was improved at extremely high level was obtained.

Furthermore, when the anti-reflectivity was visually evaluated in a bright room, films having an anti-reflection layer on a hard coat layer all were excellent.

Still furthermore, like examples 16 and 17, even when a support width and a UV-absorbent contained in the support were varied, similar performance could be obtained.

The drying irregularity of example 18, in which cohesive silica particles having an secondary particle diameter of 1.0 μm (manufactured by Nihon Silica) were used in place of the crosslinked poly(acryl-styrene) particles having an average particle diameter of 3.5 μm, was C level, and the air irregularity of example 18 was excellent.

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2005-244359 filed Aug. 25 of 2005, the contents of which are incorporated herein by reference.

What is claimed is:

1. A method for producing a film having a coated layer, comprising:
coating a coating solution on a support to provide a coating layer, the coating solution comprising a light-transmitting resin and a solvent;
first drying the coating layer in a first drying zone where a maximum wind speed on a surface of the coating layer is 1 m/sec or more; and
second drying the coating layer in a second drying zone having a temperature of 50° C. or more higher than that of the first drying zone to form a coated layer.

2. The method according to claim 1, wherein a drying speed of the solvent in the first drying is 0.3 g/m²/sec or more.

3. The method according to claim 1, wherein the solvent in the coating solution comprises at least two solvents having boiling temperatures different from one another by 30° C. or more.

4. The method according to claim 1, wherein the coating, the first drying and the second drying are carried out with the support conveying at 30 m/min or more.

5. The method according to claim 1, wherein the support is a long roll, and the support has a width of 1.4 to 4 m.

6. The method according to claim 1, wherein the coating solution comprises a surfactant.

7. A film comprising: a support; and a coated layer, the film being produced by a method according to claim 1.

8. An optical film comprising a film according to claim 7, wherein the coated layer comprises an optical functional layer.

9. The optical film according to claim 8, wherein the optical functional layer is an anti-glare layer.

10. The optical film according to claim 8, wherein the optical functional layer comprises light-transmitting particles having a refractive index different from the light-transmitting resin.

11. The optical film according to claim 8, which comprises a lower refractive index layer having a refractive index lower than that of the optical functional layer, the optical functional layer being disposed between the support and the lower refractive index layer.

12. A polarizing plate comprising: a polarizer; and two protective films sandwiching the polarizer, wherein at least one of the two protective films is an optical film according to claim 8.

13. A liquid crystal display comprising: a liquid crystal cell; and an optical film according to claim 8 as an outermost layer of the liquid crystal display.

14. The liquid crystal display according to claim 13, wherein the liquid crystal cell is of a VA mode or an IPS mode.
